(19) United States
(12) Patent Application Publication
(10) Pub. No.: US 2025/0083313 A1
(43) Pub. Date: Mar. 13, 2025

(54) ROBOTIC SYSTEMS, METHODS, AND DEVICES FOR GRAPPLING AND ACTUATING A PAYLOAD

(71) Applicant: MacDonald, Dettwiler and Associates Inc., Brampton (CA)

(72) Inventors: Tej Singh Sachdev, Milton (CA); Steve Fisher, Schomberg (CA); Philip Raymond Apperly, Tottenham (CA); Drew Grandy, New Tecumseth (CA)

(21) Appl. No.: 18/720,567

(22) PCT Filed: Dec. 16, 2022
(86) PCT No.: PCT/CA2022/051842

§ 371 Date: Jun. 14, 2024

Related U.S. Application Data
(60) Provisional application No. 63/290,121, filed on Dec. 16, 2021.

(51) Int. Cl. B25J 9/16

(52) U.S. Cl. CPC B25J 9/1633

(57) ABSTRACT

Robotic systems, methods, and devices for grappling and actuating a pay load are provided. A robotic end effector device includes a grapple mechanism for capturing and rigidizing a pay load through a grapple fixture. The grapple mechanism grapples a probe of the grapple fixture and retracts the probe to bring a first coupling element of the grapple fixture into mating connection with a second coupling element on the grapple mechanism. Each coupling element includes a plurality of radially-disposed teeth and notches which are configured to mate with the notches of the other coupling element. The grapple mechanism includes a pay load present sensor for sensing the probe is present in the grapple mechanism to initiate grappling and a calibration sensor for tracking position of a moving component of the grapple mechanism. Retraction of the moving component is stopped at a target preload position based on the position tracking.

### TECHNICAL FIELD

The following relates generally to robotic systems and devices, and more particularly to a robotic interface for grappling and actuating a payload via a prepared interface on the payload.

### INTRODUCTION

The development of a low mass active robotic interface that operates on the end of a manipulator is a critical element in the advancement of robotic servicing, maintenance, and assembly capabilities, and in particular in space and on-orbit environments. One objective is to limit the mass and volume of the robotic device, while at the same time maximizing the design's load capacity. Development of a multipurpose robotic interface will encourage spacecraft integrators to incorporate robotic compatibility into future vehicles and architectures.

More generally, a robotic interface is desired that can enable effective capture of a payload, such as a tool or other object, in a variety of applications and environments, including space and on-orbit applications. Further, a robotic interface is desired that can enable actuation of the captured payload, such as through maneuvering the captured payload via a pick and place operation or the like, or through transferring torque across the robotic interface. In other cases, there may be the transfer of data, power, and fuel.

Accordingly, there is a need for an improved systems, methods, and devices for grappling and actuating a payload that overcome at least some of the disadvantages of existing systems and methods.

### SUMMARY

There is provided a robotic end effector device having an arm interfacing end including a robotic arm interface for connecting to a robotic arm and a payload interfacing end for interfacing with a payload, the payload having a grapple fixture which includes a first coupling element mounted to a surface of the payload and a grapple probe.

The device includes a housing for enclosing an interior compartment of the end effector device; a second coupling element that is connected to the housing at the payload interfacing end for mating with the first coupling element during rigidization of the end effector to the payload, the second coupling element having an opening therethrough to enable the grapple probe of the grapple fixture to enter the interior compartment as the payload interfacing end is moved towards the grapple fixture by the robotic arm; and a grapple mechanism disposed in the interior compartment for capturing and rigidizing the payload to the end effector device through the grapple fixture.

The grapple mechanism includes a jaw assembly including jaws for grappling the grapple probe; a payload present sensor for sensing that the grapple probe is in a position to be grappled by the jaws (“grappling position”); and a moving component for translating along a capture axis of the grapple mechanism in a direction opposite the payload interfacing end (“retraction”) to bring the first coupling element and the second coupling element into mating connection while the jaws are grappling the grapple probe to rigidize the end effector to the payload to a target preload. The moving component includes the jaw assembly, and wherein the retraction of the moving component closes the jaws to grapple the grapple probe; a translation mechanism for retracting the moving component along the capture axis; a motor for driving the translation mechanism, the motor triggered to drive the translation mechanism in response to the payload present sensor sensing the grapple probe in the grappling position; a calibration sensor for sensing that the moving component has retracted from a calibration position; and a position monitoring device for monitoring a position of the moving component relative to the calibration position and generating an output to stop retraction of the moving component when the moving component has reached a target preload position along the capture axis that achieves the target preload.

A robotic end effector device having an arm interfacing end including a robotic arm interface is also provided. The device is for connecting to a robotic arm and a payload interfacing end for interfacing with a payload, the payload having a grapple fixture for grappling and rigidizing the payload and a torque element for receiving torque.

The device includes a grapple mechanism configured to grapple a grapple probe of the grapple fixture as the payload interfacing end of the end effector device is moved towards the grapple fixture and retract the grappled probe along a capture axis towards the arm interfacing end to bring a coupling element of the grapple fixture and the torque element towards the payload interfacing end; and a socket drive mechanism for passing torque to the payload through the torque element on the payload

The socket drive mechanism includes a socket module having a socket for receiving and seating the torque element; a socket rotator for rotating the socket to impart rotational mechanical energy to the torque element seated in the socket; a socket drive motor module for driving rotation of the socket rotator; and an axial compliance mechanism configured to passively axially retract the socket module from a forward position when the socket is misaligned to and contacts the torque element and to passively return to the forward position when the socket is aligned with and seated on the torque element.

The socket drive motor drives rotation of the socket rotator when the socket is seated on the torque element to impart the rotational mechanical energy to the torque element.

A method of robotic capture of a payload is also provided. The method includes moving a payload interfacing end of an end effector via a robotic arm towards a grapple fixture on the payload such that the grapple fixture is within a capture envelope of the end effector, the payload interfacing end having a grapple mechanism and sensing that a probe of the grapple fixture is within a grappling area of the grapple mechanism where grapple jaws of the grapple mechanism can grapple the probe

In response to sensing the grapple probe is within the grappling area, the method further includes retracting the grapple mechanism along a capture axis to close the grapple jaws and grapple the probe and sensing that the grapple mechanism has retracted from a home position.

In response to sensing the grapple mechanism has retracted from the home position, the method further includes tracking a position of the grapple mechanism along the capture axis as the grapple mechanism retracts via a position monitoring device; further retracting the grapple mechanism along the capture axis to a target preload position as the grapple mechanism is grappling the probe to draw a first coupling element of the grapple fixture on the surface of the payload into mated connection with a second coupling element on the payload interfacing end of the end effector such that the first and second coupling elements transmit static loads between each other without separation of the interface up to a maximum rigidization load capability of the end effector, the target preload position corresponding to a discrete rigidization load; generating an output at the position monitoring device when the grapple mechanism has retracted to the target preload position; and stopping retraction of the grapple mechanism at the target preload position based on the output of the position monitoring device.

A method of robotically transmitting torque to a payload is also provided. The method includes capturing the payload with an end effector by grappling a grapple fixture on the payload with a grapple mechanism of the end effector; retracting the grapple mechanism to a target preload position to rigidize the grapple fixture to the end effector; seating a torque element present on the payload in a socket of a socket drive mechanism of the end effector via relative motion of the payload and the end effector resulting from the retraction of the grapple mechanism; and sensing that the torque element is seated in the socket of the socket drive mechanism.

In response to sensing the torque element is seated in the socket, the method also includes applying torque to the torque element by rotating the socket to drive a torque driven subsystem of the payload connected to the torque element.

Other aspects and features may become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1A is a block diagram of a system for robotic capture of and torque transfer to a payload via a prepared interface on the payload, according to an embodiment;

FIG. 1B is a block diagram of the machine vision system of the system of FIG. 1A;

FIG. 1C is a block diagram of the grapple subsystem of the system of FIG. 1A;

FIG. 1D is a block diagram of the torquer subsystem of the system of FIG. 1A;

FIG. 2 is a flow diagram of a method of interfacing between a multipurpose end effector and a prepared payload, according to an embodiment;

FIGS. 3A and 3B are a flow diagram of a method of grappling and rigidizing a payload via a grapple fixture on the payload, according to an embodiment;

FIG. 4 is a flow diagram of a method of aligning, seating, and actuating a torque element (or torque or actuation member) on a prepared interface of a payload, according to an embodiment;

FIG. 5 is a perspective view of a robotic interface system including a prepared interface for use on a payload and a robotic end effector for interfacing with the payload via the prepared interface, according to an embodiment;

FIG. 6A is a front perspective view of the end effector of FIG. 5 in isolation;

FIG. 6B is a rear perspective view of the end effector of FIG. 6A;

FIG. 7A is an external side view of a grapple mechanism of the end effector of FIG. 6A in isolation;

FIG. 7B is an external front view of the grapple mechanism of FIG. 7A;

FIG. 8 is a front perspective view of a front end of the grapple mechanism of FIGS. 7A-7B;

FIG. 9 is a perspective view of the grapple fixture of FIG. 5 in isolation;

FIG. 10A is a perspective view of the end effector front end of FIG. 8 and the grapple fixture of FIG. 9 in a pre-capture configuration as the end effector moves towards the grapple fixture;

FIG. 10B is a perspective view of the end effector front end of FIG. 8 and the grapple fixture of FIG. 9 in a post-capture and rigidized configuration, showing coupling of respective coupling elements of the end effector and grapple fixture;

FIG. 11 is a cross-sectional side view of the grapple mechanism of the end effector of FIGS. 6A-6B in isolation, according to an embodiment;

FIG. 12A is a cross-sectional side view of the grapple mechanism of FIG. 11 after contact with a grapple fixture and during mechanism retraction;

FIG. 12B is a cross-sectional side view of the interface between the grapple mechanism and grapple fixture of FIG. 12A having been rigidized through Belleville spring stack compression via relative motion between a split housing and screw sleeve;

FIG. 13 is a perspective partially transparent side view of the grapple jaws of the grapple mechanism of FIG. 11 illustrating actuation of the grapple jaws between an open configuration and a closed configuration, according to an embodiment;

FIG. 14A is a front perspective view of the socket drive mechanism of the end effector of FIGS. 6A-6B in isolation;

FIG. 14B is a side view of the socket drive mechanism of FIG. 14A;

FIG. 14C is a cross sectional side view of the socket drive mechanism of

FIGS. 14A-14B, according to an embodiment;

FIG. 15 is a perspective view of the torque drive bolt of the prepared interface of FIG. 5, in isolation;

FIG. 16A is a front view of the socket profile of the socket head of the socket drive mechanism of FIGS. 14A-14C;

FIG. 16B is a cross-sectional side view illustrating angular misalignment accommodation of the socket drive of the socket drive mechanism of FIGS. 14A-14C with respect to the torque drive bolt of FIG. 15;

FIG. 17A is a front perspective view of the Oldham coupling of the socket drive mechanism of FIGS. 14A-14C;

FIG. 17B is a front perspective exploded view of the Oldham coupling of FIG. 17A;

FIG. 18 is a front perspective view of the Oldham coupling of FIGS. 17A-17B illustrating Oldham coupling misalignment accommodation, according to an embodiment;

FIG. 19 is a side view illustrating axial compliance of the socket drive mechanism of FIGS. 14A-14B, including a bolt misaligned stage and a bolt fully seated stage;

FIG. 20 is a cross-sectional side view of the socket drive mechanism of FIG. 19 illustrating axial compliance;

FIG. 21A is a cross-sectional side view of the grapple mechanism and socket drive mechanism of the end effector of FIGS. 6A-6B, illustrating microswitch sensing element locations, according to an embodiment;

FIG. 21B is a graphical representation of example physical and electrical switch states for each of the socket engaged microswitch, the payload present microswitch, the rigidize load safety microswitch, and the calibration microswitch of FIG. 21A;

FIG. 22A is a cross-sectional side view of the grapple mechanism and socket drive mechanism of the end effector of FIGS. 6A-6B in a rest state for power off state of an operational sequence;

FIG. 22B is a graphical representation of the physical and electrical switch states for each of the socket engaged microswitch, the payload present microswitch, the rig safety microswitch, and the calibration microswitch corresponding to the operational state shown in FIG. 22A;

FIG. 23A is a cross-sectional side view of the grapple mechanism and socket drive mechanism of the end effector of FIGS. 6A-6B in a rest state for power on state of an operational sequence;

FIG. 23B is a graphical representation of the physical and electrical switch states for each of the socket engaged microswitch, the payload present microswitch, the rig safety microswitch, and the calibration microswitch corresponding to the operational state shown in FIG. 23A;

FIG. 24A is a cross-sectional side view of the grapple mechanism and socket drive mechanism of the end effector of FIGS. 6A-6B in a power up while at “rest state” state of an operational sequence;

FIG. 24B is a graphical representation of the physical and electrical switch states for each of the socket engaged microswitch, the payload present microswitch, the rig safety microswitch, and the calibration microswitch corresponding to the operational state shown in FIG. 24A;

FIG. 25A is a cross-sectional side view of the grapple mechanism and socket drive mechanism of the end effector of FIGS. 6A-6B in a calibration position of an operational sequence;

FIG. 25B is a graphical representation of the physical and electrical switch states for each of the socket engaged microswitch, the payload present microswitch, the rig safety microswitch, and the calibration microswitch corresponding to the operational state shown in FIG. 25A;

FIG. 26A is a cross-sectional side view of the grapple mechanism and socket drive mechanism of the end effector of FIGS. 6A-6B in a ready for capture state of an operational sequence;

FIG. 26B is a graphical representation of the physical and electrical switch states for each of the socket engaged microswitch, the payload present microswitch, the rig safety microswitch, and the calibration microswitch corresponding to the operational state shown in FIG. 26A;

FIG. 27A is a cross-sectional side view of the grapple mechanism and socket drive mechanism of the end effector of FIGS. 6A-6B in an approach, ready for capture state of an operational sequence;

FIG. 27B is a graphical representation of the physical and electrical switch states for each of the socket engaged microswitch, the payload present microswitch, the rig safety microswitch, and the calibration microswitch corresponding to the operational state shown in FIG. 27A;

FIG. 28A is a cross-sectional side view of the grapple mechanism and socket drive mechanism of the end effector of FIGS. 6A-6B in a payload present state of an operational sequence;

FIG. 28B is a graphical representation of the physical and electrical switch states for each of the socket engaged microswitch, the payload present microswitch, the rig safety microswitch, and the calibration microswitch corresponding to the operational state shown in FIG. 28A;

FIG. 29A is a cross-sectional side view of the grapple mechanism and socket drive mechanism of the end effector of FIGS. 6A-6B in a jaws closed state (or “soft capture” state) of an operational sequence;

FIG. 29B is a graphical representation of the physical and electrical switch states for each of the socket engaged microswitch, the payload present microswitch, the rig safety microswitch, and the calibration microswitch corresponding to the operational state shown in FIG. 29A;

FIG. 30A is a cross-sectional side view of the grapple mechanism and socket drive mechanism of the end effector of FIGS. 6A-6B in a first contact with socket drive state of an operational sequence;

FIG. 30B is a graphical representation of the physical and electrical switch states for each of the socket engaged microswitch, the payload present microswitch, the rig safety microswitch, and the calibration microswitch corresponding to the operational state shown in FIG. 30A;

FIG. 31A is a cross-sectional side view of the grapple mechanism and socket drive mechanism of the end effector of FIGS. 6A-6B in a grapple fixture contact, socket not aligned state of an operational sequence;

FIG. 31B is a graphical representation of the physical and electrical switch states for each of the socket engaged microswitch, the payload present microswitch, the rig safety microswitch, and the calibration microswitch corresponding to the operational state shown in FIG. 31A;

FIG. 32A is a cross-sectional side view of the grapple mechanism and socket drive mechanism of the end effector of FIGS. 6A-6B in a rigidized, socket not aligned state of an operational sequence;

FIG. 32B is a graphical representation of the physical and electrical switch states for each of the socket engaged microswitch, the payload present microswitch, the rig safety microswitch, and the calibration microswitch corresponding to the r operational state shown in FIG. 32A;

FIG. 33A is a cross-sectional side view of the grapple mechanism and socket drive mechanism of the end effector of FIGS. 6A-6B in a rigidized, socket aligned (ready for operations) state of an operational sequence;

FIG. 33B is a graphical representation of the physical and electrical switch states for each of the socket engaged microswitch, the payload present microswitch, the rig safety microswitch, and the calibration microswitch corresponding to the operational state shown in FIG. 33A;

FIG. 34A is a cross-sectional side view of the grapple mechanism and socket drive mechanism of the end effector of FIGS. 6A-6B in a release of payload state of an operational sequence;

FIG. 34B is a graphical representation of the physical and electrical switch states for each of the socket engaged microswitch, the payload present microswitch, the rig safety microswitch, and the calibration microswitch corresponding to the operational state shown in FIG. 34A;

FIG. 35A is a cross-sectional side view of the grapple mechanism and socket drive mechanism of the end effector of FIGS. 6A-6B in a release, start to push on probe state of an operational sequence;

FIG. 35B is a graphical representation of the physical and electrical switch states for each of the socket engaged microswitch, the payload present microswitch, the rig safety microswitch, and the calibration microswitch corresponding to the operational state shown in FIG. 35A;

FIG. 36A is a cross-sectional side view of the grapple mechanism and socket drive mechanism of the end effector of FIGS. 6A-6B in a release, jaws start to open state of an operational sequence;

FIG. 36B is a graphical representation of the physical and electrical switch states for each of the socket engaged microswitch, the payload present microswitch, the rig safety microswitch, and the calibration microswitch corresponding to the operational state shown in FIG. 36A;

FIG. 37A is a cross-sectional side view of the grapple mechanism and socket drive mechanism of the end effector of FIGS. 6A-6B in a release, jaws partially open state of an operational sequence;

FIG. 37B is a graphical representation of the physical and electrical switch states for each of the socket engaged microswitch, the payload present microswitch, the rig safety microswitch, and the calibration microswitch corresponding to the operational state shown in FIG. 37A;

FIG. 38A is a cross-sectional side view of the grapple mechanism and

socket drive mechanism of the end effector of FIGS. 6A-6B in a jaws open state of an operational sequence;

FIG. 38B is a graphical representation of the physical and electrical switch states for each of the socket engaged microswitch, the payload present microswitch, the rig safety microswitch, and the calibration microswitch corresponding to the operational state shown in FIG. 38A;

FIG. 39A is a cross-sectional side view of the grapple mechanism and socket drive mechanism of the end effector of FIGS. 6A-6B in a payload released state of an operational sequence;

FIG. 39B is a graphical representation of the physical and electrical switch states for each of the socket engaged microswitch, the payload present microswitch, the rig safety microswitch, and the calibration microswitch corresponding to the operational state shown in FIG. 39A;

FIG. 40A is a cross-sectional side view of the grapple mechanism and socket drive mechanism of the end effector of FIGS. 6A-6B in a return to rest state of an operational sequence; and

FIG. 40B is a graphical representation of the physical and electrical switch states for each of the socket engaged microswitch, the payload present microswitch, the rig safety microswitch, and the calibration microswitch corresponding to the operational state shown in FIG. 40A.

### DETAILED DESCRIPTION

Various apparatuses or processes may be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it may be readily apparent that more than one device/article (whether or not they cooperate) may be used in place of a single device/article. Similarly, where more than one device or article is described herein (whether or not they cooperate), it may be readily apparent that a single device/article may be used in place of the more than one device or article.

The following relates generally to robotic systems and devices, and more particularly to a robotic interface for grappling and actuating a payload via a prepared interface on the payload.

The development of a low mass active robotic interface that operates on the end of a manipulator is a critical element in the advancement of robotic on-orbit servicing, maintenance, and assembly capabilities. One objective is to minimize the mass and volume of a multi-purpose end effector, while at the same time maximizing the design's load capacity. Development of a dexterous and multipurpose robotic interface can encourage spacecraft integrators to incorporate robotic compatibility into future vehicles and architectures. Further, the robotics-based systems, methods, and devices described herein can be used in robotic applications outside the space-based systems context, while providing similar functionalities and advantages.

As used herein, the term “end effector” refers generally to a robotic device or element at the end of a robotic arm that performs a function. The term “end effector” as used herein includes devices that are permanently or non-separably mounted to the end of the robotic arm and devices having a separable interface with the end of the robotic arm. A separable interface may allow the end effector to be picked up, used, and put down (i.e. separated from the robotic arm). Instances of the end effector having a separable interface may also be referred to as a “tool” or “end of arm tool”. In such an instance, the robotic arm may have a first end effector mounted to its end which has the function of a tool-changer that allows the robotic arm to use multiple different tools, and a second end effector having the separable interface and which can be engaged by the first end effector and function as a tool. In such a case, the first “tool-changer” end effector and the second “tool” end effector are each considered an end effector. Accordingly, any references to “end effector” herein are intended to include all devices as described in the foregoing unless otherwise noted.

The robotic capture system of the present disclosure may provide a relatively wide capture envelope for robotic operations and mating of interfaces. Accordingly, the robotic capture system may advantageously provide forgiving misalignments during interface mating. Such forgiveness on interface misalignment may also permit using a vision system with lower performance requirements for vision system alignment for capture. Accordingly, in some embodiments, the vision system used for alignment by the robotic capture system may be a vision system with lower performance requirements.

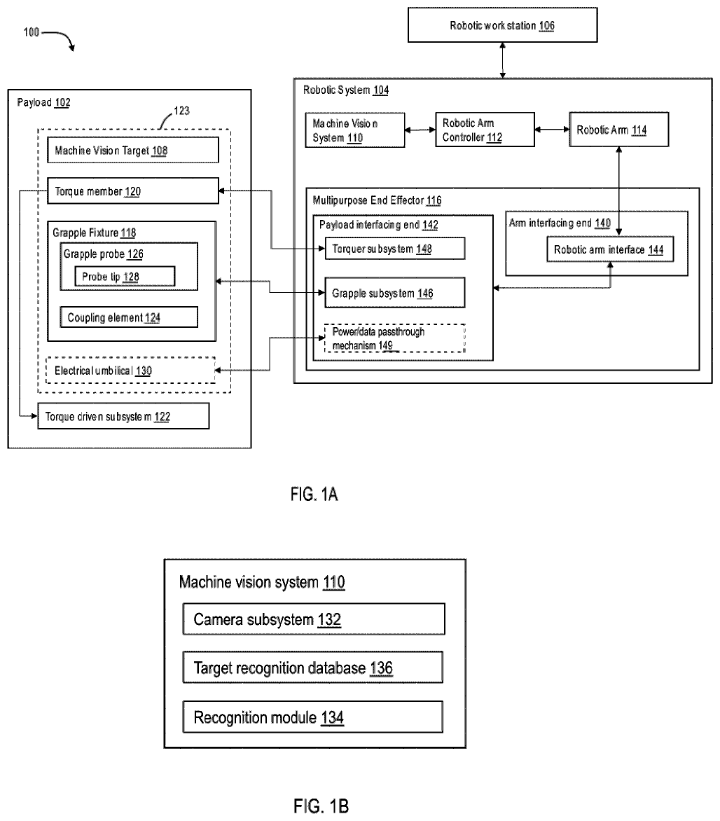

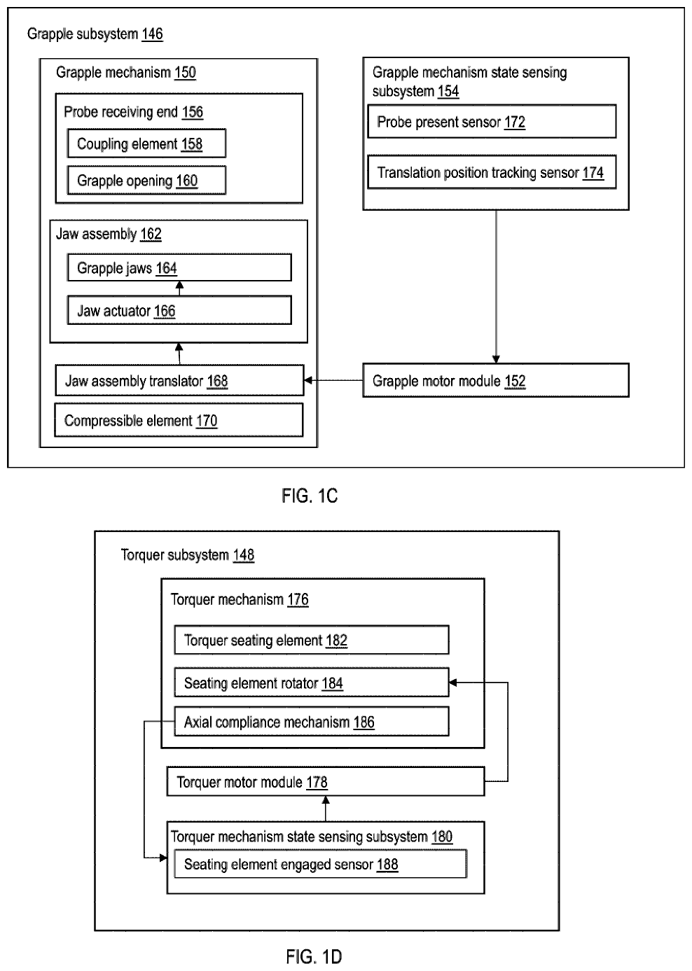

Referring now to FIGS. 1A to 1D, shown therein is a block diagram of a system 100 for robotic capture and manipulation of a payload, according to an embodiment.

The system-level view of the system 100 is shown in FIG. 1A. Certain components of the system 100 are shown in greater detail in FIGS. 1B-1D.

The system 100 includes a payload 102 and a robotic system 104 for capturing the payload 102 and manipulating the payload 102 once captured.

The system 100 also includes a robotic workstation 106 for communicating with the robotic system 104. The robotic workstation 106 includes a human-machine interface for sending commands to the robotic system 104. Communication between the robotic workstation 106 and the robotic system 104 may be achieved via any suitable data transfer technique, such as a network connection (e.g. wireless or wired). The robotic workstation 106 and robotic system 104 include communication interfaces and software for facilitating communication between the workstation 106 and the robotic system 104.

The payload 102 may be any object and the nature of the payload 102 is not particularly limited other than being an object that a user of the robotic system 104 desires to be captured and manipulated (e.g. moved, actuated). For example, the payload 102 may be a tool that can be captured and then used by actuating the tool through the robotic system 104. Examples of a payload 102 in a space-based application of the system 100 include a tool for capturing a free flyer object and a refueling tool.

The payload 102 includes a machine vision target 108 on the payload 102. The machine vision target 108 may be a space vision marker system target in a space-based robotics implementation. The machine vision target 108 is positioned on the payload 102 such that a machine vision system 110 of the robotic system 104 can detect and track the machine vision target 108. The machine vision target 108 may include an encoding of data bits enabling which, when decoded by the machine vision system 110, identifies the payload 102. The machine vision system 110 is configured to assist in alignment for capture. Given that the end effector 116 may provide a relatively forgiving capture envelope, in some embodiments, components of the machine vision system 110 responsible for alignment may be simplified and/or have lower performance requirements than may otherwise be required of robotic capture tasks of a similar nature.

The machine vision system 110 is shown in greater detail in FIG. 1B. The machine vision system 110 includes a camera subsystem 132 for visualizing the machine vision target 108, a processor for generating and processing image data collected by the camera subsystem, a memory for storing the image data, and a communication interface for communicating with other components of the robotic system 104 (e.g. communicating information about detection and tracking of the machine vision target 108). The processor is configured to execute a recognition module 134. The recognition module 134 uses the image data provided by the camera subsystem 132 to identify the payload 102. The recognition module 134 references a target recognition database 136 stored in the memory to determine whether the processed machine vision target image data matches a given payload. The machine vision system 110 may also include an alignment module (not shown) for performing system alignment for capture. The alignment module (as well as camera subsystem 132 used for vision on alignment) may be simplified (e.g., lower performance requirements) given the relatively wide capture envelope of the robotic system 104, particularly over traditional approaches to visual alignment tasks in robotic capture operations of similar nature.

The camera subsystem 132 may include one or more cameras. The camera subsystem 132 may be configured to capture images of the machine vision target 108 for worksite registration and payload identification, image target fiducials (for photogrammetry measurements), and perform general inspection of hardware. In some cases, the camera subsystem 132 may include a camera for machine vision target 108 viewing and a camera for imaging target fiducials for photogrammetry measurements. In some embodiments, the camera subsystem 132 may include a camera focused at close range and a camera focused at mid-range. The close range camera may be used for target 108 viewing and hardware inspection from a working distance, while the mid-range camera may be used for general inspection of hardware (from further away than the close range camera) and imaging target fiducials. In an embodiment, the close range camera may be mounted above the grapple subsystem 146 and/or torquer subsystem 148 and the mid-range camera may be mounted to a side of the grapple subsystem 146 (e.g., at substantially the same height as the grapple subsystem 146). In an embodiment, the close range camera is a boresight camera and the mid-range camera is a photogrammetry camera. The close range camera may be configured and/or used for imaging the machine vision target 108 on payload 102. The images may be used to extract a six degrees of freedom (DOF) pose, which may enable positioning of the robotic system 104 accurately with respect to a worksite.

The robotic system 104 includes a robotic arm controller 112 for controlling movement of a robotic arm 114. The robotic arm controller 112 includes a processor for processing data, a memory for storing data, and a communication interface for communicating with the machine vision system 110 and the robotic arm 114. For example, the robotic arm controller 112 may receive data from the machine vision system 110 regarding the detection and tracking of the machine vision target 108 (and thus, the payload 102) and generate arm movement commands based on the received machine vision data. The robotic arm controller 112 may then send the arm movement commands to the robotic arm 114 to control movement of the robotic arm 114.

The robotic system 104 further includes a multipurpose end effector (“MEE”) 116 connected to the robotic arm.

The MEE 116 is configured to capture (grapple and rigidize) the payload 102 via a grapple fixture 118 on the payload 102.

The MEE 116 is further configured to actuate the payload 102 via a torque element 120 on the payload 102.

The torque member or element 120 is connected to a torque driven subsystem 122 of the payload 102. Torque applied to the torque element 120 is transferred through the torque element 120 to the torque drive subsystem 122 to drive the torque driven subsystem 122.

The grapple fixture 118 includes a coupling element 124 and a grapple probe 126 connected to the coupling element 124. The coupling element 124 may be mounted to the payload 102 via a mounting surface. The grapple probe 126 extends from a connecting end (not shown) used to connect the grapple probe 126 to the coupling element 124. The other end of the grapple probe 126 is a probe tip 128. The probe tip 128 may have a rounded outer surface. The probe tip 128 may be hemispherical in shape. The grapple probe 126 may be connected to the coupling element 124 such that the grapple probe 126 is substantially perpendicular to the mounting surface of the coupling element 124 in a resting state. In some cases, the grapple probe 126 may be deflectable (e.g. through attaching the probe 126 to the coupling element 124 via a deflectable joint, such as a spring).

In an embodiment, the coupling element 124 may include a notched outer periphery for interfacing with a similarly notched component of the end effector 116 (interlocking). The notches of the notched periphery are interspaced with non-notched segments of the periphery (“teeth” or “lobes”).

Optionally, the payload 102 includes an electrical umbilical 130. The electrical umbilical 130 acts as an interface for the transfer of power and/or data from the end effector 104 to the payload 102. The electrical umbilical 130 may be connected to a power output system of the payload 102 for supplying power to components of the payload 102 or to a data processing system of the payload 102 for receiving and processing data.

The machine vision target 108, torque member 120, grapple fixture 118, and electrical umbilical 130 compose a prepared interface 138 of the payload 102. The prepared interface 138, when present on a payload 102, prepares the payload 102 for interfacing with (capture and manipulation by) the end effector 116.

The MEE 116 includes an arm interfacing end 140 for interfacing with the robotic arm 114 and a payload interfacing end 142 for interfacing with the payload 102.

The arm interfacing end 140 includes a robotic arm interface 144 for connecting the end effector 116 to the robotic arm 114 to enable manipulation of the end effector 116 by the robotic arm 114. The robotic arm interface 144 includes connections for transferring power, transferring data, and actuating components of the end effector 116. The robotic arm interface 144 also includes physical connections of the robotic arm 114 to the end effector 116.

The robotic arm interface 144 interfaces with various components of the payload interfacing end 142 to enable operation of the subsystems and mechanisms of the payload interfacing end 142.

The payload interfacing end 142 includes a grapple subsystem 146 and a torquer subsystem 148. Optionally, the payload interfacing end 142 includes a power/data passthrough mechanism 149. The power/data passthrough mechanism 149 is configured to interface with electrical umbilical 130 on payload 130 and pass one or more of power or data through to the payload 102. In some embodiments, the power/data passthrough mechanism 149 includes a plurality of umbilical assemblies. In a particular embodiment, at least one umbilical assembly is located on each side of the grapple subsystem 146. The power/data passthrough mechanism 149 enables the end effector 116 to grapple a tool that requires transfer of power and/or data.

The payload interfacing end 142 may include a refueling subsystem. The refueling subsystem may include a fuel coupling configured to interface or couple with a refueling receiving component on the payload 102 (not shown). The payload interfacing end 142 may also include electrical pass-throughs, and multi-purpose end effector embodiments with a fluid pass through valving that interfaces with a payload umbilical. Fluid may be liquid or gases including pressurized fluid.

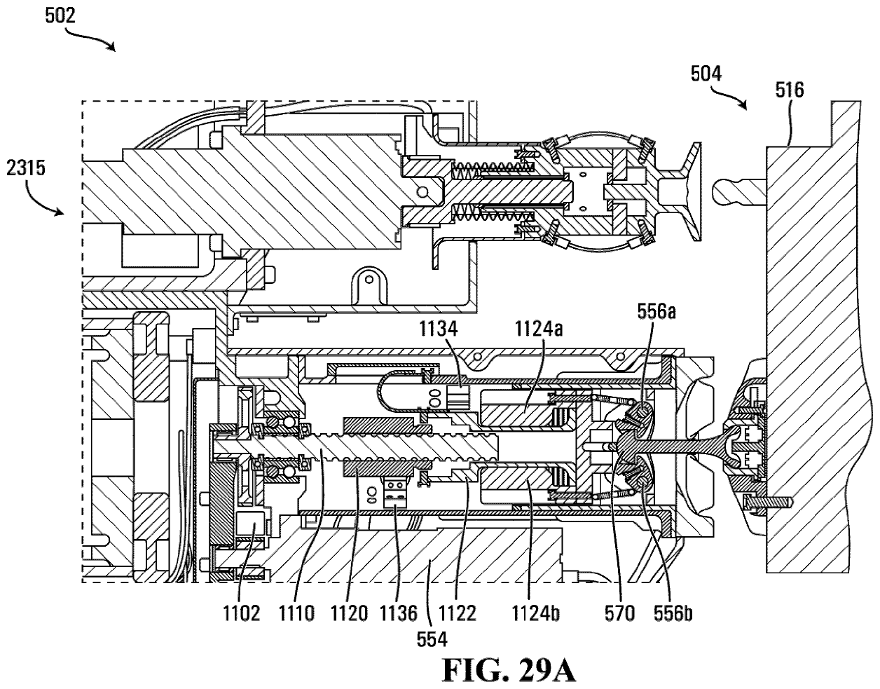

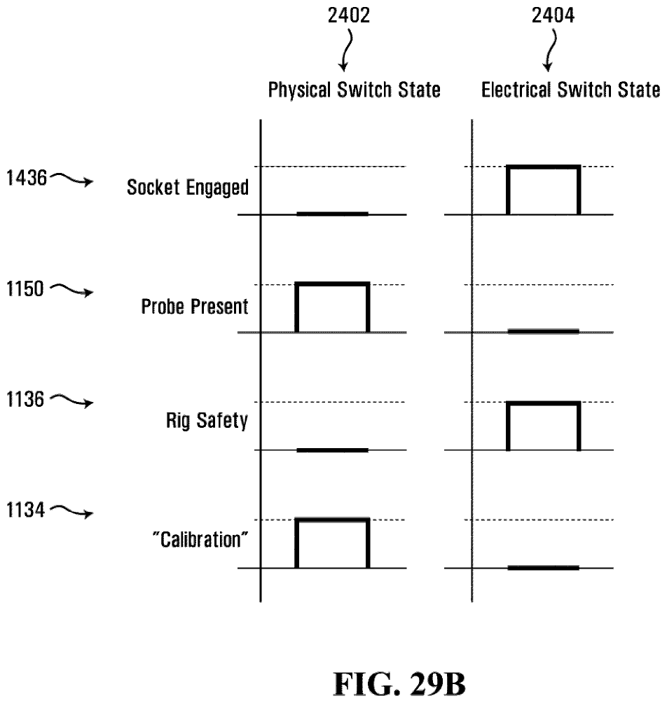

In some embodiments, the MEE 116 may include a mechanism for load limiting via sensed feedback. In an embodiment, the MEE 116 may include a force torque sensor (FTS). The FTS may be mounted internally. The FTS may be mounted in a primary load path of the grapple subsystem 146 or grapple mechanism (e.g., grapple mechanism 150 of FIG. 1C). The FTS may provide measurement of three axes of forces and three axes of moments. In an embodiment, the FTS includes an FTS hardware frame that orients x and y in the lateral direction, with z in the axial direction. Generally, soft capture (as described herein, and as shown, for example, in FIG. 29A) by the MEE 116 with low initial loads puts the interface into a state where rigidization loads can be precisely controlled. Soft capture corresponds to a state where the probe tip 128 has been captured by the grapple subsystem 146 (i.e., grapple jaws 164 of FIG. 1C have closed on and grappled the probe tip 128), but rigidization of the interface (as described herein) has not yet occurred. The FTS may be used to limit loads during grappling, payload handling, or payload attachment to or removal from an interface, in order to facilitate robotic operations.

The grapple subsystem 146 provides a means of grappling and rigidizing the robotic arm 114 to hardware interfaces on a payload 102 via the grapple fixture 118. By grappling and rigidizing the interface between the end effector 116 and the payload 102, the grapple subsystem 146 enables subsequent manipulation of the payload by the end effector 116.

The grapple subsystem 146 is shown in more detail in FIG. 1C.

The grapple subsystem 146 includes a grapple mechanism 150 for performing grappling and rigidization of the payload to end effector interface, a grapple motor module 152 for driving the grapple mechanism 150, and a grapple mechanism state sensing subsystem 154 for performing state sensing in the grapple mechanism 150.

The sensing subsystem 154 generates output signals based on sensed state changes in the grapple mechanism 150 that are used to control an output of the grapple motor module 152 or other components.

The grapple mechanism 150 includes a probe receiving end 156 configured to receive the grapple probe 126 of the grapple fixture 118. The probe receiving end 156 includes a coupling element 158 and a grapple opening 160 in the coupling element 158 for receiving the grapple probe 126 therethrough to enter the grapple mechanism 150.

The coupling element 158 may have a concave surface for guiding the grapple probe 126 into the grapple opening 160. For example, the profile of the concave surface, the profile of the probe tip 128 of the grapple probe 126, and the relative motion of the payload 102 and the end effector 116 may function together to guide an off-center (in multiple translational and rotational axes) probe 126 (that is, a probe 126 not precisely aligned with the opening 160) by forcing the probe tip 128 to slide along the concave surface of the coupling element 158 towards and through the opening 160.

The coupling element 158 is configured to mate with the coupling element 124 of the grapple fixture 118 upon contact of the coupling elements 158, 124. The profile of the concave surface of the coupling element 158 may complement the profile of the mating surface of the coupling element 124 (e.g. concave and convex). In the embodiment where the coupling element 124 of the grapple fixture 118 has a notched periphery, the coupling element 158 also has a notched periphery. Generally, upon mating, the teeth of the grapple fixture coupling element 158 situate in and contact the notches of the end effector coupling element 158 and the teeth of the end effector coupling element 158 situate in and contact the notches of the grapple fixture coupling element 124. In some cases, the notched peripheries may include curved surfaces to facilitate misaligned teeth-notch pairs to slide into position where the teeth are situated in the notches. As such, the coupling elements 124, 258 may facilitate alignment of the interface and provide improved resistance to torque along the long axis.

The grapple mechanism 150 further includes a jaw assembly 162. The jaw assembly 162 incudes grapple jaws 164 and a jaw actuator 166. The jaw actuator 166 is connected to the grapple jaws 164 and configured to move the grapple jaws 164 between an open configuration and a closed configuration. The grapple jaws 164 are configured to be actuated between open and closed configurations (to enable entry of the grapple probe 126 into the throat of the jaws 164, and to grab the probe, and eventual release respectively). In an embodiment, the grapple jaws 164 includes two jaw elements which form the jaws.

The grapple mechanism 150 further includes a jaw assembly translator 168 for translating the jaw assembly 162 along the capture axis of the grapple mechanism 150 in either direction (towards the payload interfacing end, “forward”, or away from the payload interfacing end, “retraction”). The jaw assembly translator 168 is a translation mechanism driven by the grapple motor module 152. In an embodiment, the jaw assembly translator 168 may include a ball screw rotatable via the grapple motor module 152 and a ball nut, where the jaw assembly 162 is connected to the ball nut such that rotation of the ball screw causes the ball nut to translate the jaw assembly 162.

The jaw actuator 166 may be mechanically connected to the jaw assembly translator 168 such that retraction of the jaw assembly 162 past a certain position along the capture axis causes the jaw actuator 166 to move the grapple jaws 164 from the open position to the closed position. Similarly, forward translation of the jaw assembly 168 past a certain position along the capture axis may cause the jaw actuator 166 to move to grapple jaws 164 from the closed configuration to the open configuration.

The grapple mechanism 150 also includes a compressible element 170 for compressing to generate a target preload and rigidize the interface between the grapple fixture 118 and the end effector 116. The compressible element 170 is then released or decompressed to release the preload (i.e. upon release of the grapple fixture). In an embodiment, the compressible element 170 includes one or more Belleville spring stacks or washers. The compressible element 170 is mounted in the primary load path of the grapple mechanism 150. The Belleville stack has two seating surfaces. At first, the screw sleeve starts contacting/compressing the Belleville stack.

In an embodiment, the compressible element 170 may be mounted or otherwise positioned between a first compressing surface of the jaw assembly translator 168 (at an end of the compressible element 170 proximal the payload interfacing end) and a second compressing surface of the jaw assembly 162 (at an end of the compressible element 170 distal the payload interfacing end), such that the compressible element 170 is biased between the first and second compressing surfaces. The jaw assembly translator 168 is configured to retract the jaw assembly 162 only to a certain point during capture and rigidization, after which point the jaw assembly translator 168 continues to retract along the capture axis. This continued retraction compresses the compressible element 170 between the first and second compressing surfaces as the first surface is retracted and the second surface is stationary. The amount of retraction can be measured (e.g. via the state sensing subsystem 154) and retraction stopped upon a target preload of the compressible element 170 being generated. In some cases, multiple target preloads may be possible via different degrees of retraction and compression of the compressible element 170.

The jaw assembly 162 is part of a “moving component” of the grapple mechanism 150 which translates along the capture axis of the grapple mechanism 150 during retraction and release. The moving component also includes one or more components of the jaw assembly translator 168 which translate along the capture axis during retraction and release, including the first compressing surface used to compress the compressible element 170. For example, in an embodiment, the moving component may include the jaw assembly 162 and a ball nut and screw sleeve which are part of the jaw translator mechanism 168. The first compressing surface used to compress the compressible element 170 may be an arm-interfacing end facing surface of the screw sleeve.

The grapple mechanism state sensing subsystem 146 includes a probe present sensor 172 and a translation position tracking sensor 174 for calibration.

The probe present sensor 172 is used to detect that the grapple probe 126 has entered a grappling area between the grapple jaws 164. The probe present sensor 172 may be disposed at a distal end of the grappling area such that the probe tip 128 of the grapple probe 126 has to enter the grappling area and into position for grappling by the jaws 164 in order to trigger the payload present sensor 172.

Any suitable type of sensor may be used as the payload present sensor 172. In an embodiment, the payload present sensor 172 includes a physical contact sensor that registers a state change when the sensor is contacted by the probe tip 128.

The state change registered by the payload present sensor 172 is used as an indicator to actuate the grapple jaws 164 closed using the jaw actuator 166.

The translation position tracking sensor 174 is used for calibration to detect when the jaw assembly 162 leaves a calibration or home position during retraction. For example, the sensor 174 may have a first state when the jaw assembly 162 is in the home position and a second state when the jaw assembly 162 is not in the home position. The sensor 174 may include a physical switch that is engaged/disengaged when the jaw assembly 162 is translated out of the home position. The sensor 174 registers the state change. The state change is communicated to a position tracking device, such as a resolver, which tracks or computes displacement along the capture axis relative to the home position. The position tracking device may be a component of the grapple motor module 152. The position tracking device is configured to generate a signal when a predetermined displacement (“target preload position”) is achieved and output the signal to the motor, stopping the motor and arresting translation. In an embodiment, the position tracking device may track motor turns to determine when the target position is reached.

An example sequence of operation of the grapple subsystem 146 will now be described. As the end effector 116 is moved towards the grapple fixture 118 on the payload 102, the grapple probe enters the grapple mechanism 150 through the opening 160 in the probe receiving end 156. The grapple probe 126 continues to move into the grapple mechanism 150 such that the probe tip 128 enters the grappling area between the open grapple jaws 164. In doing so, the probe tip 128 triggers a state change in the probe present sensor 172. A signal indicating the state change is outputted to the grapple motor module 152. Upon receiving the signal, the grapple motor module 152 drives the jaw assembly translator 168 to retract the jaw assembly 162 along the capture axis. The initial retraction of the jaw assembly 162 causes the jaw actuator 166 to move the grapple jaws 164 to the closed position to grapple the probe tip 128. As the jaw assembly 162 is retracted by the jaw assembly translator 168, the grapple probe 126 is retracted as well, drawing the coupling element 128 on the payload 102 towards the coupling element 158 of the end effector 116.

As the jaw assembly 162 is retracted out of the home position, the translation position tracking sensor 174 is triggered by the movement of the jaw assembly 162 and registers a state change. A signal indicating the state change is outputted to the position tracking device which starts to track position. The position tracking device outputs a stop signal to the grapple motor module 152 when a target preload position is reached. Upon receiving the stop signal, the motor stops driving the jaw assembly translator 168.

The target preload position is a position at which the coupling elements 128, 158 of the grapple fixture 118 and end effector 116, respectively, have been brought into mating contact and the compressible element 170 has been compressed, as described above. Accordingly, the target preload position may include retraction by the jaw assembly translator 168 past a point at which the jaw assembly 162 is no longer retracted or retractable, in order to compress the compressible element 170 between compressing surfaces of the jaw assembly 162 and the jaw assembly translator 168.

Referring again to FIG. 1A, the torquer subsystem 148 is shown in greater detail in FIG. 1D.

The torquer subsystem 148 includes a torquer mechanism 176 for applying torque to the torque element 120 on the payload 102, a torquer motor module 178 for driving the torquer mechanism 176, and a torquer mechanism state sensing subsystem 180 for sensing state changes in the torquer mechanism 176 and outputting signals to the torquer motor module 178 to alter an output of the motor module 178.

The torquer mechanism 176 includes a torquer seating element 182 (e.g. socket head) for receiving and seating the torque element 120 as the end effector 116 moves closer to the payload 102 (e.g. during capture by the grapple subsystem 146).

The torquer mechanism 176 further includes a seating element rotator 184 for rotating the seating element to impart torque to a seated torque bolt 120. The seating element rotator 184 may also be used to rotate the seating element 182 when the seating element 182 is misaligned to the torque element 120, to properly align. The seating element rotator 184 is driven by the torque motor module 178.

The torquer mechanism 176 further includes an axial compliance mechanism 186. The axial compliance mechanism 186 is used to passively retract the torquer seating element 182 from the torque element 120 upon contact between a misaligned torque element 120 and the seating element 182. In an embodiment, the axial compliance is achieved through a spring-loaded torquer seating element 182 (where misaligned contact compresses the spring, causing retraction).

The torquer mechanism state sensing subsystem 180 includes a seating element engaged sensor 188 which is used to sense and register a state change when the seating element 182 is properly aligned to/seated on the torque element 120 versus when the seating element 182 is misaligned to/not seated on the torque element 120. For example, the sensor 188 may have a first state when the seating element 182 is in the forward position and a second state when the seating element 182 is retracted from the forward position (i.e. the axial compliance mechanism 186 is engaged). In an embodiment, the sensor 188 may include a switch positioned such that the seating 182 element engages the switch when the seating element 182 is forward and disengages the switch when the seating element 182 is retracted (or vice versa).

Based on the sensed state change indicating the misalignment (via retraction from the forward position), the torquer motor module 178 drives the seating element rotator 184 to rotate the seating element 182 to properly seat on the torque element 120. The rotation of the seating element 182 may be commanded automatically within the robotic system 104 or may be commanded by the robotic workstation 106 (e.g. an operator commands rotation of the seating element 182 until properly seated). Upon properly seating the torque element 120, the seating element 182 returns to the forward position (axially compliance mechanism 186 no longer engaged) and the seating element engaged sensor 188 senses and registers the state change. A signal indicating the state change is outputted to the torque motor module 178. In response to the received signal, the torque motor module 178 drives the seating element rotator 184 to rotate the torquer seating element 182. Rotation of the seating element transfers torque to the torque element 120 by rotating the seated torque element 120, and the torque element 120 transfers the applied torque to the torque driven subsystem 122 of the payload.

The seating element rotator 184 may be configured to apply a desired amount of torque (e.g. through counting rotations).

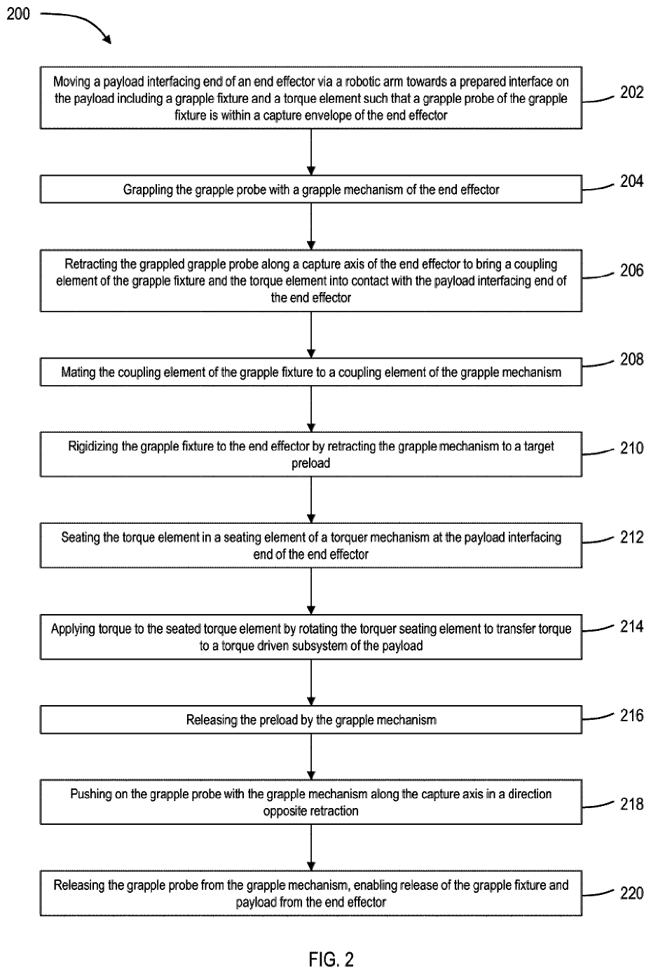

Referring now to FIG. 2, shown therein is a method 200 of robotic capture and manipulation of a payload, according to an embodiment.

The method 200 may be implemented using the system 100 of FIG. 1. In describing the method 200, explicit reference may be made to components of the system 100 of FIG. 1 as examples of components performing certain functions or steps. In other instances, explicit reference to components of system 100 may not be made but it is understood that components of system 100 may be used or configured to perform certain functions or steps though not explicitly referenced.

At 202, a payload interfacing end of an end effector is moved via a robotic arm towards a prepared interface on the payload. The prepared interface includes a grapple fixture and a torque element. The end effector is moved by the robotic arm towards the prepared interface such that a grapple probe of the grapple fixture is within a capture envelope of the end effector.

At 204, the grapple probe is grappled with a grappling mechanism of the end effector.

At 206, the grappled grapple probe is retracted along a capture axis of the end effector to bring a coupling element of the grapple fixture and the torque element into contact with the payload interfacing end of the end effector.

At 208, the coupling element of the grapple fixture is mated to a coupling element on a front end of the grapple mechanism by the continued movement of the respective coupling elements towards each other through retraction of the grapple probe connected to the coupling element of the grapple fixture.

At 210, the grapple fixture is rigidized to the end effector by retracting the grapple mechanism to a target preload.

At 212, the torque element is seated in a seating element of a torquer mechanism of the end effector at the payload interfacing end of the end effector.

At 214, torque is applied to the seated torque element by rotating the torquer

seating element to transfer torque to a torque driven subsystem of the payload. The torque element is connected to the torque driven subsystem in the payload such that the transfer of torque to the torque element through its rotation by the seating element is transferable to the torque driven subsystem to drive the torque driven subsystem.

At 216, the preload generated at 110 is released by the grapple mechanism.

At 218, the grapple mechanism pushes on the grapple probe along the capture axis in a direction opposite retraction to drive the grapple probe out of the grapple mechanism.

At 220, the grapple probe is released from the grapple mechanism. The release of the grapple probe enables the release of the grapple fixture, and thus the payload, from the end effector.

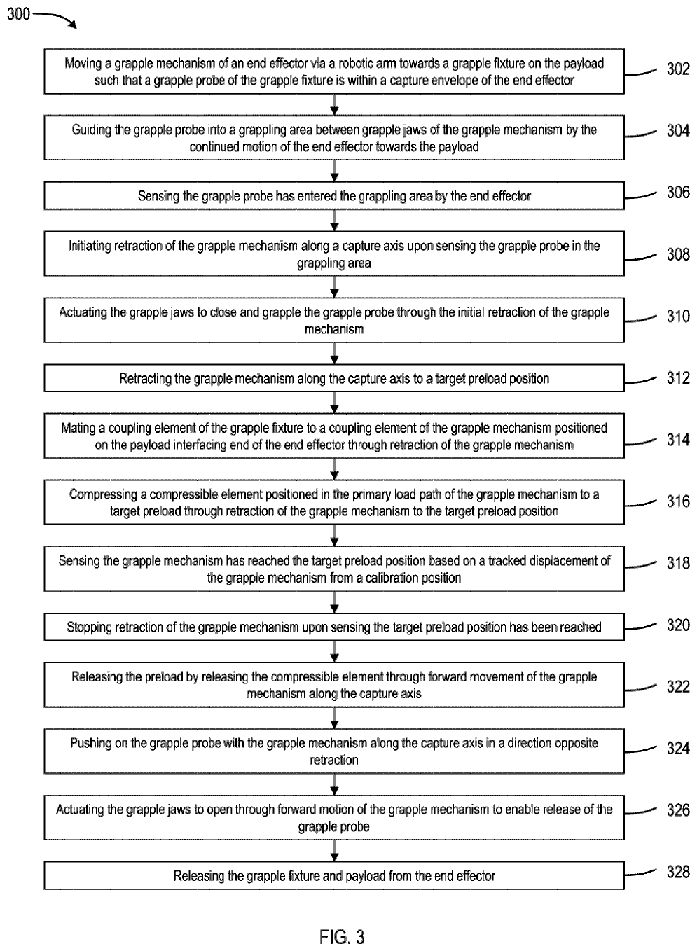

Referring now to FIGS. 3A and 3B, shown therein is a method 300 of robotic capture of a payload using an end effector, according to an embodiment.

The method 300 may be implemented using the system 100 of FIG. 1. In describing the method 300, explicit reference may be made to components of the system 100 of FIG. 1 as examples of components performing certain functions or steps. In other instances, explicit reference to components of system 100 may not be made but it is understood that components of system 100 may be used or configured to perform certain functions or steps though not explicitly referenced.

The method 300 can be used to grapple and rigidize the payload to the end effector to enable subsequent manipulation or actuation of the captured payload.

In an example, the method 300 may be used in a space-based application, where the payload is a tool, such as a free flyer capture tool or a refueling tool.

At 302, a grapple mechanism of the end effector is moved via a robotic arm towards a grapple fixture on the payload such that a grapple probe of the grapple fixture is within a capture envelope of the end effector.

Movement commands for the robotic arm are received from a robotic arm controller connected to the robotic arm. The movement commands may be generated at a robotic workstation and communicated to the robotic arm controller. In a space-based application, the robotic workstation may be on ground or other remote location.

At 304, the grapple probe of the payload is guided through continuation motion of the end effector towards the payload into a grappling area.

The grappling area is located between grapple jaws of the grapple mechanism such that, when the grapple jaws are actuated to close, the grapple jaws will grapple the grapple probe. The guiding of the grapple probe into the grappling area may include guiding a probe end of the grapple probe towards and into the grappling area via a probe guiding surface having a concave profile (“grapple face”) disposed at the payload interfacing end of the end effector. The grapple face may include a centrally located opening in the probe guiding surface towards and through which the grapple probe is guided by the concave profile of the surface and the continued motion of the end effector towards the payload. The guiding of the grapple probe by the grapple face through the opening and into the grappling area may also constrain the grapple probe to a position generally parallel to a capture axis along which the grapple probe will be retracted during capture.

At 306, the end effector senses that the grapple probe has entered the grappling area.

This may include, for example, triggering a sensing element positioned in or near the grappling area such that the sensing element is triggered by the grapple probe only when the grapple probe is in the grappling area. In an embodiment, this may be achieved by positioning a sensing element at a distal end of the grappling area that is triggerable by physical contact with the probe end of the grapple probe (e.g. depressing a sensing element). The sensing includes generating a state change signal reflecting the state change (payload present, grapple probe in grappling area). The state change signal can then be communicated to one or more other components of the grapple mechanism to effect subsequent operations based on the present state (payload present).

At 308, translation of the grapple mechanism along the capture axis in a direction opposite the payload interfacing end (“retraction”) is initiated in response to sensing the presence of the grapple probe in the grappling area at 206.

The state change signal generated at 306 is sent to and received by a translation mechanism, which initiates retraction upon receiving the state change signal. In an embodiment, the state change signal may be communicated to a grapple motor module. In response to receiving the state change signal, a motor component of the grapple motor module drives the translation mechanism to retract the grapple mechanism. This may include, for example, driving rotation of a ball screw or the like, causing a ball nut to retract along the ball screw, moving the grapple mechanism (or components thereof) through connection to the ball nut.

At 310, the grapple jaws are actuated to close (move from open state to closed state) through the initial retraction of the grapple mechanism at 208.

For example, the initial retraction of the grapple mechanism may cause a jaw actuating component of the grapple mechanism to mechanically actuate the grapple jaws to close through mechanical link or connection to the translation mechanism. A spring is connected to the probe present bar. A pair of springs keeps the payload present switch activated during mechanism retraction.

At 312, the grapple mechanism, having grappled the grappled probe, is retracted along the capture axis to a target preload position. The target preload position may be precalibrated.

At 314, a coupling element of the grapple fixture is mated to a coupling element of the grapple mechanism positioned on the payload interfacing end of the end effector through the retraction of the grapple mechanism.

The coupling element may be a component of the grapple face of the end effector. For example, the grapple face may act as both a probe guiding surface and a coupling element.

Generally, the grapple fixture coupling element is mounted to the payload, acting as a base component for the grapple fixture and the coupling element of the end effector is at the payload interfacing end, so the retraction of the grapple probe along the capture axis brings the coupling elements together and into contact.

Mating of the respective coupling elements may be used to promote alignment of the interface between the grapple fixture and the end effector (e.g. in the case of positional misalignment of the grapple interface).

The mating of the coupling elements may also improve overall combined load capacity (e.g. stiffer interface when picking the payload up).

The mating of the coupling elements may limit or eliminate any rotational play about the roll axis at the end effector to grapple fixture interface. The mating of the coupling elements may make the grapple interface stronger in relation to torques about the long axis.

At 316, a compressible element positioned in the primary load path of the grapple mechanism is compressed to a target preload through retraction of the grapple mechanism to the target preload position.

The compressible element may be a Belleville spring stack or the like. By compressing the compressible element, the target preload is achieved and the interface between the grapple fixture and the end effector is rigidized.

At 318, the end effector senses that the grapple mechanism has reached the target preload position based on a tracked displacement of the grapple mechanism along the capture axis from a calibration position.

This may include, for example, sensing when the grapple mechanism leaves the calibration position, generating a state change signal in response to leaving the calibration position, communicating the state change signal to a position monitoring component, monitoring the displacement of the grapple mechanism along the capture axis from the calibration position via the position monitoring component, and generating a state change signal when the position monitoring component identifies the target preload position is reached.

At 320, the retraction of the grapple mechanism along the capture axis is stopped in response to sensing the target preload position has been reached at 318.

This may include, for example, the translating mechanism receiving the state change signal generated by the sensing at 318 and stopping retraction of the grapple mechanism. In an embodiment, this may include the state change signal being communicated to a motor which, in response to receiving the signal, stops driving rotation of a ball screw used to translate the grapple mechanism.

At this stage, the payload is rigidized to the end effector through the grapple fixture. The payload may be manipulated by the end effector. Manipulation may include, for example, maneuvering the payload (through commanded movement of the robotic arm to which the end effector is connected), actuating the payload (e.g. transferring torque through a torquing interface on the payload to actuate a torque driven subsystem of the payload), or passing power, fuel, and/or data from the end effector to the payload through an electrical umbilical interface.

The steps that follow relate to the release of the payload captured and rigidized through steps 302-320. The release is initiated via command from robotic work station 106 to robotic arm controller 112 to robotic arm 114 to MEE, etc. which powers the actuator in the direction for release. Some embodiments could include an external means of reversing the grapple mechanism. E.g., an EVA release by an astronaut or equivalent external robotic system action.

At 322, the preload generated at 316 is released by releasing (decompressing) the compressible element through forward movement of the grapple mechanism along the capture axis (i.e. translation opposite direction of retraction).

At 324, the grapple mechanism pushes on the grapple probe along the capture axis towards the payload interfacing end. This is effected through continued translation of the grapple mechanism in the forward direction.

At 326, the grapple jaws are actuated to open through the forward motion of the grapple mechanism along the capture axis to enable the release of the grapple probe. This may be effected through the jaw actuating component described at 310 (operating in the opposite direction, to move from closed to open).

At 328, the grapple fixture is released from the grapple mechanism and the payload is released from the end effector.

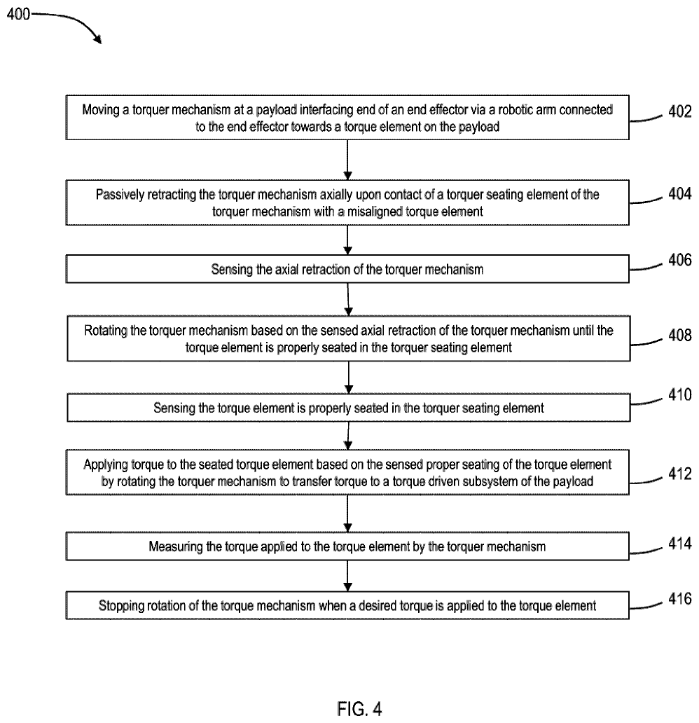

Referring now to FIG. 4, shown therein is a method 400 of robotically actuating a payload via an end effector, according to an embodiment.

The payload may be a tool and the method 400 may be used to actuate the tool to enable robotic capabilities. The method 400 may be implemented using the system 100 of FIG. 1. In describing the method 400, explicit reference may be made to components of the system 100 of FIG. 1 as examples of components performing certain functions or steps. In other instances, explicit reference to components of system 100 may not be made but it is understood that components of system 100 may be used or configured to perform certain functions or steps though not explicitly referenced.

At 402, a torque mechanism at a payload interfacing end of the end effector is moved via a robotic arm connected to the end effector towards a torque element on the payload.

Generally, the torque element is configured to have torque applied thereto and transfer the applied torque to a torque driven subsystem of the payload. In some cases, the movement at 402 may be part of a payload capture sequence, such as described in FIG. 2. For example, the end effector may move towards the payload, at least in part, because of a capture and rigidization process being performed by the end effector which brings the payload, and the torque element, closer to the payload interfacing end of the end effector.

The torque mechanism is brought into contact with the torque element. The torque element on the payload may or may not be properly aligned with a torquer seating element. Proper alignment facilitates seating of the torque element in the torquer seating element. The torquer seating element is configured to mate the torque element (e.g. complementary profiles). The torquer seating element is rotatable by operation of the torquer mechanism to transfer torque to the seated torque element.

At 404, the torquer mechanism passively retracts axially upon contact of the torquer seating element with a misaligned torque element.

This may occur, for example, via compression of a spring component in the torquer mechanism. For example, the torquer mechanism may include a spring loaded component (e.g. socket head) that includes the torquer seating element. The passive axial retraction may prevent the torquer seating element from continuing to move towards the torque element in instances where the torque element is misaligned (as the payload interfacing end of the end effector continues to move towards the payload).

At 406, the axial retraction of the torquer mechanism is sensed by the end effector.

This may be achieved, for example, by using a sensing element configured to register a state change when the torquer mechanism is displaced from a forward (“home”) position.

For example, axial retraction of the torquer mechanism may cause the torquer mechanism to engage (or disengage) a switch or other sensing element, registering a state change. The state change indicates that the torque element is not properly aligned/seated to the torquer seating element. The sensed state change can then be communicated to enable steps to be performed to properly seat the torque element.

At 408, the torquer mechanism is rotated based on the sensed axial retraction of the torquer mechanism from 406.

The torquer mechanism is rotated until the torquer seating element is properly seated on the torque element.

In an embodiment, the rotation of the torquer mechanism may be commanded by a human operator through a human-machine interface configured to generate a command based on an input from the user and send the command to the robotic system of which the end effector is a component. For example, the command may be sent from a robotic workstation (operator) to the robotic arm controller, which commands the robotic arm to cause the end effector to rotate the torquer mechanism.

In another embodiment, the rotation of the torquer mechanism may be performed automatically by the end effector without human user input.

Upon properly aligning and seating the torque element in the torquer seating element, the axial compliance in the torquer mechanism is released and the torquer mechanism moves forward to its home position. In an embodiment using a spring component, the compression force in the spring is removed and the spring component returns to a non-compressed state, moving the torquer mechanism axially forward.

At 410, the end effector senses that the torquer seating element is properly seated on the torque element.

This may include, for example, registering a state change in the sensing element described at 406 upon the torquer mechanism returning to the forward home position. For example, the forward axial motion of the torquer mechanism may cause the torquer mechanism to disengage (or engage) a switch or other sensing element, registering a state change. The state change indicates that the torque element is properly aligned/seated in the torquer seating element. The sensed state change can then be communicated to initiate operations (i.e. actuation) using the torquer mechanism.

At 412, the torquer mechanism is rotated to apply torque to the seated torque element in response to sensing the torquer seating element is properly seated on the torque element at 410.

This may be achieved, for example, by communicating the state change signal from the sensing element to a torquer motor configured to initiate rotation of the torquer mechanism upon receiving the state change signal.

The rotation of the torque element on the payload by the torquer mechanism transfers torque through the torque element to the torque driven subsystem of the payload connected to the torque element. This enables actuation of the torque driven subsystem of the payload to perform one or more functions (e.g. tooling functions).

At 414, the torque applied by the torquer mechanism to the torque element is measured by the torquer mechanism.

This may include, for example, monitoring a number of turns of the torquer seating element (e.g. to a desired or predetermined number) or an amount of torque applied (e.g. via current limiting). The torquer mechanism may include a resolver for the rotational position monitoring.

At 416, the torquer mechanism stops rotation of the torquer seating element when the desired torque has been applied to the torque element.

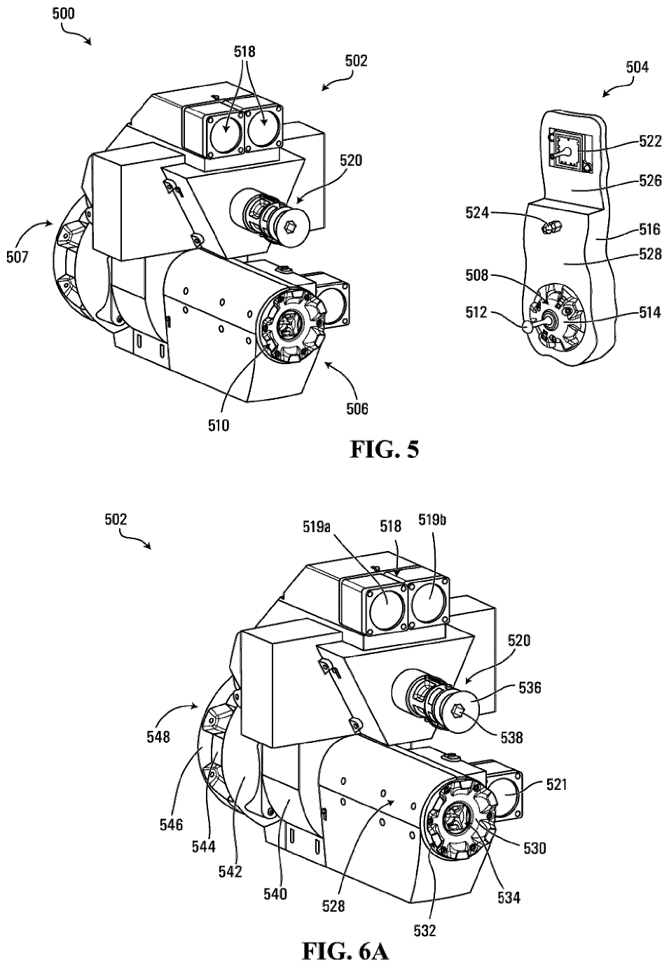

Reference will now be made to FIGS. 5 to 20, which illustrate an embodiment of a robotics-based system of the present disclosure. The embodiment is an example of the system 100 of FIG. 1 and may be used to implement any one or more of the methods of FIGS. 2 to 4. The embodiment is designed for a space-based robotics application, such as in on orbit robotic servicing of payloads, but may also be used in non-space-based applications (with or without modification, as appropriate).

Referring now to FIG. 5, shown therein is a system 500 for robotic capture and actuation of a payload, according to an embodiment.

The system 500 includes an end effector (EE) 502 for interfacing with a prepared interface 504. The prepared interface 504 is on a payload 516. The payload 516 may be a spacecraft or other hardware, such as a dedicated tool (e.g. free flyer capture tool, refueling tool). By interfacing with the payload 516 through the prepared interface 504, the end effector 502 can grapple and actuate the payload 516.

The EE 502 includes a payload interfacing end 506 for interfacing with the payload 516 via the prepared interface 504 and an arm interfacing end 507 for connecting the EE 502 to a robotic manipulator (e.g. robotic arm).

Generally, during interfacing, the robotic manipulator is used to move the payload interfacing end 506 of the EE 502 towards the prepared interface 504 on the payload 516. In some cases, the arm interfacing end 507 may be used at a host-EE interface, where the host is an operator of the robotic system of which the robotic arm and end effector are a part, and the payload interfacing end 506 may be used at an EE-user interface, where the user is the payload 516 owner (or otherwise in control of the payload 516) and wishes to engage the services of the host/operator in the manipulation of the payload 516. This may provide a walking arm embodiment, as described below.

The prepared interface 504 includes a machine vision target 522. The machine vision target 522 is disposed on a first surface 526 of the payload 516. The machine vision target 522 enables visualization of the payload 516. In some cases, the machine vision target 522 may enable identification of the payload 516. By identifying the payload 516 as being of a certain class (e.g. a certain type of tool), the EE 502 may be commanded to interface with the payload 516 based on the identity of the payload 516.

The prepared interface 504 includes a torque element 524. The torque element 524 may also be referred to as a torque bolt or actuation member. The torque element 524 is disposed on a second surface 528 of the payload 516.

The torque element 524 in the embodiment of FIG. 5 is a ball end hex bolt (e.g. 7/16″). In other embodiments, the torque element 524 may have other shapes or configurations.

The torque element 524 connects to a torque driven subsystem (not shown) of the payload 516. The torque element 524 enables actuation of the payload 516 through the torque element 524. In particular, the torque element 524 enables reception and transfer of torque to the torque driven subsystem, thereby driving the torque driven subsystem. In doing so, the torque driven subsystem can be driven through torque generated external to the payload 516.

The prepared interface 504 includes a grapple fixture 508.

The grapple fixture 508 is disposed on the second surface 528 of the payload 516. The grapple fixture 508 includes a coupling element 514 and a grapple probe 512 (or probe 512). The coupling element 514 is mounted to the second surface 528 of the payload 516. The grapple fixture 508 enables capture of the payload 516. In particular, the grapple fixture 508 enables grappling and rigidization of the payload 516 via the grapple probe 512 and coupling element 514.

The payload 516 to which the prepared interface 504 is attached may be considered a “prepared element” or “prepared asset”, where the payload 516 has been “prepared” in advance with the prepared interface 504 to enable the EE 502 to interact with the payload 516. In some cases, the prepared interface 504 may be a standardized interface that can be provided on a variety of payloads to simplify the implementation of the system 500.

A vertical layout in the current flight system may improve packaging and volume/mass decisions for placement of the torquer and camera with respect to the end effector and may provide improved payload packaging and assembly needs for the mission. Other layouts may be provided to integrate with different system solutions on the payload side.

The target and grapple fixture may have their normal vectors in the same direction and aligned with camera optic axis and end effector axis respectively (˜20° offset in pitch/yaw might be tolerable, but should be avoided). The target and grapple fixture may be close together to minimize calibration complexity and thermal distortion effects.

The grapple fixture and torque bolt may have their normal vectors in the same direction to minimize initial alignment issues prior to extension of the torque. Embodiments include where torque is pitched/yawed 90° to the grapple fixture axis. The grapple fixture and torque bolt may be close together to minimize alignment issues, load path lengths, and thermal distortion effects

The EE 502 includes a camera subsystem 518 at the payload interfacing end 506 for visualizing the machine vision target 522.

The camera subsystem 518 may generate image data of the machine vision target 522 which can be processed by a processing device, which may be located in the EE 502 or the robotic arm to which the EE 502 is connected, in order to identify or determine a position and orientation of the payload 516. The camera subsystem 518 may be used for target viewing or worksite inspection. The camera subsystem 518 may provide images for pose estimation to support precise robotic alignment/positioning control, and situational awareness to system operators. The EE 502 provides means to inspect on-orbit assets via the camera subsystem 518. The system may include another camera use for photogrammetry.

The EE 502 includes a socket drive mechanism 520 at the payload interfacing end 506.

The socket drive mechanism 520 is configured to interface with the torque element 524 of the prepared interface 504. The socket drive mechanism 520 seats the torque element 524 and actuates the torque element 524, transferring torque thereto which can be passed to the torque driven subsystem of the payload 516.

The socket drive mechanism 520 may act as a torque passthrough mechanism to actuate the torque element 524, as well as other tools and/or mechanisms. The socket drive mechanism 520 provides clockwise (CW) and counterclockwise (CCW) rotation capability over a continuous range of motion. The rotation capability may be provided for a desired number of turns or until a desired torque is achieved (via current limiting). Accordingly, in cases where the payload 516 is or includes a dedicated tool (e.g., a free flyer capture tool, a refueling tool, etc.), the socket drive mechanism 520 may be used to actuate the dedicated tool.

The EE includes a grapple mechanism 510 at the payload interfacing end 506.

The grapple mechanism 510 is configured to receive, grapple, and rigidize the grapple fixture 508 via the grapple probe 512 and the coupling element 514. The grapple mechanism 510 of the EE 502 provides a means of grappling, capturing, and rigidizing dedicated tools (i.e. payload 516). In doing so, the grapple mechanism 510 enables the EE 502 to perform pick and place operations of prepared elements (i.e. payloads 516 having a prepared interface 504) through grappling, capturing, and rigidizing.

The grapple mechanism 510 provides a means for grappling and rigidizing hardware such as payloads or tools that are equipped with the grapple fixture 508. Once rigidized, both halves of the interface are engaged together and transmit static loads between them without separation of the interface, up to a maximum rigidization load capability of the EE 502. The grapple mechanism 510 provides a means of grappling and rigidizing a robotic arm (not shown) to hardware interfaces using the grapple fixture 508.

The EE 502 may be used to maneuver both large and small payloads. The EE 502 may act as an anchor for a walking arm. The EE 502 may be used to manipulate fasteners on the payload 516 or other hardware.

The system 500 may be controlled from the ground, with automated operations enabled from the ground and controlled via onboard arm control software.

In variations, the EE 502 may serve as a mechanical, electrical, data, and/or viewing interface between a robotic arm and an attached payload (e.g. payload 516) or a base structure (for the case of an end-over-end walking arm). Specific EE 502 functionality may include grappling the grapple fixture 508, seating and applying torque to the torque element 524, acting as a conduit for electrical power and data (e.g. to facilitate end-over-end arm walking or interfacing to a tool/payload that requires power and/or data) via an umbilical mechanism (not shown), and viewing functionalities for a variety of operations via the camera subsystem 518 (e.g. visual inspection, refueling). Note that interface load capacities may also be affected by which modular sub-assemblies are included (e.g., an EE 502 including the umbilical mechanism may be able to maintain a higher fully mated preload than an EE 502 not including them).

The EE 502 may be used to maneuver payloads via capture and release of a fixed payload/tool. The EE 502 may be used to perform capture and release of a free-flying (FF) payload with a FF capture/release tool. The EE 502 may be used to perform release of a FF payload from a FF capture/release tool. The EE 502 may further include functionality to react a load at an arm base, for walking arm cases where the EE 502 may be used to anchor a robotic arm to a structure.

In a particular embodiment, the EE 502 is configured to interface to a capture/release tool equipped with the grapple fixture 508, where the capture/release tool is configured to capture and rigidize a free-flying payload. For example, the socket drive mechanism 520 of the EE 502 may drive the tool's rigidization mechanism, including an umbilical between the EE 502 and the tool. A motor in the tool may drive latches that are on the tool-side of the interface. The EE 502 may grapple the FF capture tool and mate the umbilical (not shown). The tool's latch motor may be actuated through the umbilical and the latches engage onto load reaction features on the EE 502 side.

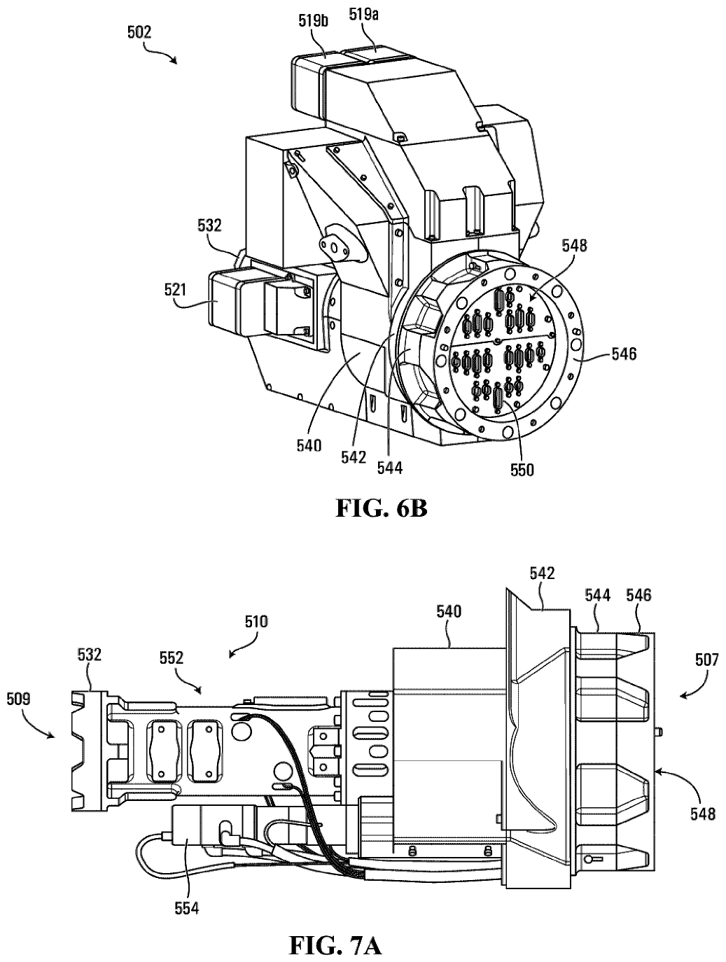

Referring now to FIGS. 6A and 6B, shown therein is the end effector 502 of the system 500 of FIG. 5 in isolation.

The camera subsystem 518 includes first and second boresight cameras 519a, 519b (referred to collectively as boresight cameras 519 and generically as boresight camera 519).

The first and second boresight cameras 519a, 519b may function as prime and redundant boresight cameras for providing redundant views (for providing operational failure tolerance). The boresight cameras 519 are used for viewing the machine vision target 522 on the prepared interface 504 during operations for alignment (e.g. using pose estimation algorithms). The boresight cameras 519 support automation by capturing images of the machine vision target 522 for worksite registration. This can be an important part of automated operations in terms of the ability to see something at the worksite that allows the system to become registered with the worksite during an operation. A six degrees of freedom (6DOF) pose may be extracted from the images acquired by the boresight cameras 519. The 6DOF pose may enable an operator to command the robotic system to position itself accurately with respect to the worksite. A 6DOF pose may be extracted from either of the redundant views.

The boresight cameras 519 may be used to inspect hardware from a working distance. The working distance may range from a high hover to a low hover.

In some cases, the boresight cameras 519 may provide black and white imagery.

The camera subsystem 518 also includes a photogrammetry camera 521.

The photogrammetry camera 521 is configured to image target fiducials for photogrammetry measurements. The camera 521 (photogrammetry camera) may also be used for general inspection of hardware. The camera 521 may enable inspection from, a distance that is further away from the target than that provided by the boresight cameras 519. The camera 521 has a working distance that is also suitable for performing inspections of hardware (from further away than using the boresight cameras). The photogrammetry camera 521 may provide black and white imagery.

In an embodiment, the boresight cameras 519 are focused at close range and the photogrammetry camera 521 is focused at midrange. In an embodiment, all three cameras 519a, 519b, and 521 may be the same but with lenses focused at a different distance and with different f-numbers, depending on functionality.

Each camera assembly 519, 521 may be paired with a Light Emitting Diode (LED) ring for illumination (not shown). In an embodiment, the boresight cameras 519 are equipped with red LEDs, and the photogrammetry camera 521 is equipped with white LEDs (not shown).

The cameras 519, 521 are mounted on the EE 502 to provide opportunities for inspection, situational awareness, and to see targets or other visual markers (fiducials) as required during operations. In some embodiments, the EE 502 may include one or more electrical umbilical assembly mechanisms for passing power or data through to the payload. The umbilical assembly mechanism is configured to interface (e.g., couple or mate) with a receiving component on the payload (e.g., electrical umbilical 130). The umbilical mechanism may be located to the left or right side of the grapple mechanism 510. In an embodiment, the camera 521 may be replaced with the umbilical assembly (i.e., the umbilical assembly mounted in substantially the same position as the camera 521).

The grapple mechanism 510 is implemented as a grapple cannister 528. The grapple cannister houses various components of the grapple mechanism 510.

Disposed at the payload interfacing end 506 of the grapple canister 528 is a front end of the grapple mechanism 510 which includes a coupling element 532. The coupling element 532 of the grapple mechanism 510 is configured to interface and mate with the coupling element 514 of the grapple fixture 508 on payload 516.

The coupling element 532 includes a concave face 530 and a generally circular opening 534 (grapple opening) centrally located on the concave face 530. The concave face 530 is used to guide the probe 512 of the grapple fixture 508 towards and through the opening 534 and into the grapple canister 528. The concave face 530 also has a profile that is generally complementary to a convex profile of the coupling element 514 of the grapple fixture 508, which promotes mating of the coupling elements 514, 532 during capture.

The socket drive mechanism 520 of the EE 502 includes a socket drive 536 (or socket head 536). The socket drive 536 includes a socket 538 centrally positioned at the payload interfacing end 506 of the socket drive 536. The socket 538 is configured to receive and seat the torque element 524 of the prepared interface 504 as the grapple mechanism 510 grapples and rigidizes the payload 516 via the grapple fixture 508. The socket head 536 may make contact with the second surface 528 when the socket drive mechanism applies torque to the prepared interface 504 via the torque element 524.

The grapple mechanism 510 and socket drive mechanism 520 are disposed vertically about one another such that, upon capture, the grapple mechanism 510 and socket drive mechanism 520 line up with the grapple fixture 508 and torque element 524 respectively.

The EE 502 also includes a main housing 540 disposed at an end of the grapple canister 528 proximal the arm interfacing end 507.

The EE 502 also includes a force torque sensor (FTS) 542 (the housing for the FTS is visible in FIGS. 6A-6B). The FTS 542 is mounted internally in the EE 502. The FTS 542 is configured to measure three axes of forces and three axes of moments simultaneously. The FTS 542 is mounted in a primary load path which passes through the grapple mechanism 510. The FTS 542 is not in the grapple mechanism. The FTS 542 measures interface loads between the robotic arm and EE. In an embodiment, the FTS 542 includes an FTS hardware frame that orients x and y in the lateral direction, with z in the axial direction. On load limiting via sensed feedback, soft capture with low initial loads (as described herein) by the EE 502 puts the interface into a state where rigidization loads can be precisely controlled.

Disposed at the arm interfacing end 507 of the EE 502 is a bulkhead 548 which includes a plurality of connectors 550 for mechanically and electrically connecting the EE 502 to the robotic arm. The bulkhead acts as cable termination point in the EE 502 and includes panel mounted connectors for various components such as motor modules, sensors, microswitches, cameras/LEDs, etc.

Also at the arm interfacing end 507 the EE 502 includes an EE-to-arm interface adapter including a thermal isolator 546 and a manipulator adapter 544. The thermal isolator 546 may be composed of titanium. The manipulator adapter 544 may be composed of aluminum. The manipulator adapter 544 mates to the thermal isolator 546.

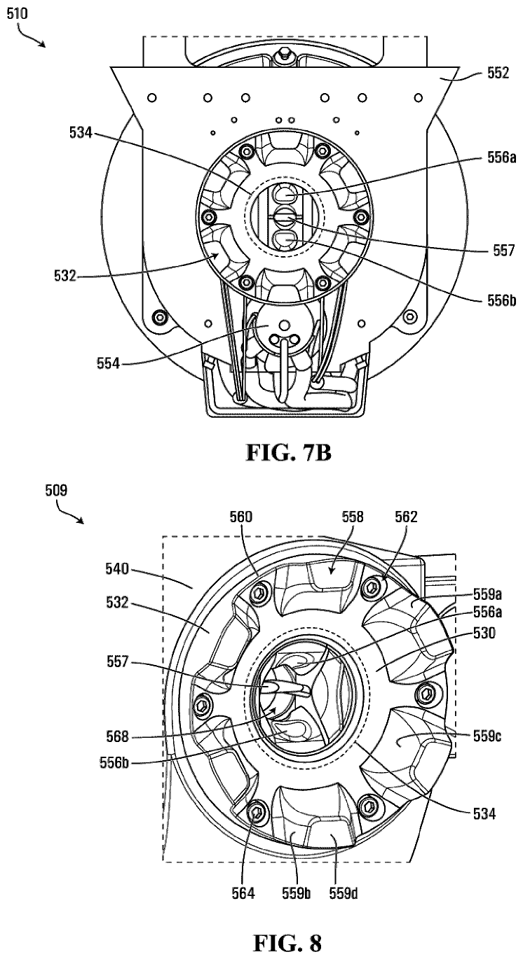

Referring now to FIGS. 7A-7B, shown therein is the grapple mechanism 510 in further detail.

The grapple mechanism 510 includes outer housing 552 disposed towards a payload-facing end 509, which houses internal components of the grapple mechanism 510 and extends from the main housing 540 to the coupling element 532. The coupling element 532 is mounted to a payload interfacing end of the housing 552.

The grapple mechanism 510 further includes a grapple motor module 554 for driving the grapple mechanism 510 during grappling and rigidization.

The front end of the grapple mechanism 510 is shown in FIG. 7B. The grapple mechanism 510 includes grapple jaws 556a and 556b (referred to collectively as grapple jaws or jaws 556 and generically as grapple jaw or jaw 556) disposed in the grapple canister 528 near the opening 534 in the coupling element 532.

The grapple jaws 556 are configured to move between an open configuration and a closed configuration. When in the open configuration, the jaws 556 can receive the probe 512 of the grapple fixture 508. When in the closed configuration, the jaws 556 can grapple or grab the probe 512, such that the probe 512, and thus the payload 516, is captured.

Disposed between the grapple jaws 556 is a probe present sensor bar 558. The probe present sensor bar 558 is used to sense when the probe 512 of the grapple fixture 508 is between the jaws 556 in the grappling position or area (e.g. “grappling area 568” as shown in FIG. 8).

The probe present sensor bar 558 is triggered when contacted by the tip of the probe 512. Upon sensing by the probe present sensor bar 558 that the probe 512 is present, the grapple mechanism 510 is configured to close the jaws 556 to capture the probe 512.

Referring now to FIG. 8, shown therein is the payload-facing end 509 of the grapple mechanism 510, including the coupling element 532, in greater detail.

The coupling element 532 is mounted to the payload interfacing end 509 of the housing 540 of the grapple canister 528 via fasteners 564 which are received through radially distributed mounting holes 562 in the coupling element 532.

The coupling element 532 includes six teeth 558. In other embodiments, the number of teeth 558 may vary. The teeth 558 are radially arranged about the periphery of the coupling element 532.

The teeth 558 are separated by similarly radially arranged recesses 560 (or notches 560).

In the embodiment of FIG. 8, the mounting holes 562 are disposed in the recesses 560 (one hole in each recess). In other embodiments, the mounting holes 562 may be located elsewhere on the coupling element 532.

The particular embodiment of the coupling element 532 shown in FIG. 8 may be referred to as a hexahirth coupling element or hexahirth design, that includes a Hirth-type coupling with six teeth. Accordingly, the coupling element 532 may be configured to act as one half of a hirth coupling (whether with six or another number of teeth).

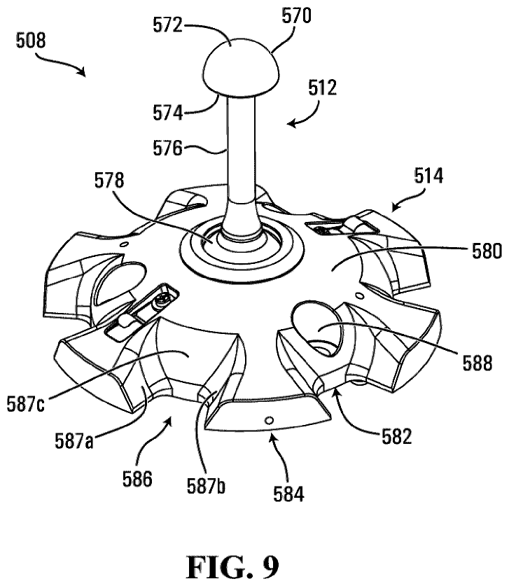

The recesses 560 interface with teeth of the coupling element 514 of the grapple fixture 508 (teeth 584 of FIG. 9) when the grapple fixture 508 makes contact with the concave face 530.

Each one of the teeth 558 includes a top surface 559d, a first side surface 559a, a second side surface 559b, and a third side surface 559c.

The top surface 559d is substantially flat.

The third side surface 559c has a concave profile which promotes sliding of the grapple probe 512 along the side surface 559c towards the opening 534 upon the grapple probe 512 contacting the side surface 559c of the tooth 558 (e.g. if the grapple probe 512 is misaligned to the opening 534 upon approach). As such, the side surfaces 559c of the teeth 558 may be considered to form part of the concave face 530.

Side surfaces 559a, 559b of the tooth 558 have a curved profile to promote sliding of teeth on the coupling element 514 of the grapple fixture 508 into the recesses 560 during capture and rigidization to promote effective mating of the complementary coupling elements 514, 532.

Referring now to FIG. 9, shown therein is the grapple fixture 508 of FIG. 5 in greater detail. The grapple fixture 508 is shown in isolation. In use, the grapple fixture 508 is attached to payload 516 as in FIG. 5.

As previously noted, the grapple fixture 508 includes grapple probe 512 and coupling element 514.

The grapple probe 512 includes a shaft 576 which attaches to the coupling element 514 at a probe attachment end 578. The probe 512 is attached to the coupling element 514 at a generally central position on the coupling element 514.

The grapple probe 512 includes a probe tip 570 at an end of the shaft 576 opposite the probe attachment end 578. The probe tip 570 has a rounded (convex) first surface 572 and a flat second surface 574. The probe tip 570 design may be considered a hemispherical design. The rounded first surface 572 enables the probe tip 570 to contact and slide along the concave face 530 towards the opening 534 of the coupling element 532. The flat second surface 574 provides a flat surface onto which the grapple jaws 556 can close and grapple the probe 512, such that the probe tip 570 is grappled about the second surface 574. For example, once the jaws 556 close, the jaws 556 can be retracted and draw the probe 512 further into the grapple canister 528 via contact with the flat second surface 574 of the probe tip 570.

The coupling element 532 includes a mounting surface 582 and a mating surface 580, which are generally opposed to one another.

The mounting surface 582 is used to mount the coupling element 532, and thus the grapple fixture 508, to the payload 516. The mounting surface 580 may have a generally flat profile.

The mating surface 580 of the coupling element 514 has a convex profile. The convex profile of the mating surface 580 is generally complementary to the concave profile of the coupling element 532 of the EE 502 such that the two surfaces can contact and may mate during rigidization of the interface.

The mating surface 580 includes a plurality of recesses 588 which include mounting holes for receiving fasteners (not shown) to mount the coupling element 514, and the grapple fixture 508, to the payload 516.

The coupling element 514 includes six teeth 584. The number of teeth 584 on the coupling element 514 match the number of recesses 560 in the coupling element 532 of the EE 502. As with the coupling element 532 of the EE 502, in other embodiments, the number of teeth 584 may vary and match the number of recesses 560 in the coupling element 532.

The dimensions and profile of the teeth 584 are generally complementary to the recesses 560 of the coupling element 532, such that the teeth 584 mate with the recesses 560. The coupling element 514 may act as one half of a Hirth coupling with the coupling element 532 of the EE 502. Load may be distributed symmetrically around the interface. So there should be a minimum of two teeth/lobes/keys. FIG. 8 shows how tightly the lobes and fasteners are arranged on the EE side of the i/f. For this diameter of interface, the number of teeth is appropriate for the operational loading of typical assembly and pick-and-place operations for a 2 or 3 meter arm. For other applications the contact forces can be lowered with more teeth, which can protect the surface finishes and improve fracture resistance through an operational lifetime. The system may include more teeth with a larger diameter interface, which typically will be sized to take more load. For example, a latching end effector curvic coupling is designed to take rotational loads when manipulating an 80,000 kg space shuttle.

The teeth 584 are radially arranged about the periphery of the coupling element 514. The teeth 584 are separated by notches 586. The notches 586 comprise recessed portions of the coupling element 514 at the outer periphery. The notches 586 have dimensions and a profile generally complementary to the teeth 558 of the coupling element 532, such that the notches 586 mate with the teeth 558.

The notches 586 each include side surfaces 587a, 587b, 587c. The side surfaces 587a, 587b, 587c contact respective mating side surfaces 559a, 559b, 559c of the teeth 558 of coupling element 532 during mating. The side surfaces 587a, 587b, 587c each have a curved or rounded profile to promote sliding of the teeth 558 of coupling element 532 of the EE 502 into the notches 586. Accordingly, misalignments between coupling elements 514, 532 as the coupling elements 514, 532 are brought together during capture may be passively corrected to promote mating.

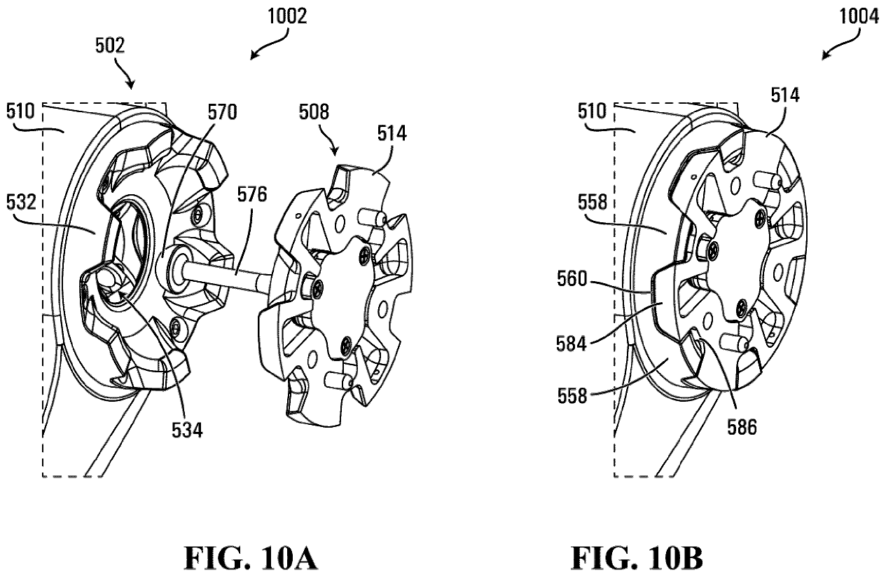

Referring now to FIGS. 10A and 10B, shown therein is the front end of the grapple mechanism 510 and the grapple fixture 508 in a pre-capture configuration 1002 and post-capture and rigidized configuration 1004. The grapple fixture 508 is shown in isolation but it is to be understood that the grapple fixture 508 is mounted to the payload 516 in application.

In FIG. 10A, the front end of the grapple mechanism 510 is moved towards the grapple fixture 508 by the robotic arm (not shown) for capture and rigidization.

As can be seen, the probe tip 570 of the grapple probe 512 is generally aligned with the opening 534 of the coupling element 532 such that, as the EE 502 is moved further towards the grapple fixture 508, the grapple probe 512 will enter the grapple canister and into the grappling position between the jaws 556. If the probe 512 is misaligned to the opening 534, the probe tip 570 may contact the concave face 530 of the coupling element 532 and the continued motion of the EE 502 towards the grapple fixture 508 causes the probe tip 570 to slide along the concave face 530 towards and through the opening 534. There is a spring in the GF base to permit the probe deflection during cases of misalignment.

In FIG. 10B, the tip 570 and then the entire grapple probe 512 have entered the grapple opening 534 and have been grappled by the grapple jaws 556a, 556b (not visible in FIG. 10B).

The grapple probe 512 has been captured and retracted by the grapple mechanism 510 to bring the coupling elements 532, 514 into contact.

Mating of the coupling elements 532, 514 is achieved when the teeth 558 of the grapple mechanism 510 coupling element 532 are received within the notches 586 of the grapple fixture 508 and the teeth 584 of the grapple fixture 508 are received within the notches 560 of the coupling element 532. The mating is promoted by the curved surfaces of the teeth 558 and notches 586, as previously described. The mating of the teeth 558, 584 and recesses/notches 586, 560 bring the mating surface 580 of the grapple fixture 508 into contact with the concave face 530 of the grapple mechanism 510.

The resultant interlocking interface post-capture may advantageously minimize or prevent accidental separation of the interface before the grapple mechanism 510 deliberately pushes the probe 512 back against the grapple jaws 556a, 556b for release.

In FIG. 10B, the rounded side surfaces 559a, 559b, 559c, 587a, 587b, and 587c facilitate sliding of the teeth 558, 584 into the recesses 560, 586 to promote capture. Accordingly, upon successful capture, the rounded side surfaces 559a, 559c, 559c are in contact with the rounded side surfaces 587a, 587b, 587c.

The coupling element 532 of the grapple mechanism 510 functions as a mating and aligning interface of the grapple mechanism. The coupling element 532 is a hexahirth face coupling interface design, which improves overall combined load capacity. The hexahirth design may use 60 degree contact angles. The hexahirth coupling element 532 may be entirely separate from the rest of the hardware in the grapple mechanism 510 and bolt onto the main housing via six fasteners, along with dowels for locating. The 60 degree contact angle may advantageously provide the best friction angle at the interface. Any rotational play about the roll axis at the end effector 502 to grapple fixture 514 interface (‘tick-tock’) may be eliminated. The hexahirth design of the coupling element 532 may allow for capture of a grapple fixture 514 when the positional misalignments of the grapple interface are within a worst case combined envelope of ±20 mm translationally, ±5 degrees in wobble (combined pitch and yaw), and ±1.5 degrees in roll. In other words, the end effector 502 can capture a grapple fixture 514 at these worst-case misalignments without a vision-system in the loop correcting alignments prior to grappling.

Dry-lubricating anodized, operational surfaces of the coupling element 532 allows for a 60 degree face-gear contact angle without risk of wedge-locking and allows for reliable separation of the interface without risk of cold-welding or galling. Note, however, that this can create very high resistivity surfaces (insulative). Therefore, a secondary charge flow path may be implemented such that contact does not rely on lubricated surfaces only. A set of ground fingers located on the interfacing grapple fixture 514 may be used to contact conductive surfaces on the coupling element's 532 hexhirth in non-structural and non-functional locations (e.g. the fingers create a bond between the grapple fixture 514 and end effector 502 after being grappled and rigidized).

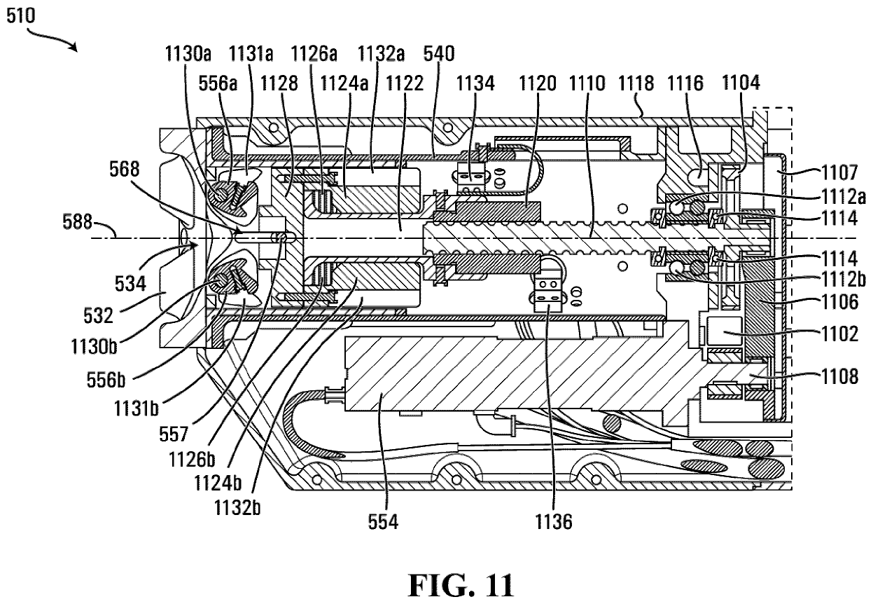

Referring now to FIG. 11, shown therein is a cross-sectional side view of the grapple mechanism 510 showing internal components, according to an embodiment.

The grapple mechanism 510 in FIG. 11 is in a full forward position in which the grapple mechanism 510 is ready for capture and to receive the grapple probe 512 of the grapple fixture 508.

The grapple mechanism 510 includes a capture axis 588, which is an axis along which components of the grapple mechanism 510, and the captured grapple probe 512, move during capture and release.

At the front end of the grapple mechanism 510 is the coupling element 532 with the opening 534 therein for receiving the grapple probe 512 into the grappling position 568 between the (open) jaws 556a, 556b.

Various internal components of the grapple mechanism 510 used to effect grappling, rigidization, and release will now be described.

The grapple mechanism 510 uses the grapple motor module 554 and a number of other internal components to meet the required performance of the grapple mechanism 510.

In an embodiment, the grapple motor module 554 comprises a fully redundant (dual wound) DC brushless motor, a fully redundant (dual wound) single friction interface electromechanical power-to-lift brake, prime and redundant resolvers, and a planetary gearbox. The gearbox may have a maximum ratio of 100:1. The power-to-life brake design implies that the brakes are applied without power, and that an actuation voltage (nominal required voltage) is required to disengage the brake on the motor. The brake may thus advantageously enable maintaining preloaded configuration with no power draw required.

The output of the grapple motor module 554 interfaces to a gear pass (e.g. 3:2:1 gear pass) that comprises an input gear (not shown), an idler gear 1102, and a grapple drive gear 1104. The grapple mechanism 510 further comprises a gear housing 1106. A gearbox cover 1107 protects and isolates the input gear, idler gear 1102, a grapple drive gear 1104, and a gear housing 1106.

A motor module output shaft 1108 drives the input gear (keyed from the motor shaft), which in turn drives the idler 1102, and finally rotates the grapple drive gear 1104. The gears are each supported by needle rollers (gears used in the EE 502 design are supported on both sides as much as possible).

The gear housing 1106 on the gear pass locates the motor shaft 1108 and a ball screw shaft 1110, as well as holds the gear pass together.

The grapple drive gear 1104 at the output of the gear pass rotates the ball screw 1110. The ball screw 1110 is also a keyed interface. The ball screw 1110 is mounted on angular contact bearings 1112a, 1112b (referred to collectively as angular contact bearings 1112 and generically as bearings 1112) in order to both radially locate the ball screw 1110, as well as take all the thrust loads in the design.

A ballscrew collar 1114 is disposed immediately behind the angular contact bearing 1112 and clamps the bearing 1112 in place. All of the thrust loads are transferred to the split collar 1114. The configuration of components described above allows some axial flexibility.

The grapple mechanism 510 further includes a bearing retainer 1116 about the ballscrew collar 1114. All of the axial load generated during rigidization in the ball screw 1110 is reacted through the path of the ballscrew collar 1114, through the angular contact bearing 1112, and into a main housing 1118 of the grapple mechanism 510.

The grapple mechanism 510 further includes a ball nut 1120 on an output end of the ball screw 1110. A screw sleeve 1122 interfaces to the ball nut 1120 and moves with the ball nut 1120 but relative to a split housing 1124a, 1124b (referring to collectively as the split housing 1124) during rigidization. The split housing 1124 includes Belleville washers 1126a, 1126b (referred to collectively as the Belleville stacks 1126). The foregoing elements and relative motion thereof may advantageously provide a lower stiffness in the grapple mechanism 510 during capture and rigidization.

Once the probe 512 of the grapple fixture 508 enters the jaws 556 (as indicated by the payload present probe bar 558), retraction is performed by a jaw housing 1128 (which houses the jaws 556) connected to the split housing 1124, the split housing 1124, the screw sleeve 1122, and the ball nut 1120 through the grapple mechanism 510. These components 1128, 1124, 1122, 1120 travel along the ball screw 1110 towards the arm-interfacing end 507 along the axis of capture 588 until the grapple fixture 508 is captive (i.e., the jaws 556 are fully closed around the grapple probe 512).

Once the jaws 556 are closed, the grapple mechanism 510 continues to pull the grapple probe 512 along the axis of capture 588 at the start of a rigidization process, and the components 1120, 1122, 1124, 1128 continue to move along the ball screw 1110.

Towards the end of the rigidization process, the screw sleeve 1122 and ball nut 1120 continue moving along the ball screw 1110 (and are pulled by the ball screw 1110), but now relative to the split housing 1124. The split housing stops moving along the ball screw because the GF is now seated on the face of the EE. This prevents the GF probe from being drawn in any further (split housing connected to jaws that are now seated on the underside/flat side of the probe tip). There may be a spring in the payload present bar, or a set of springs that keep the payload present switches engaged during rigidization. The relative motion between the screw sleeve 1122 and the split housing 1124 compresses the Belleville stacks 1126, which creates the required preload in the grapple mechanism 510.

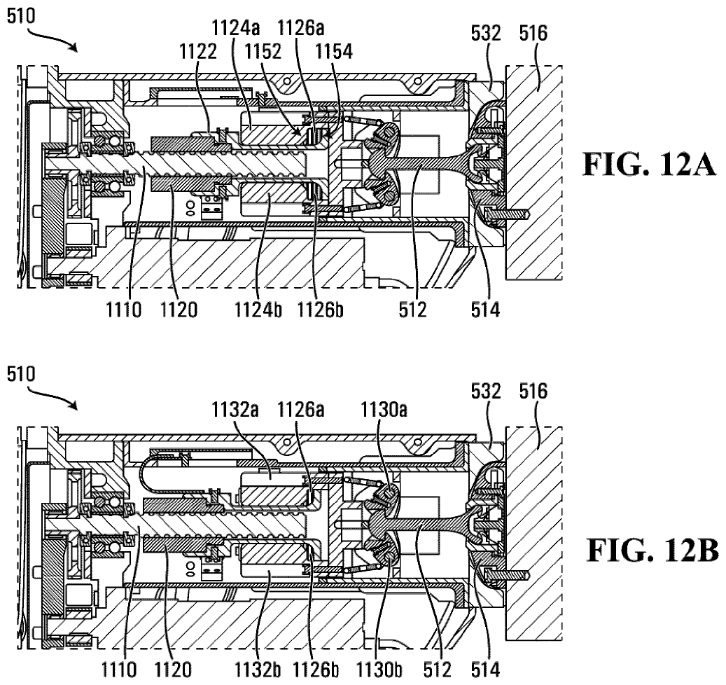

The rigidization through compression of the Belleville stacks 1126 is shown in FIGS. 12A and 12B.

FIG. 12A shows the grapple mechanism 510 having captured and achieved contact with the coupling element 514 of the grapple fixture 508 (via coupling element 532). At this stage the Belleville stacks 1126 are not compressed. Up to the position shown in FIG. 12A, the jaw housing 1128, split housing 1124, screw sleeve 1122, and ball nut 1120 have retracted along the ball screw 1110.

FIG. 12B shows the grapple mechanism 510 having rigidized the interface with the grapple fixture 508 by generating the target preload through compression of the Belleville stacks 1126. Compression of the Belleville stacks 1126 is achieved via relative motion between the split housing 1124 and the screw sleeve 1122.

In particular, translation of the split housing 1124 along the capture axis is stopped (along with the jaw housing 1128), while translation of the screw sleeve 1122 (and ball nut 1120) continues along the capture axis away from the payload interfacing end in direction 1148. As this occurs, the Belleville stacks 1126 are compressed between an end-facing surface 1152 (proximal to the arm end) of the split housing 1124, which is stationary, and an end-facing surface 1154 (proximal to the payload end) of the screw sleeve 1122, which continues to move along the capture axis 558 towards the surface 1152 of the split housing 1124 in direction 1148.

Translation of the ball nut 1120 and screw sleeve 1122 relative to the split housing 1124 is measured and monitored to generate the target preload in the Belleville spring stacks 1126.

The grapple jaws 556a, 556b are fixed to the jaw housing 1128 via jaw pins 1130a, 1130b (collectively referred to as jaw pins 1130), respectively, which allow the jaws 556 to pivot open and closed as the jaw housing 1128 and the screw sleeve 1122, split housings 1124, and ball nut 1120 travel along the ball screw 1110.

The jaws 556a, 556b are actuated by cams or extension springs 1131a, 1131b. The jaws 556 are forced open at the fully forward position of the grapple mechanism 510, and the cams or extension springs 1131a, 1131b work to hold the jaws 556a, 556b closed in their extended position.

The jaws 556 are forced open at the grapple mechanism's 510 fully forward position and are actuated closed by the cams or extension springs 1131a, 1131b as the jaw housing 1128, split housing 1124, and screw sleeve 1122 are retracted for rigidization. A slotted guide 1132a, 1132b in the jaw housing 1128 guides the travel of the jaws 556 from their “open” to “closed” position via jaw guide pins 1130a, 1130b on the jaws 556 themselves, while pivoting about the jaw pins 1130a, 1130b.

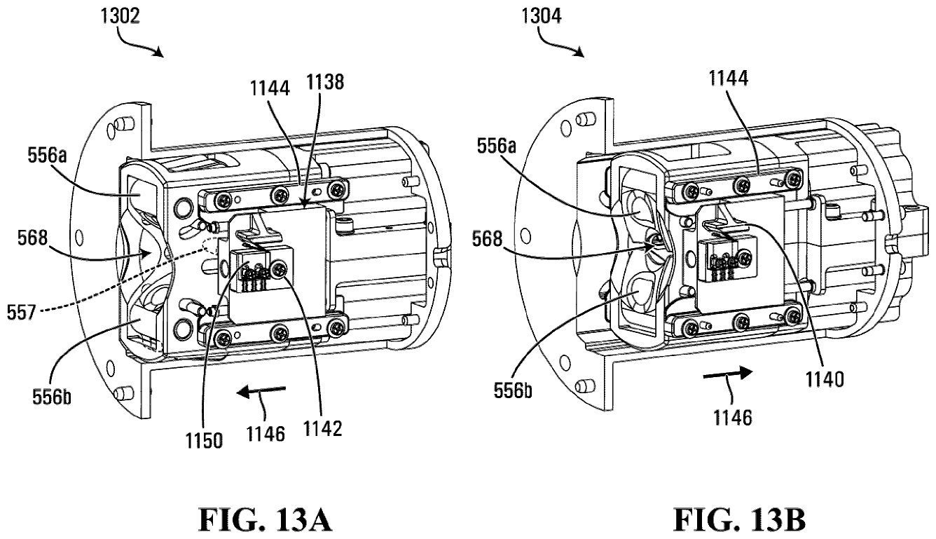

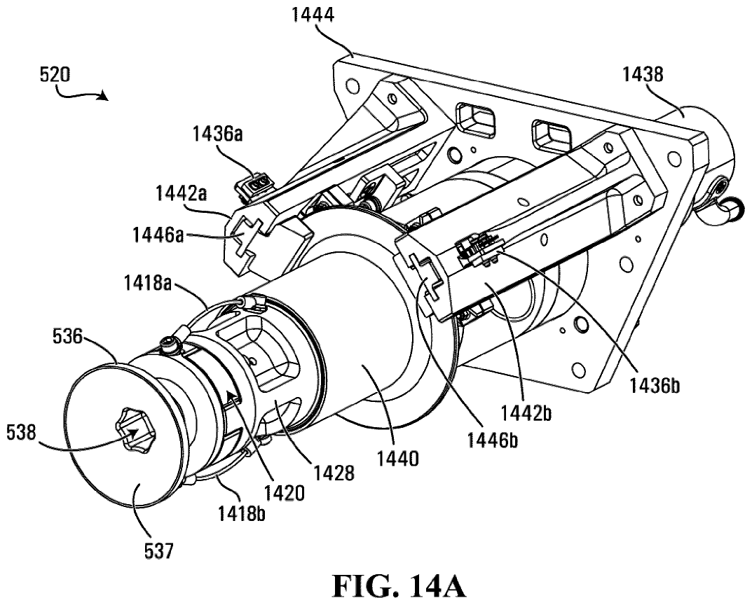

Referring now to FIG. 13, shown therein is a perspective partially transparent side view of the grapple jaws 556 illustrating actuation of the grapple jaws 556 between an open configuration 1302 and a closed configuration 1304, according to an embodiment.

Cams 1144 actuate the grapple jaws 556. When the cams 1144 travel in a first direction 1146, the grapple jaws 556 open. When the cams 1144 travel in an opposite second direction 1148, the grapple jaws 556 close.

A payload present microswitch senses whether a payload is present according to whether the payload present bar 558 is triggered. The payload present microswitch is mounted on a mount 1142 disposed beneath a ramp 1140, all of which is disposed on a slider 1138 in between the cams 1144.

The hard-capture preload is borne against a flat surface on the back of the probe tip to significantly reduce internal loads including contact stresses, and enables the use of standard materials and processes.

The jaws 556 inside the grapple canister 1128 use a flat-bottomed design at the point of engagement with the grapple probe 512 and are actuated by the linear motion of the grapple mechanism 510. This profile, in tandem with the hemispherical probe tip 570 of the grapple fixture 508, may significantly reduce internal mechanism loads.

Referring again to FIG. 11, the grapple mechanism 510 further includes jaw housing guides 1132a, 1132b for holding the jaw housing 1128, the screw sleeve 1122, and the split housing 1124 and preventing them from rotating given the motion of the ball nut 1120.

By operation of the jaw housing guides 1132a, 1132b, instead motion is limited to linear motion along the axis of capture 588. The aforementioned hardware and components are enclosed by the main housing 540 of the grapple mechanism 510.

Three sets of prime and redundant microswitches are implemented in the grapple mechanism 510 to help determine unambiguous mechanism states during operations. In variations, a single microswitch may be used in place of prime and redundant microswitches.

The microswitches include a payload present microswitch 1150 (shown in FIG. 13), calibration microswitch 1134, and rigidization safety microswitch 1136.

The Calibration and Rigidization Safety microswitches 1134, 1136 are stationary inside the mechanism. In other words, these microswitches 1134, 1136 remain fixed relative to the motion of the mechanism 510 during rigidization, and features on the moving mechanism trigger the switches 1134, 1136 at a known, pre-determined position.

The Payload Present microswitch 1150 is mounted on a slider 1138 that allows the switch 1150 to move with the mechanism 510 during rigidization, thus maintaining the ‘payload present’ state throughout the rigidization process.

These switches 1150, 1134, 1136 are described in more detail in the following sections.

The payload present microswitch 1150 (which, in this embodiment, includes prime and redundant microswitches) senses if a payload is present, i.e. if the grapple probe 512 of the grapple fixture 508 is within the jaws 556 of the grapple mechanism 510. The switch states are used by software to detect the presence of a payload, as a trigger for the payload capture and rigidization sequence performed by the grapple mechanism 510. As a result, the appropriate motion is initiated based on the state to achieve the mechanism motion profile. The software may be implemented on a robotic arm controller or robotic workstation. Embodiments include software on the arm control computer (on-board the spacecraft) and/or in the robotic workstation (with operator either ground or aboard space station). The software may be processed and acted upon at a “state machine” layer of processing where sequential tasks are scheduled, executed, monitored, and checked for completion.

The payload present microswitches 1150 are fastened to a small mount 1142, which is installed on a ramp 1140 that travels with the slider 1138. These features are shown in FIG. 13. The microswitch slider 1138 includes a center spring in a guide (not visible in FIG. 13) that gets compressed by the payload present bar 558, once the bar 558 is depressed by the tip 570 of the grapple probe 512 that is inserted deep enough inside the jaws 556 to be captured (i.e. into the grappling position 568). It is the motion of the payload present bar 558 via the spring compliance that pushes the microswitches 1150 on their mounts 1142 along slots. At the back end of the slots the microswitches 1150 are physically depressed by the payload present ramp 1140 which provides the payload present' indication initially. Then, a set of spring shafts (spring-loaded plungers, not visible in FIG. 13) that pass through the slider 1138 push the slider 1138 forward at all times to keep the microswitch 1150 engaged while the jaw housing 1128, split housing 1124, and screw sleeve 1122 are retracted during the rigidization process. Thus the payload present indication remains true (indicating there is still a payload) throughout rigidization.

The payload present signal states that the GF probe tip is present. After the signal is received, the mechanism must then retract in order to close the jaws around the GF probe tip, even when at the maximum EE 502 to grapple fixture 508 offset for successful capture of 20 mm (radial capture misalignment).

Referring again to FIG. 11, the Calibration microswitches 1134 are used to sense if the grapple mechanism 510 is at the calibrated position. The microswitches 1134 are used to establish a calibrated position of the grapple mechanism 510, after which the position of the mechanism is computed by keeping track of motor turns using a motor resolver (present in the motor module 554).

The Rigidization Safety microswitches 1136 are used to indicate that the grapple mechanism 510 is approaching its rear hardstop. The microswitches 1136 are used to stop motion of the grapple mechanism 510 before it retracts too far.

The Calibration and Rigidization Safety microswitches 1134, 1136 are actuated by ramps (not visible in FIG. 11) on the circumference of the screw sleeve 1122. Thus, as the screw sleeve 1122, split housing 1124, and jaw housing 1128 assemblies travel in the direction of the arm interfacing end 507 during rigidization. Note that the target preload should be achieved (and may be determined by counting a predetermined number of motor turns, or by current monitoring) prior to reaching the Rigidization Safety microswitch 1136. The rigidization safety microswitch 1136 is in place for safety in case the mechanism travels too far during rigidization without a payload.

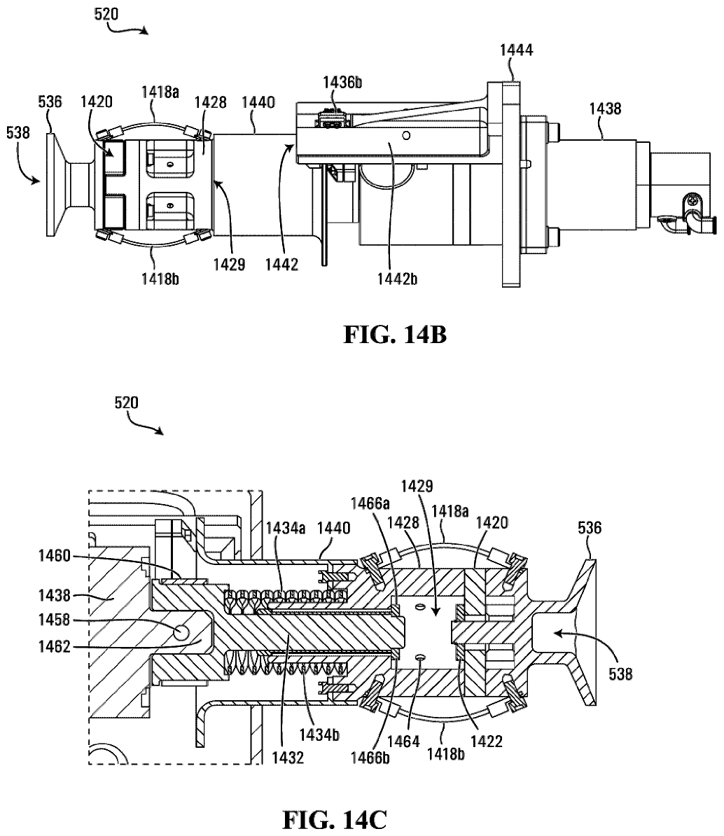

Reference will now be made to FIGS. 14 to 21, which show the socket drive mechanism 520 of the end effector 502 of FIG. 5 in further detail.

Referring first to FIGS. 14A-14C, shown therein is the socket drive mechanism 520 of FIG. 5 in isolation, in perspective, side, and cross-sectional views.

The socket drive mechanism 520 provides clockwise and counterclockwise rotation capability over a continuous range of motion to rotate the torque bolt 524 (ball head hex bolt) on the payload 516 (e.g. tool or other hardware). Note that the torque bolt 524 (and prepared interface 504) is not shown in FIGS. 14A-14C.

The socket drive mechanism 520 includes socket head 536 (also referred to as socket drive 536 or drive socket 536) for interfacing with the torque bolt 524 of the payload 516.

The socket drive 536 transmits torque to the payload 516 through the torque bolt 524.

The socket head 536 is a spring-loaded socket head. The spring loaded socket head 536 can be rotated in either direction for a desired number of turns or until a desired torque has been reached (e.g. via current limiting). In an embodiment, the maximum output torque capability may be 17 N·m.

The socket head 536 includes a socket surface 537 which is curved towards socket 538 of the socket head 536.

The socket 538 is configured to receive the torque bolt 524 of the payload 516.

The socket 538 is shaped to be complementary to the shape of the end of the torque bolt 524 for mating. In the embodiment shown, the socket 538 has a hexagonal profile (“socket hex”) that is complementary to the profile of a bolt hex of the torque bolt 524.

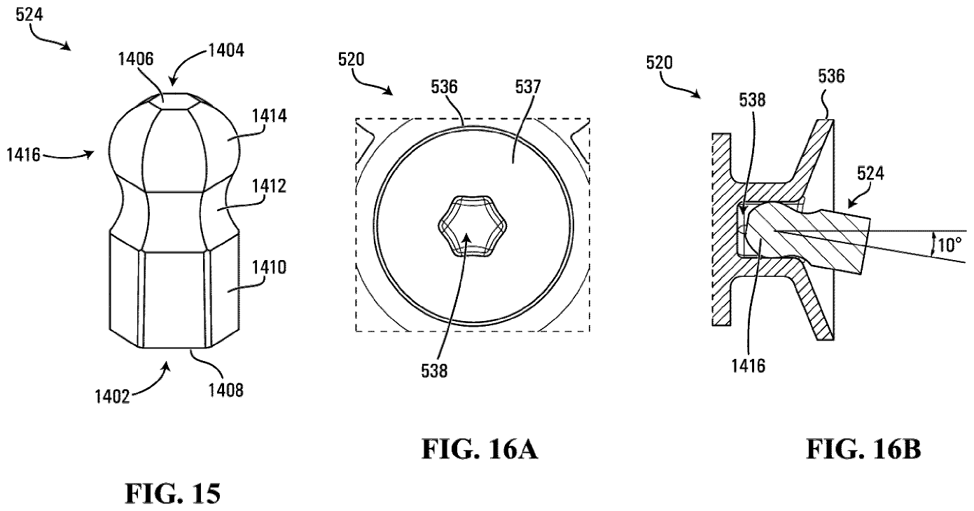

The torque bolt 524 of FIG. 5, which is seated and rotated by the socket 538, is shown in isolation in FIG. 15.

The torque bolt 524 includes a mounting end 1402 for mounting or connecting the torque bolt 524 to the payload 516 via the second surface 528 of the prepared interface 504 and a socket interfacing end 1404 for mating and interfacing with the socket 538 of the socket drive mechanism 520.

Generally, the mounting end 1402 of the torque bolt 524 may connect to a torque driven subsystem of the payload 516 such that rotation of the torque bolt 524 transfers torque to the torque driven subsystem. The torque driven subsystem may be a component of a tool, for example.

The torque bolt 524 includes a flat, hexagonal top surface 1406 and a flat, hexagonal bottom surface 1408. The top surface 1406 has a smaller diameter than the bottom surface 1408.

The torque bolt 524 further includes six side surfaces traversing from the top surface 1406 to the bottom surface 1408. The side surfaces each include a flat portion 1410 proximal the mounting end 1402, a rounded portion 1414 proximal the socket interfacing end 1404, and a concave portion 1412 between the rounded portion 1414 and the flat portion 1410. The concave portion 1412 is narrower than each of the rounded portion 1414 and the flat portion 1410.

The region of the torque bolt 524 defined by the rounded portion 1414 and the top surface 1406 form a ball end 1416. In an embodiment, the ball end 1416 is a ball end hex head. The ball end makes it easier to engage a socket with an offset angle (±10° in this design). 30° may be common for terrestrial applications. This is advantageous for robotic engagement with a socket. A downside is that the contact forces are higher with the ball head than a straight hex head. The shear forces may also be higher within the ball head itself. The profile of the socket interfacing end 1404 of the torque bolt 524 (rounded leading edge) enables sliding of the torque element 524 down the socket face 537 towards and into engagement with the socket 538.

Further details regarding the profile of the socket 536 are illustrated in FIGS. 16A and 16B.

The socket drive 536 has a rounded hex profile (e.g. 7/16″ rounded hex profile, complementary to a 7/16″ hex bolt) to transmit torque to the torque bolt 524.

The socket profile provides rotational “deadband”, which offers some play while back driving a socket drive motor (not shown) to remove wind up generated when torquing the torque bolt 524.

The socket profile also minimizes corner loading on the hex bolt 524 during high torque applications, as compared to a straight hex profile.

The ball end (Bondhus head) bolt profile of the torque bolt 524, and complementary socket profile, also advantageously provides angular misalignment accommodation to the socket (e.g. up to) 10°. Such misalignment accommodation is illustrated in FIG. 16B.

Referring again to FIGS. 14A-14C, the socket drive mechanism 520 further includes grounding wires 1418a, 1418b (referred to collectively as grounding wires 1418) for grounding the socket drive mechanism 520.

The socket drive mechanism 520 also includes an Oldham coupling 1420.

The Oldham coupling 1420 provides additional compliance to the socket drive 536 during torquing operations.

The Oldham coupling 1420 is also used to accommodate bolt 524 misalignments. The Oldham coupling 1420 may be used to rotate the socket drive mechanism 520 to effect interfacing with the torque bolt 524. The Oldham coupling 1420 helps the socket drive 536 engage onto the torque bolt 524 when the grapple mechanism 510 is rigidized. Rotation of the socket drive 536 may be required for final alignment of the hex 538 (i.e. to reach a socket drive engaged state). The Oldham coupling 1420 provides a greater misalignment capability between the bolt 524 and a socket axis 1430 to accommodate tolerances as well as changes due to thermals.

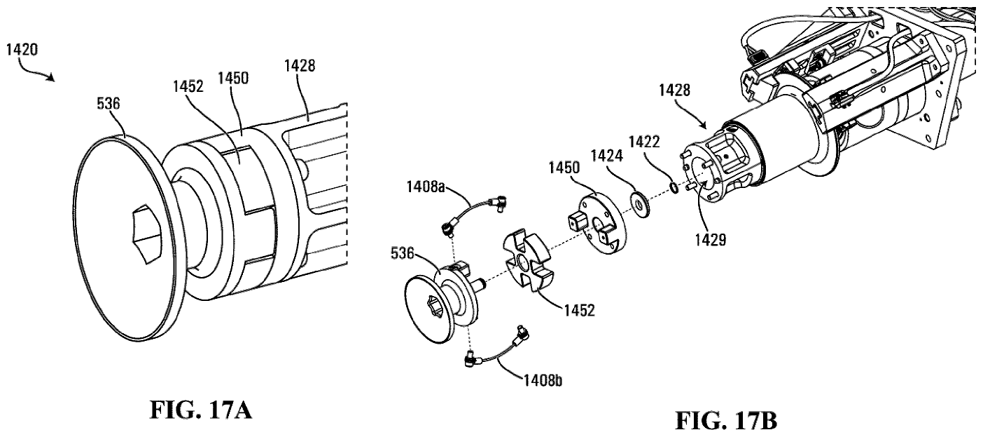

The Oldham coupling 1420 is shown in greater detail in FIGS. 17A and 17B, which show the socket drive mechanism 520 with the Oldham coupling 1420 in assembled and exploded views, respectively.

The Oldham coupling 1420 includes the socket head 536, a drive slider 1452, an adapter 1450, a spacer 1424, and a retaining ring 1422. The Oldham coupling 1420, as a whole, accommodates the shaft misalignment. The individual pieces permit connection or interface to the torque housing and ball hex head respectively (e.g., 1408a, 1408b).

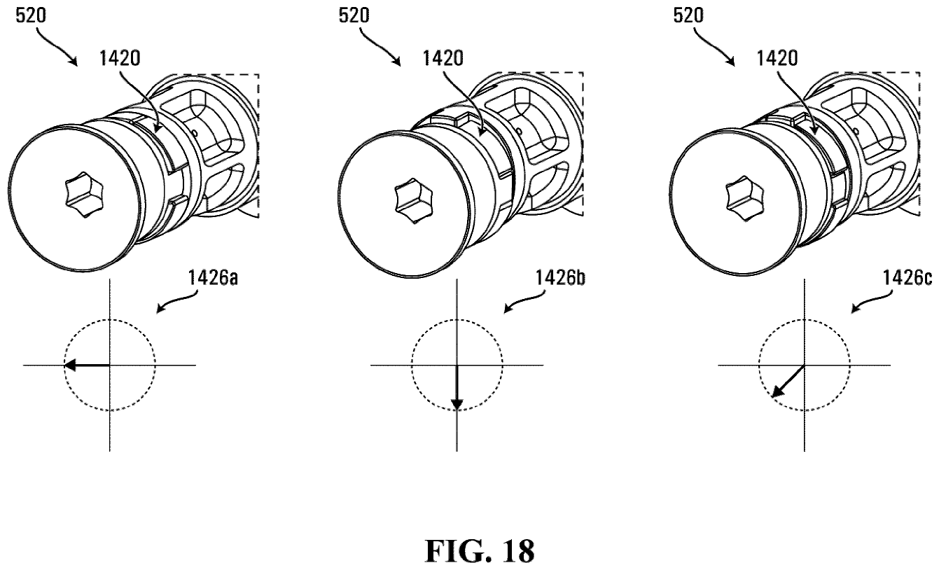

In an embodiment, the Oldham coupling 1420 is dimensioned to provide a maximum of 1.90 mm (0.075″) radial compliance. Referring to FIG. 18, radial compliance provided by the socket drive mechanism 520 through the Oldham coupling 1420 is illustrated in graphs 1426a, 1426b, and 1426c. In an embodiment, a maximum of 1.90 mm (.075″) of radial compliance is provided. The graphs show examples of three different directions of possible radial misalignment that can be accommodated. The graphs show the offset of the socket head 536 (which will be engaged on the ball hex head on the payload) with respect to the adapter 1450 (which is bolted to the torque drive shaft). The position of 1420 (more particularly the relative position of 1452 and 1450) in each figure in FIG. 18 are compared to the red arrows in the graphs.

The additional compliance provided by the Oldham coupling 1420 may advantageously remove side loads caused by misalignment of the bolt 524 that may otherwise be transmitted to spline 1432 (shown in FIG. 14C) and motor module bearings (not shown).

Additional deadband may be inherent in the design, which may advantageously minimize the risk of backing off a bolt 524 when trying to relieve the wind up of the system 500 after torquing.

The features of the Oldham coupling 1420 are held in place axially by the retaining ring 1422 and the spacer 1424.

Referring again to FIGS. 14A-14C, the socket drive mechanism 520 further includes an axially compliant drive 1428 (also referred to as axial compliance mechanism 1428) for providing axial compliance to the socket drive 536.

The axial compliance mechanism 1428 provides a passive means to retract the socket 536 when in contact with the torque bolt 524 during grappling and rigidization.

Generally, the socket drive 536 retracts via the axial compliance mechanism 1428 when the socket hex 538 is misaligned to the bolt hex of the torque bolt 524.

The socket drive 536 may then be rotated (e.g. using Oldham coupling 1420) for final alignment of the socket hex 538 to where the socket hex 538 is properly seated on the torque bolt 524.

Achieving proper alignment and seating of the socket hex 538 enables the socket drive mechanism 520 to reach a socket drive engaged state (including microswitch sensing, as described further herein).

The axial compliance is engaged within an axial compliance cavity 1429.

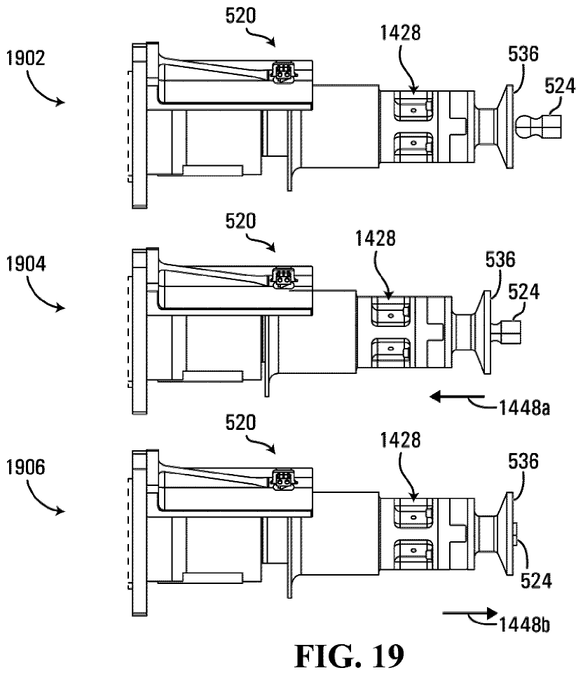

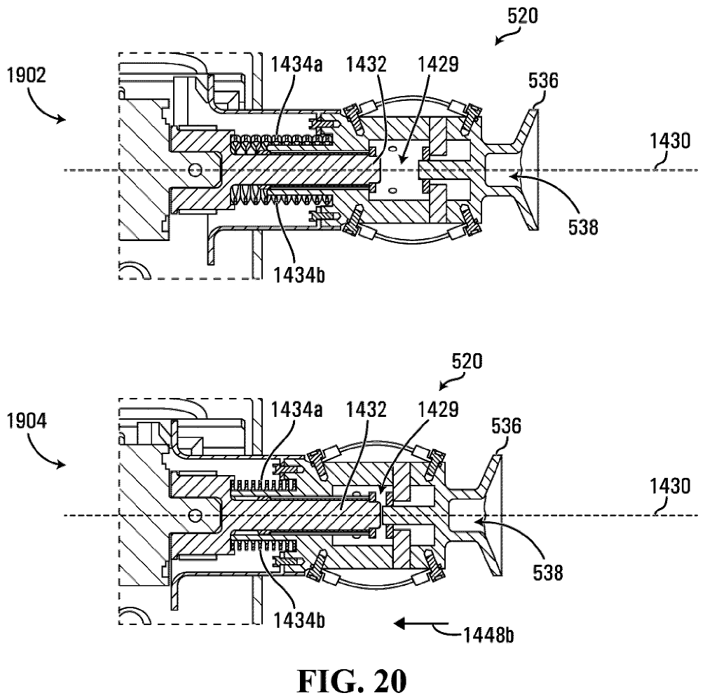

Referring now to FIGS. 19 and 20, shown therein is the axial compliance mechanism 1428 of the socket drive mechanism 520 in greater detail.

FIG. 19 shows the socket drive mechanism 520 in isolation with the axial compliance mechanism 1428 in a first state 1902, a second state 1904, and a third state 1906.

In the first (forward) state 1902, the socket drive 536 is moving towards the torque bolt 524 as the end effector 502 is rigidizing the interface with the payload 516. The torque bolt 524 in this instance is misaligned to the socket hex 538 of the socket drive mechanism 520. When the misaligned torque bolt 524 contacts the socket 538, the axial compliance mechanism 1428 will be engaged.

In the second (retracted) state 1904, the torque bolt 524 has contacted the socket 538 but is misaligned, engaging the axial compliance mechanism 1428. The axial compliance mechanism 1428 causes movement of the socket drive 536 (as well as other components of the socket drive mechanism 520) in direction 1448a. Engagement of the axial compliance mechanism 1428 causes a state change (sensed by a socket engaged microswitch, described in more detail herein). The state change is registered and used as an indication to rotate the socket drive 536. For example, the state change may be communicated to an operator, who may then rotate the socket drive 536 using the Oldham coupling 1420. The socket drive 536 is rotated until the socket 538 is properly seated on and aligned with the torque bolt 524.

In the third (forward) state 1906, the socket 538 of the socket drive mechanism 536 is seated on and aligned with the torque bolt 524. This seating is achieved via rotation of the socket drive 536 as previously described. Once properly seated, the axial compliance mechanism 1428 is disengaged, causing the socket drive 536 (and additional components of the socket drive mechanism 520) to move in direction 1448b, returning the socket drive 536 to its forward position as in first state 1902. As the socket drive 536 moves in direction 1448b, the axial compliance mechanism 1428 causes a second state change (sensed by the socket engaged microswitch). The state change is registered and used as an indication that the socket 538 is properly seated on the torque bolt 524 and that torquing operations can be performed. Accordingly, the state change may be communicated to enable the torquing operations to begin (e.g. to an operator or to another system component configured to begin or perform torquing operations autonomously).

FIG. 20 shows a cross-sectional view of the socket drive mechanism 520 with the axial compliance mechanism 1428 in the first and second states 1902, 1904 of FIG. 19.

Spline shaft 1432 provides an axial degree of freedom while transmitting torque from a motor module (motor module 1438, described below). Wave springs 1434a, 1434b (referred to as wave springs 1434 or wave spring 1434) provides forward pressure to allow the socket drive 536 to extend forward to engage the torque bolt 524 (not shown in FIG. 20) when the socket hex 538 is aligned with the torque bolt 524.

When the axial compliance mechanism 1428 is in the first (forward) state 1902, the spline shaft 1432 is positioned at a distal end of an axial compliance cavity 1429 (distal to the payload interfacing end of the socket drive mechanism 520).

The wave spring 1434 applies forward pressure to the socket drive 536. A cross-sectional view of the third state 1906 of the axial compliance mechanism would look the same as the first state 1902 in FIG. 20 (as, in third state 1906, the socket drive 536 has returned to the forward position).

When the axial compliance mechanism 1428 is in the second (retracted) state 1904, the contact between the socket drive 536 and the misaligned torque bolt 524 compresses the wave springs 1434, causing retraction of the socket drive 536. The passive retraction of the socket drive 536 via compression of the wave springs 1432 causes spline shaft 1432 to enter further into the axial compliance cavity 1429.

When the axial compliance mechanism 1428 moves to the third (forward) state 1906 (not shown in FIG. 20) when the socket 538 is aligned and seated on the torque bolt 524, the wave springs 1432 extend (decompress), causing passive forward movement of the socket drive 536 to the forward position and return of the spline shaft 1432 to the distal end of the axial compliance cavity 1429 (as in first state 1902).

Translation of the socket drive 536 (retraction and forward movement) occurs along socket axis 1430.

Referring again to FIGS. 14A-14C, the socket drive mechanism 520 includes a socket drive motor module 1438 (or motor module 1438).

The motor module 1438 may be used to drive various components of the socket drive mechanism 520, including driving rotation of the socket drive 536 to apply torque to the torque bolt 524.

In an embodiment, the motor module 1438 may have a baseline gear ratio of 480:1. The motor module 1438 mounts to the assembly via a motor mount 1444. The motor module 1438 includes an output shaft 1462. The output shaft 1462 is pinned to spline (or polygon) shaft 1432 via a dowel 1458. The dowel 1458 between the motor module output shaft 1462 and the spline shaft 1432 is secured in place via a dowel retainer sleeve 1460. The spline shaft 1432 engages the Oldham coupling 1420 of the socket drive mechanism 520. The Oldham coupling 1420 includes three features: a spline shaft adapter 1428 (also shown in FIG. 17A), drive adapter 1450 and drive slider 1452, and the socket 536.

In an embodiment, the motor module 1438 includes a fully redundant (dual wound) DC brushless motor, a resolver (which may include prime and redundant resolvers), and a planetary gearbox. The gearbox may have a maximum ratio of 480:1 (baseline).

The spline shaft 1432 is a separate element to the motor module 1438. This modularity may advantageously provide flexibility with the spline 1432 design, allowing for easier integration of potential design modifications. Furthermore, a motor vendor or the like may advantageously use a standard output shaft 1462 with the addition of a dowel hole (not shown) for retaining the dowel 1458, the dowel 1458 being for torque transmission and retention of the spline shaft 1432.

The wave springs 1434 about the spline shaft 1432 allow axial compliance of the socket drive 536 with linear travel. This axial motion enabled by the axial compliance 1428 engages and disengages microswitches 1436a, 1436b (collectively referred to as microswitches 1436) to determine when the socket drive 536 is fully seated on the bolt 524. The retaining ring on the end of the male spline shaft has a spacer (1466a/1466b). The entire compliance assembly 1428 may be retained by the male spline shaft retaining ring.

There is a cavity 1429 between the retaining rings and spacers 1422, 1424 on the Oldham coupling 1420 and the spline retainers 1466a, 1466b on the spline shaft 1432 and the spline spacers, which is essentially the axial compliance in the socket drive mechanism 520. The cavity 1429 includes four vent holes 1464 about the circumference of the socket drive mechanism 520.

The socket drive mechanism 520 includes prime and redundant microswitches 1436 (socket engaged microswitches 1436) to indicate when the socket drive 536 is fully seated, or engaged, on the torque bolt 524. In variations, only one microswitch 1436 may be used.

The prime and redundant socket engaged microswitches 1436 in the socket drive assembly are mounted on microswitch actuator sliders 1442a, 1442b (collectively referred to as the microswitch actuator sliders 1442 and generically as slider 1442).

The sliders 1442 interface to the socket drive mechanism 520 at slots 1446a, 1446b (collectively referred to as slots 1446) on the underside of each slider bracket 1442.

The socket drive mechanism 520 further includes a microswitch actuator skirt 1440.

The microswitch actuator skirt 1440 acts as a trigger for the socket engaged microswitches 1436. The microswitch actuator skirt 1440 also closes the field of view from the environment to protect internal components from radiation and charging.

The skirt 1440 fits into the slots 1446 in the sliders 1442 such that when the socket drive 536 compresses axially via the wave springs 1434 due to the torque bolt 524 pushing back on the socket drive 536, the sliders 1442 mechanically actuate the microswitches 1436 given the axial travel of the socket drive 536.

The slots 1446 in the sliders 1442 allow continuous rotation of the skirt 1440 and thus continuous rotation of the socket drive 536. The microswitch sensing design may only track the axial motion of the socket drive 536 to provide the indication of socket drive engaged versus disengaged.

The socket engaged microswitch 1436 is configured to sense whether the socket head 536 of the socket drive mechanism 520 is fully forward and indicate a state change if the socket head 536 retracts along socket axis 1430 from the fully forward position. The socket head 536 is on the axial compliance 1428 and may be deflected back from the socket engaged microswitch 1436 if the socket 536 is not aligned over the hex profile of the torque bolt 524. The socket head 536 is nominally fully forward. When grappling a payload 516, if the socket head 536 is not aligned and is deflected backwards towards the microswitch 1436, the socket head 536 may be turned slightly until the socket head 536 seats properly and the indication of alignment/proper seating is received (via change in state of the socket engaged microswitch 1436). This also establishes a zero position for the rotational motion of the socket drive 536 that follows. The zero position may be used when monitoring the torque transferred to the torque bolt 524 (e.g., via number of turns).

The socket drive mechanism 520 contains hardstops for its linear travel. The socket drive mechanism 520 may not include any rotational hardstops as the mechanism 520 accommodates a continuous range of motion. Operationally, the socket drive mechanism 520 may be driven into hardstops of an interfacing fastener (not shown), baselining that hardstop position as a home position from which to start counting turns. The socket drive 536 may then be rotated to a known turn count (e.g. while monitoring current) to determine when an operation is complete.

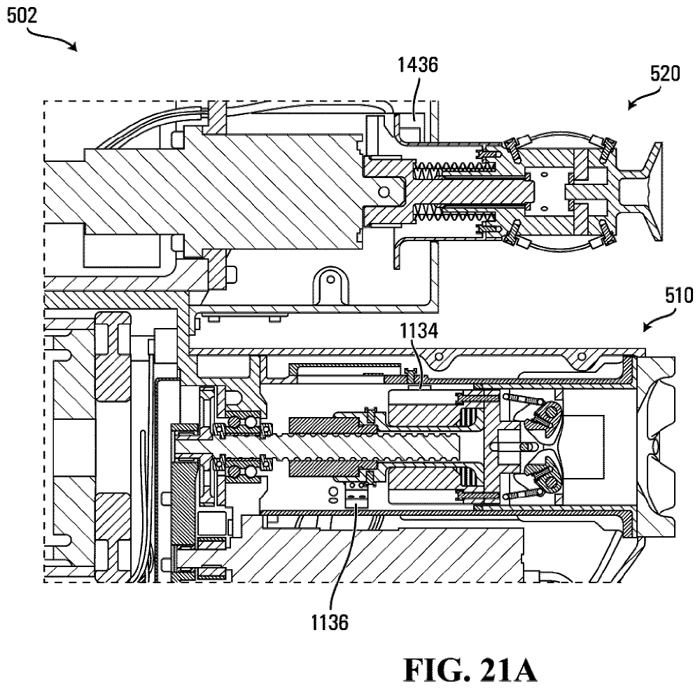

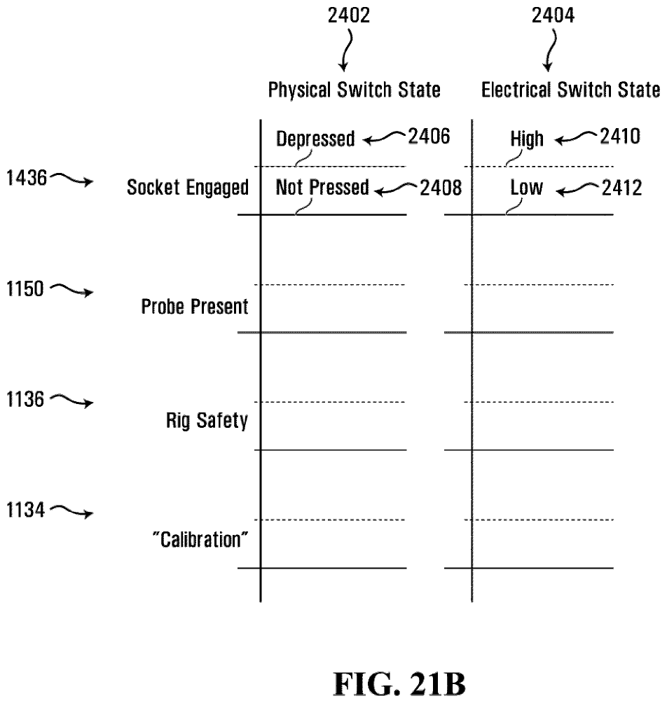

Referring now to FIGS. 21 to 40, shown therein are cross-sectional side views of the grapple mechanism 510 and socket drive mechanism 520 of the EE 502 and corresponding physical and electrical switch states for each of the socket engaged microswitch 1436, the payload present microswitch 1150, the rigidization safety microswitch 1136, and the calibration microswitch 1134 over an operational sequence performed by the EE 502, according to an embodiment.

The locations of the socket engaged microswitch 1436, the payload present microswitch 1150, the rigidization safety microswitch 1136, and the calibration microswitch 1134 are shown in FIG. 21A.

FIG. 21B illustrates an example graphical representation 2402 of the switch states of the microswitches, the format of which will be used to illustrate switch states throughout the operational sequence. Each of the socket engaged microswitch 1436, payload present microswitch 1150, rigidization safety microswitch 1136, and calibration microswitch 1134 has a corresponding physical switch state 2402 and electrical switch state 2404. The physical switch state 2402 may be a depressed state 2406 or a not depressed state 2408. The electrical switch state 2404 may be a high state 2410 or a low state 2412. Generally, when powered on, a depressed physical switch state 2406 corresponds to a low electrical switch state 2412 and a non-depressed physical switch state 2408 corresponds to a high electrical switch state 2410.

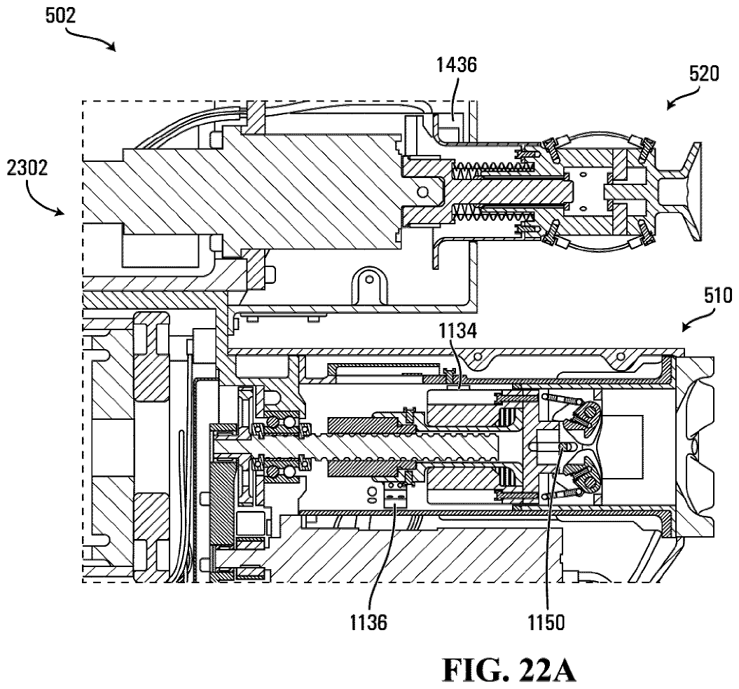

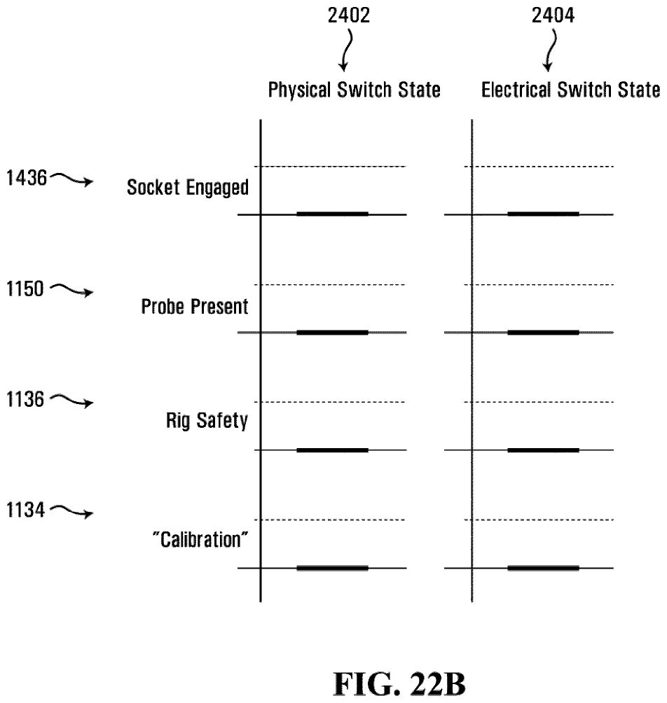

FIG. 22A shows the end effector 502 in a “rest state” 2302 when power is off. The corresponding switch states shown in FIG. 22B for all switches 1134, 1136, 1150, 1436 are non-depressed state and low electrical switch state.

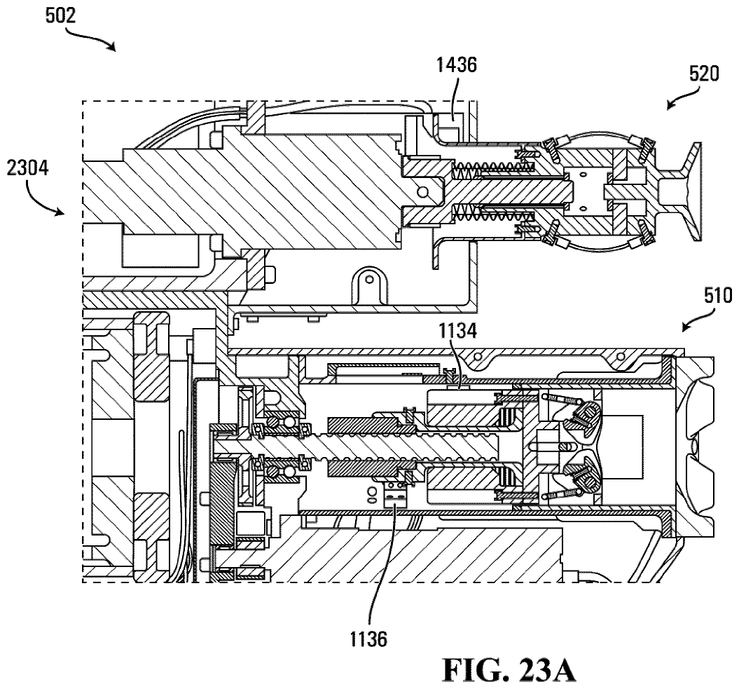

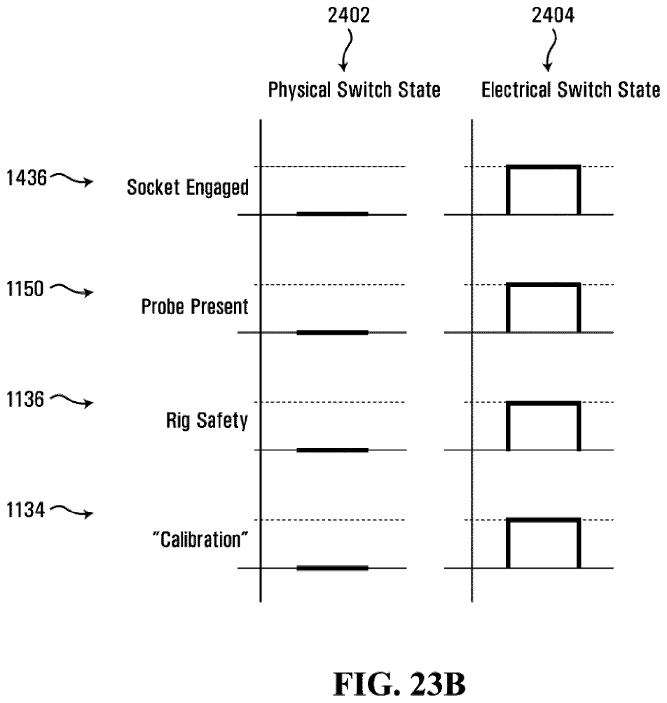

FIG. 23A shows the end effector 502 in a “rest state” 2304 when power is on. FIG. 23B shows that the electrical switch states 2404 for each of the switches 1134, 1136, 115, 1436 has changed to high electrical switch state 2410.

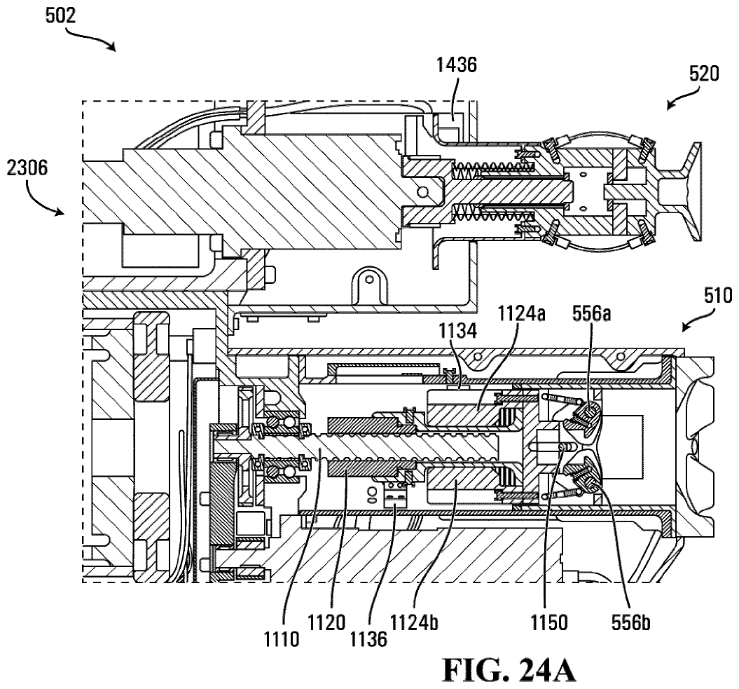

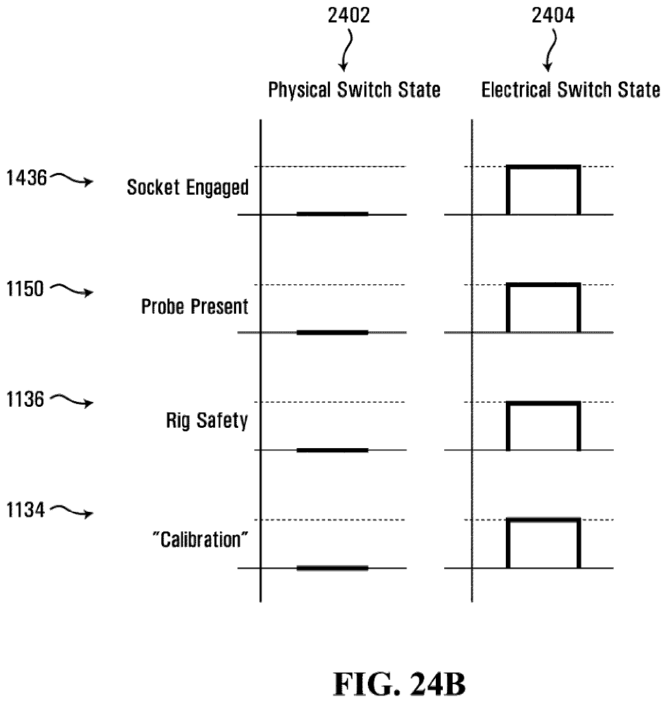

FIG. 24A shows the end effector 502 in a state 2306 of power up while at “rest state”. FIG. 24B shows the corresponding switch states 2406 of the switches 1134, 1136, 1150, 1436. The switch states and position of the mechanisms 510, 520 of the end effector 502 have not changed from FIGS. 23A, 23B.

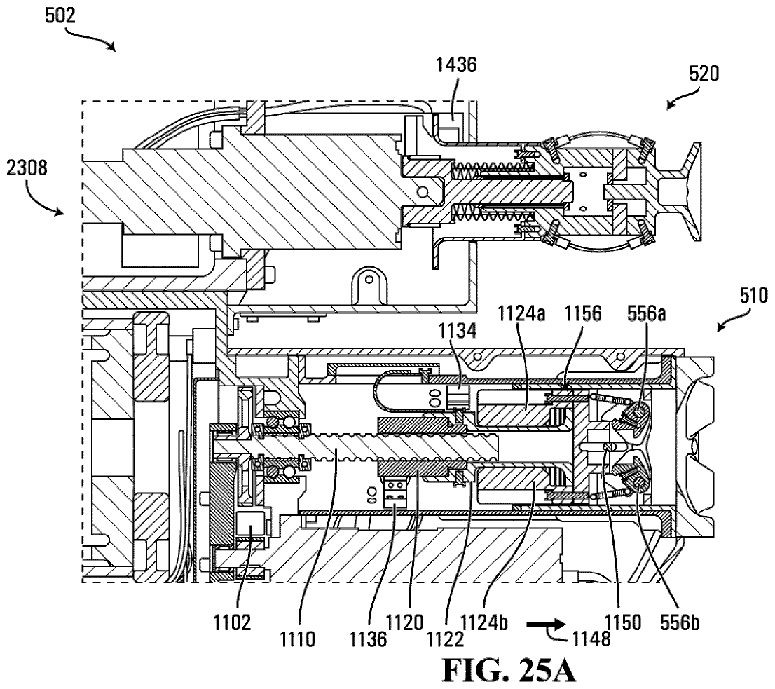

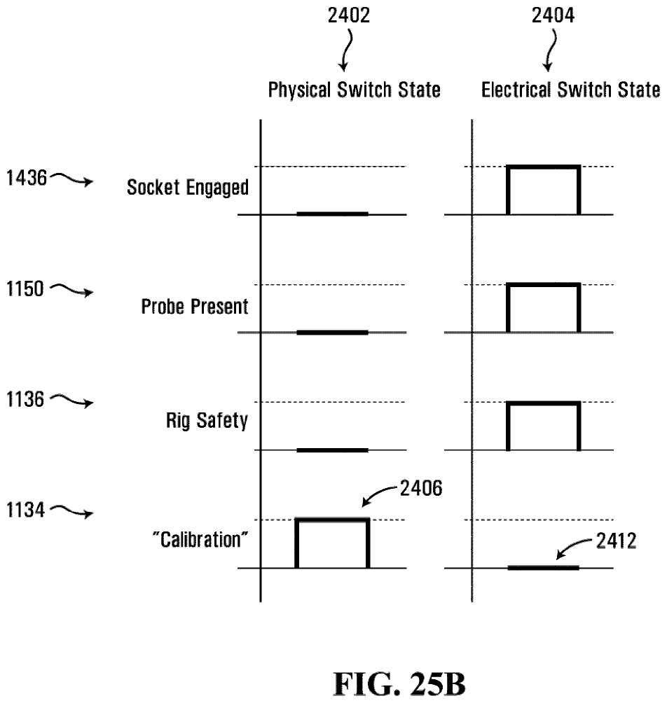

FIG. 25A shows the end effector 502 in a calibration position 2308. The motor module 554 drives the single stage gear pass 1102 to rotate the ball screw 1110. As the ball screw 1110 rotates, the ball nut 1120 translates the jaw mechanism (jaw housing 1128, Belleville spring stack 1126 and screw sleeve 1122) forward in direction 1148. In doing so, the calibration switch 1134 is depressed.

FIG. 25B shows that the physical switch state 2402 of the calibration switch 1134 has changed to a depressed state 2414 and that the electrical switch state 2404 has changed to a low state 2416.

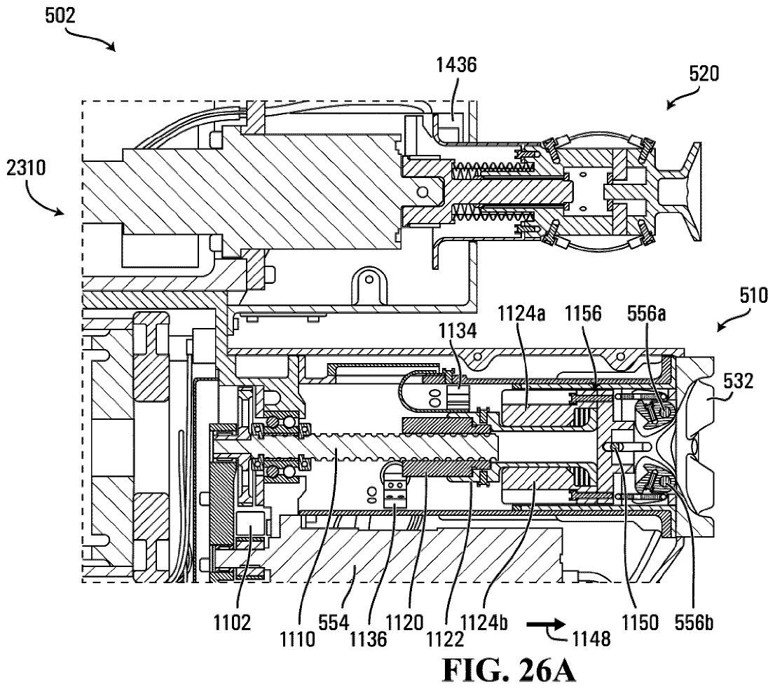

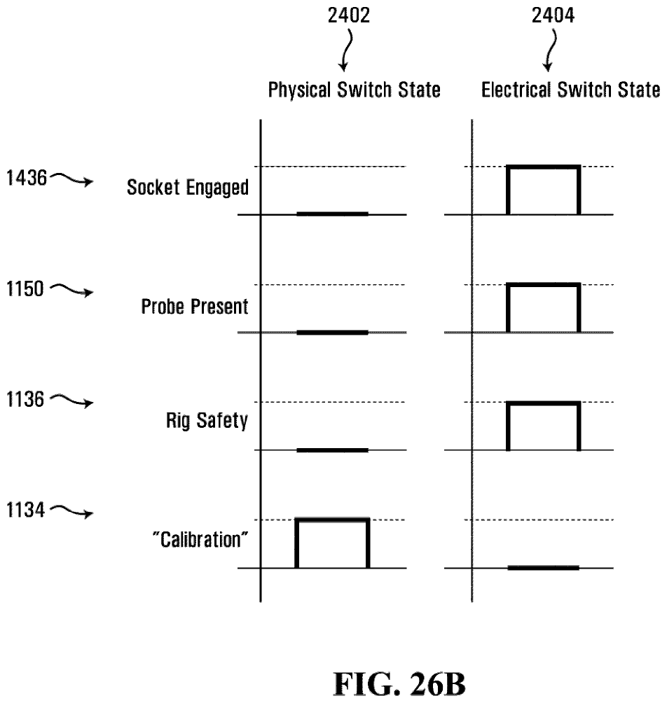

FIG. 26A shows the end effector 502 in a ready for capture state 2310. The motor module 554 further drives rotation of the ball screw 1110. The ball nut 1120 translates the jaw mechanism to a fully forward position where the jaw housing 1128 is against the back face of the coupling element 532. This movement causes the extension springs 1131 to move from an extended state to a free state, actuating the jaws 556 from a closed configuration to an open configuration.

FIG. 26B shows that the switch states 2402, 2404 for the switches 1134, 1136, 1150, 1436 in the ready for capture state 2310 have not changed from the calibration position 2508 of FIGS. 25A, 25B.

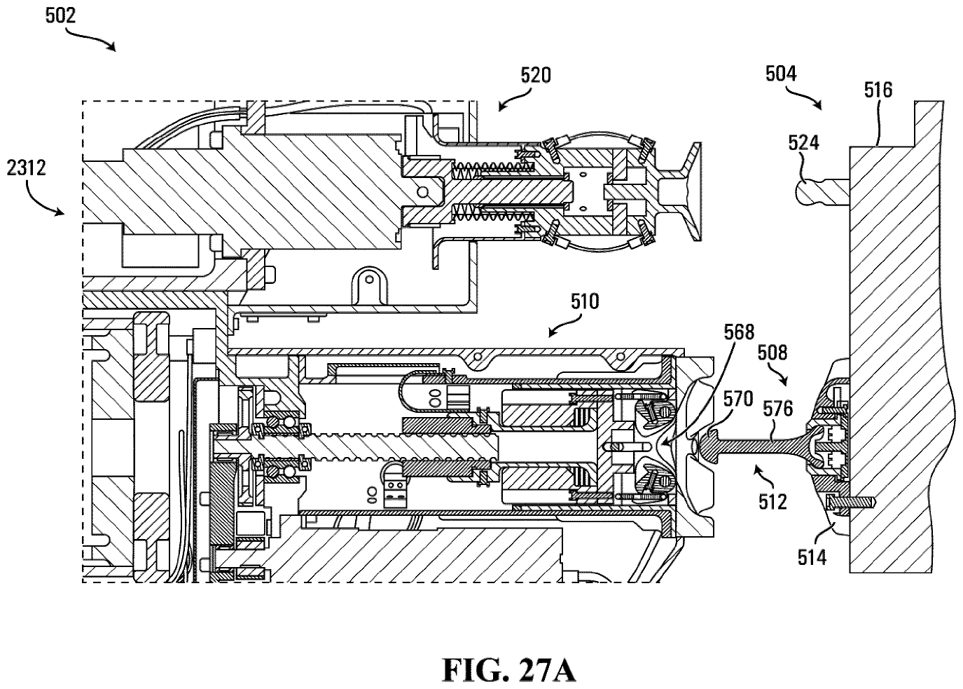

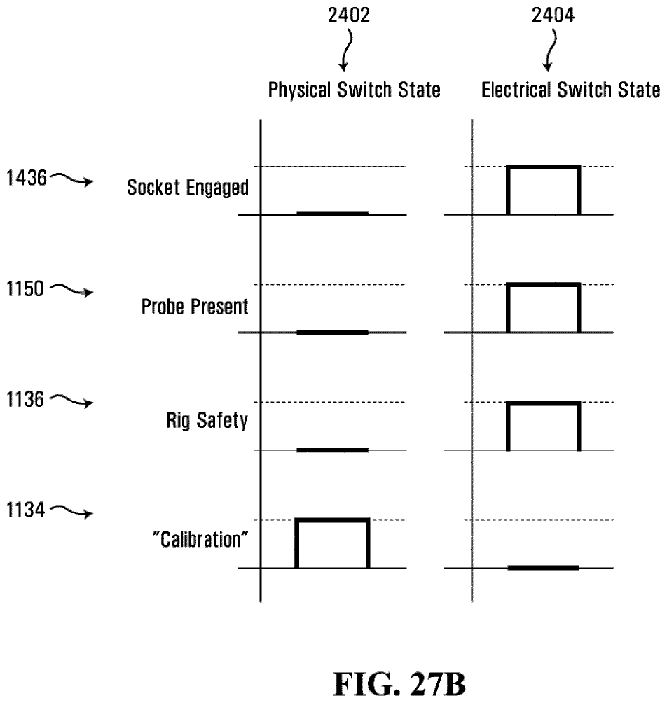

FIG. 27A shows the end effector 502 in an approach and ready for capture state 2312. The payload interfacing end of the end effector 502 is moved via the robotic arm (not shown) towards a prepared interface 504 on the payload 516. The prepared interface 504 includes the torque bolt 524 and the grapple fixture 508. The grapple probe 512 of the grapple fixture 508 is within the capture envelope of the end effector 502. The grapple probe 512 is approaching the grapple face of the end effector 502.

FIG. 27B shows that the switch states 2402, 2404 for the switches 1134, 1136, 1150, 1436 in the approach and ready for capture state have not changed from the ready for capture state 2310 of FIGS. 26A, 26B.

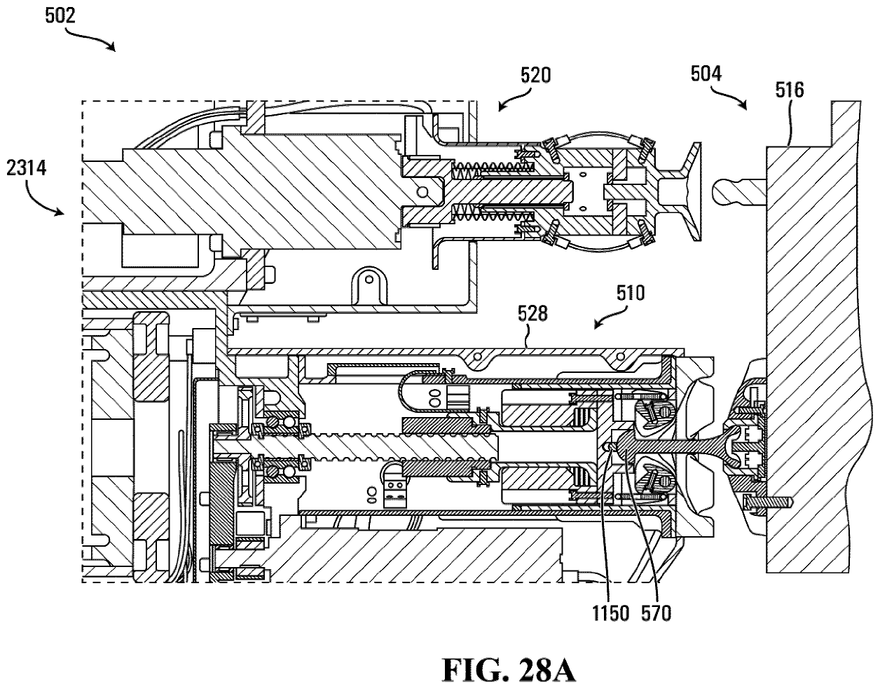

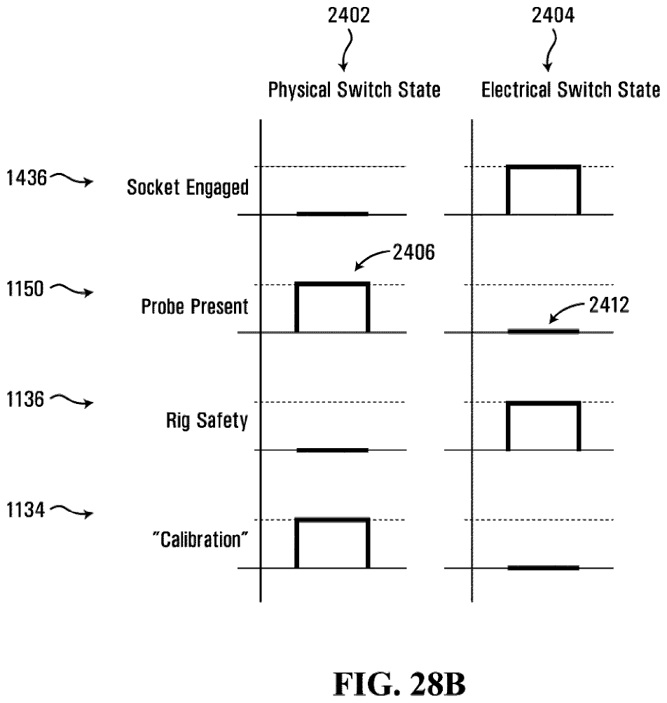

FIG. 28A shows the end effector 502 in a payload present state 2314. Through the continued movement of the end effector 502 towards the prepared interface 504 of the payload 516, the grapple probe 512 enters the grapple canister 528 through the grapple opening 534 in the grappling mechanism 510 and into the grappling area 568. The probe tip 570 of the grapple probe 512 contacts the probe present bar 558 at the distal end of the grappling area 568, triggering the probe present microswitch 1150.

FIG. 28B shows that the physical switch state 2402 of the probe present switch 1150 has changed from non-depressed to a depressed state 2408 and the electrical switch state 2404 has changed from high state 2410 to a low state 2412 as a result of the probe tip 570 contacting the probe present bar sensor 557. The end effector 502 is now aware that the payload is present (i.e. the grapple probe 512 is in the grappling area 568) and retraction of the grappling mechanism 510 can begin.

FIG. 29A show the end effector 502 in a jaws closed state 2315. The jaws closed state 2315 may also be referred to as a “soft capture” state (i.e., probe head of the grapple fixture has been captured, but rigidization has not yet occurred). Soft capture (with low initial loads) may put the interface into a state where rigidization loads can be precisely controlled. Retraction of the grapple mechanism 510 along the capture axis has been initiated, causing the grapple jaws 556 to move from the open configuration to the closed configuration and grapple the grapple probe 512 via the probe tip 570. The motor module 554 drives the single stage gear pass 1102 to rotate the ball screw 1110. As the ball screw 1110 rotates, the ball nut 1120 translates the jaw mechanism/assembly 1156 (jaw housing 1128, Belleville spring stack 1126, and screw sleeve 1122) in direction 1148. As the jaw assembly is retracted along the capture axis, the extension springs 1131 in the jaw assembly 1156 move from the free state to the extended state, actuating the grapple jaws 556 from the open configuration to the closed configuration. As can be seen, the retracting jaw assembly 1156 is approaching the calibration switch 1134.

FIG. 29B shows the switch states 2402, 2404 for the switches 1134, 1136, 1150, 1436 in the jaws closed state 2314 have not changed from the payload present state 2312 of FIGS. 29A, 29B, and that the payload present switch 1150 remains engaged.

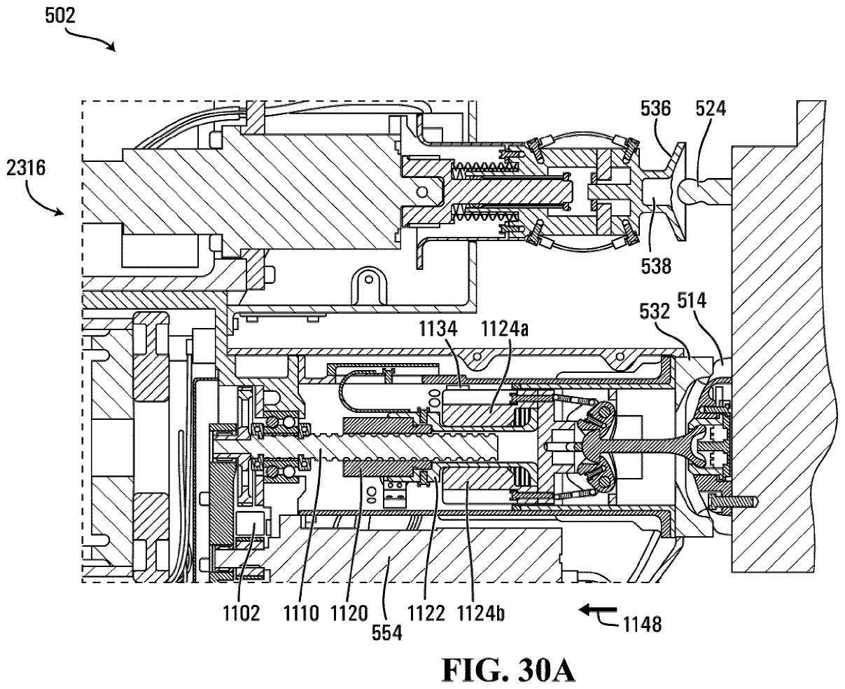

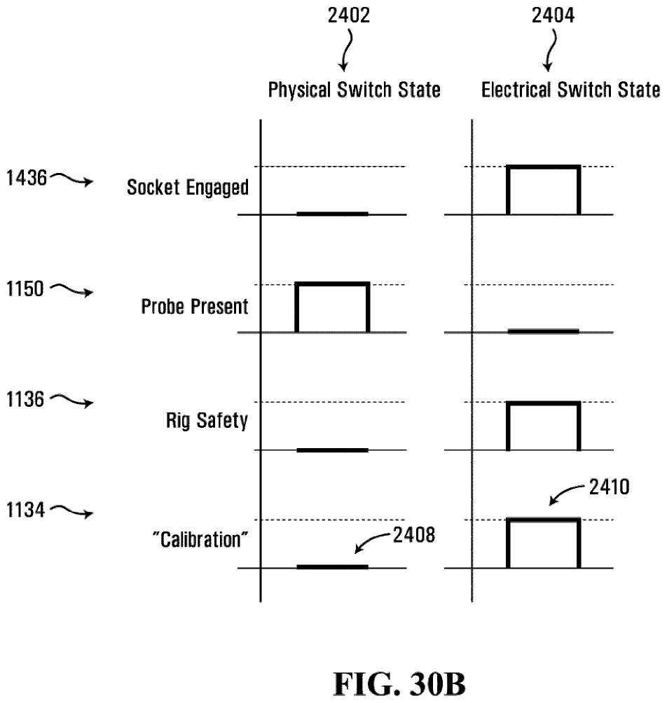

FIG. 30A shows the end effector 502 in a first contact with socket drive state 2316. The grapple mechanism of the end effector 502 has further retracted the grapple probe 512 of the payload 516 by translating the jaw assembly 1156 along the capture axis in direction 1148, bringing the torque bolt 524 of the payload 516 into contact with the socket drive 536 of the socket drive mechanism 520.

The retraction of the jaw assembly 1156 relative to the position shown in FIG. 30A releases the calibration microswitch 1134, effecting a state change. This state change indicates that the grapple mechanism 510 has passed the home or calibration position. In response to the state change in the calibration switch 1134, the resolver (not shown) in the motor module 554 monitors the motor position (e.g. tracking turn counts) as the jaw assembly 1156 continues its translation along the capture axis.

FIG. 30B shows that the calibration switch 1134 physical switch state 2402 has changed from a depressed state 2406 to a non-depressed state 2408 and the electrical switch state 2404 has changed from a low state 2412 to a high state 2410. As previously noted, this change in switch state is caused by the continued retraction of the jaw assembly 1156 relative to the position shown in FIG. 29A. The socket engaged switch 1436 is not yet engaged, reflected by the non-depressed physical switch state 2408 and the high electrical switch state 2410, as the socket head 536 is still in its fully forward position (axial compliance 1428 not engaged).

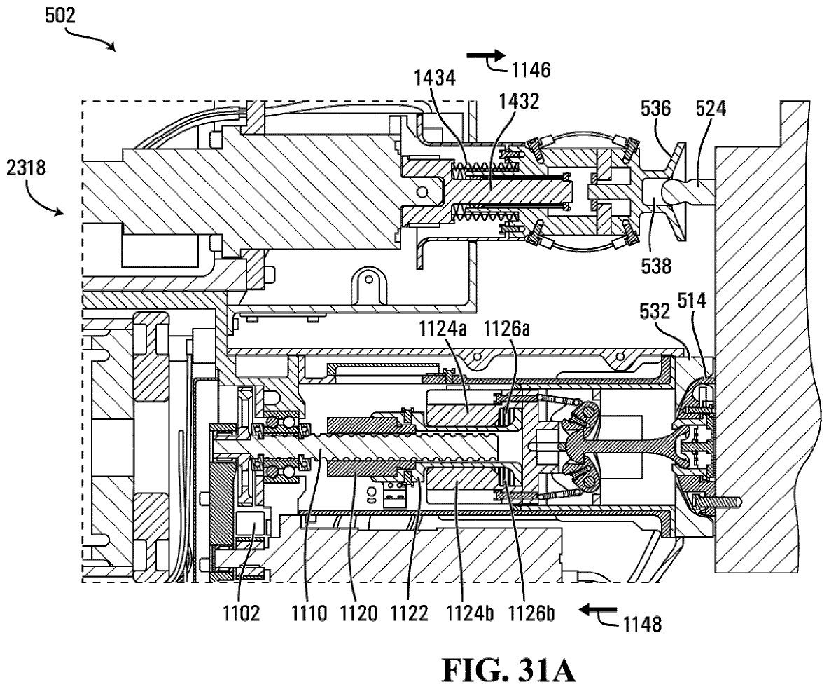

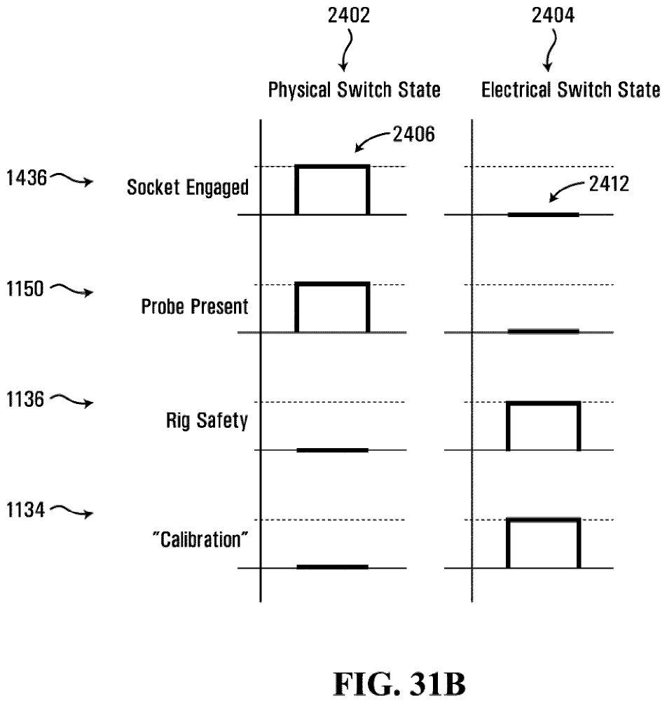

FIG. 31A shows the end effector 502 in a state 2318 corresponding to the coupling element 514 of the grapple fixture 508 having contacted the coupling element 532 of the grapple mechanism 510 and the socket 538 not aligned on the torque bolt 524.

The misaligned torque bolt 524 contacts the socket head 536 and, by virtue of its misalignment (torque bolt hex misaligned to socket hex), the socket drive 536 is passively retracted in direction 1148 via the axial compliance mechanism 1428 of the socket drive mechanism 520. In particular, the misaligned torque bolt 524 contact causes compression of the wave springs 1434 in the socket drive mechanism 520 and movement of the spline shaft 1432 further into the (axial compliance) cavity 1429.

The jaw assembly 1156 with grappled probe 512 is further retracted along the capture axis, bringing the coupling element 532 of the grapple mechanism 510 into mating contact with the coupling element 514 of the grapple fixture 508. Mating of the respective coupling elements 532, 514 also promotes alignment.

FIG. 31B shows that the switch states 2402, 2404 of the socket engaged switch 1436 have changed as a result of the misaligned socket drive 536 being deflected back from the torque bolt 524 via the axial compliance mechanism 1428. This retraction of the socket drive 536 depresses the socket engaged switch 1436, changing the physical switch state 2402 to a depressed state 2406 and the electrical switch state 2404 to a low state 2412. Triggering of the socket engaged switch 1436 may be communicated to a robotic workstation in communication with the end effector (or the robotic system controlling the end effector 502) so that an operator can use a human-machine interface of the robotic workstation to command the socket drive mechanism 520 to rotate (using the Oldham coupling 1420) to properly seat the socket 538 on the torque bolt 524.

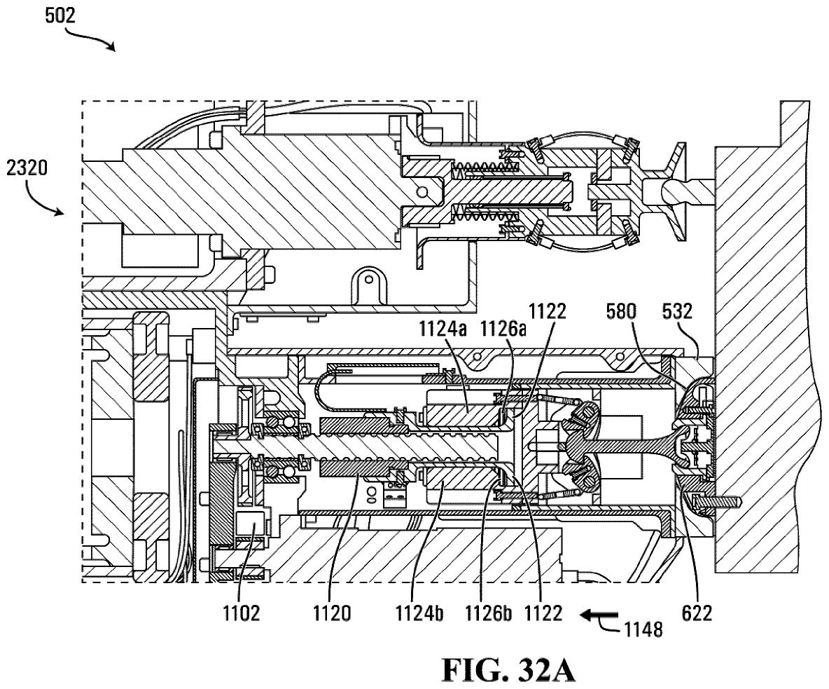

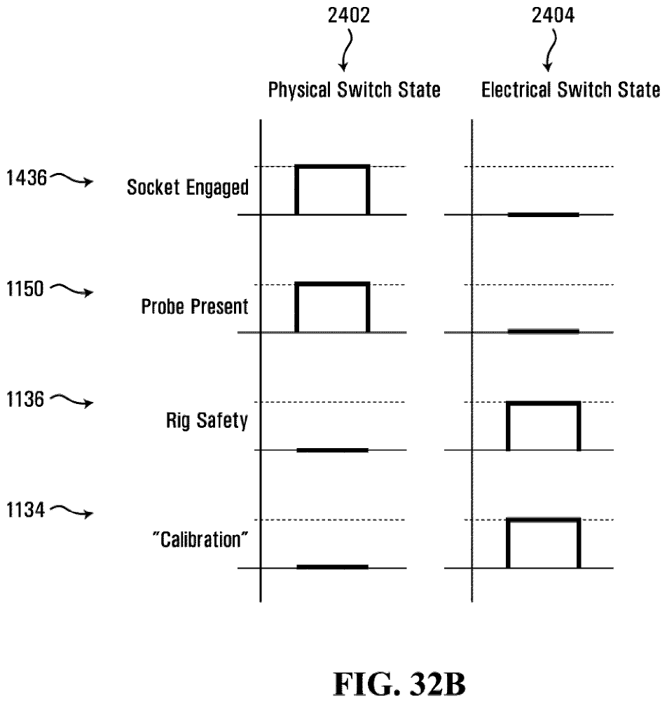

FIG. 32A shows the end effector 502 in a state 2320 in which the interface between the grapple fixture 508 and the grapple mechanism 510 has been rigidized, rigidizing the end effector 502 to the payload 516, and the socket 538 is not aligned to the torque bolt 524 (“rigidized, socket not aligned”).

Relative to the position of the grapple mechanism 510 shown in FIG. 31A, the grapple motor module 554 has further driven the gear pass 1102 to rotate the ball screw 1110, causing the ball nut 1120 to translate the screw sleeve 1122 interfacing with the ball nut 1120 in direction 1148 relative to the jaw assembly 1156. The movement of the screw sleeve 1122 relative to the split housing 1124 of the jaw assembly 1156 compresses the Belleville spring stacks 1126 to generate the target preload. The retraction of the screw sleeve 1122 is controlled to a target preload position through continued monitoring of motor position by the resolver in the grapple motor module 554 (movement relative to the calibration position indicated by the engaged calibration switch 1134).

The socket 538 remains misaligned to the torque bolt 524 (and the socket engaged switch 1436 remains engaged).

FIG. 32B shows the switch states 2402, 2404 for the switches 1134, 1136, 115, 1436 in the rigidized state 2320 have not changed from the grapple fixture contact state 2318 of FIGS. 31A, 31B.

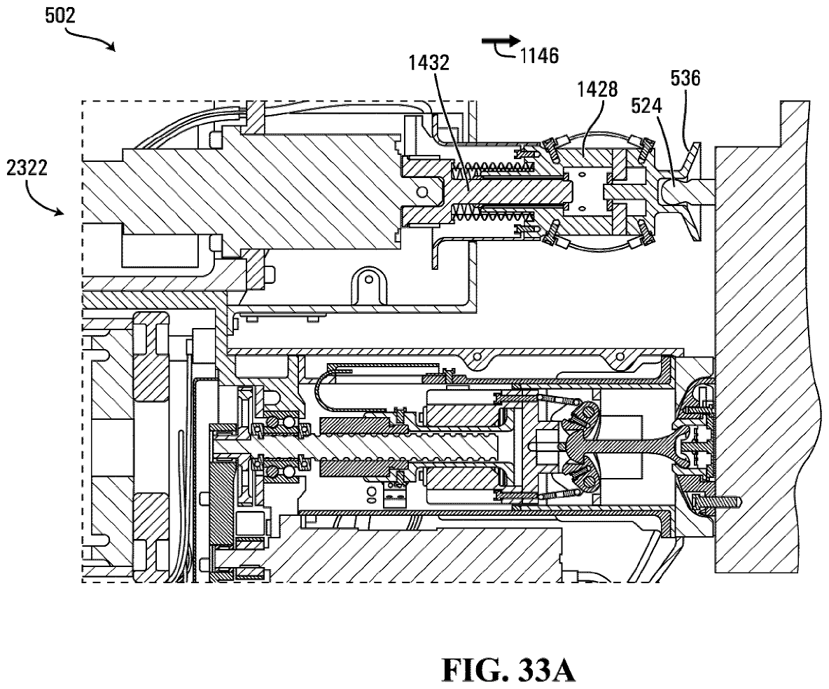

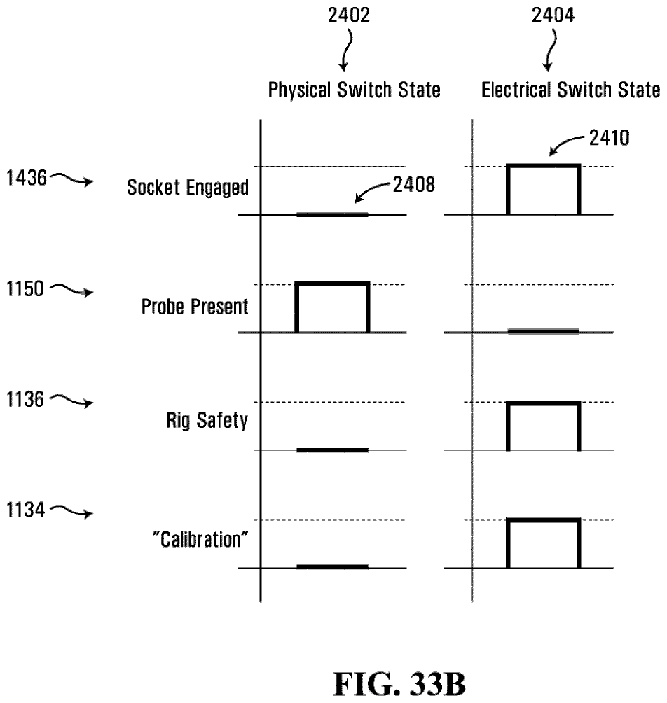

FIG. 33A shows the end effector 502 in a state 2322 in which the interface between the grapple fixture 508 and the grapple mechanism 510 remains rigidized and the socket 538 is aligned. In this state, the end effector 502 is ready to perform operations, such as transferring torque to the torque bolt 524 through rotation of the socket drive mechanism 520.

Relative to the state shown in FIG. 32A, the socket drive mechanism 520 has been rotated to a point at which the torque bolt 524 is properly aligned with the socket 538. As the socket 538 is properly seated on the torque bolt 524, the axial compliance 1428 is released as the wave springs 1434 decompress and the spline shaft 1432 retracts in the cavity 1429. As the socket drive 536 moves forward in direction 1146, the socket engaged switch 1436 is disengaged, changing the switch states 2402, 2404.

The socket engaged switch 1436 may send a signal to the socket drive motor module 1438 to drive the socket drive mechanism 520 (e.g. to a desired number of turns, to a desired torque (current limiting)).

FIG. 33B shows that the physical and electrical switch states 2402, 2404 of the socket engaged switch 1436 have changed to a non-depressed state 2408 and high electrical state 2410, respectively. This change in switch states 2402, 2404 indicates the socket 538 is properly seated on the torque bolt 524 and ready for operations.

The following figures correspond to the release of the payload 516 from the end effector 502.

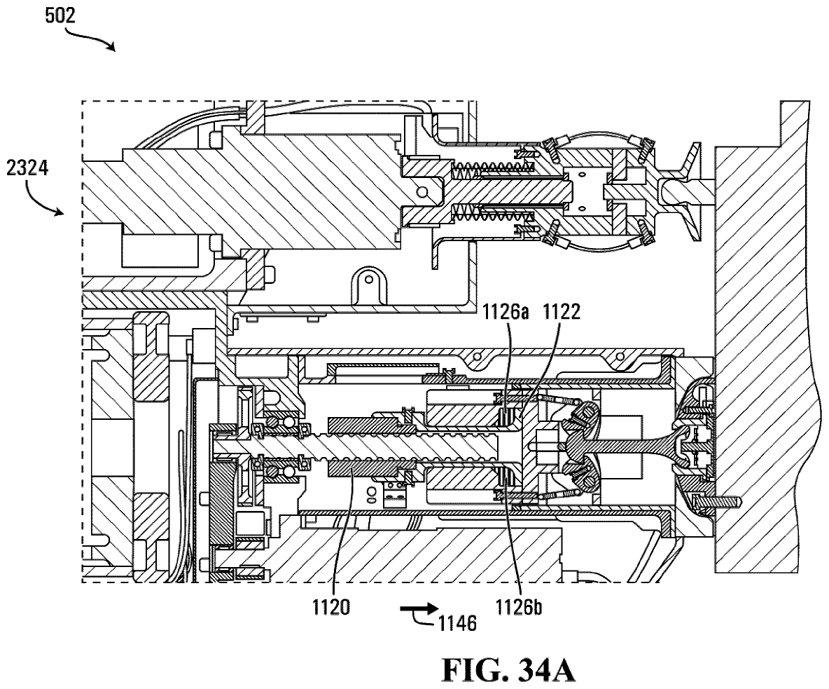

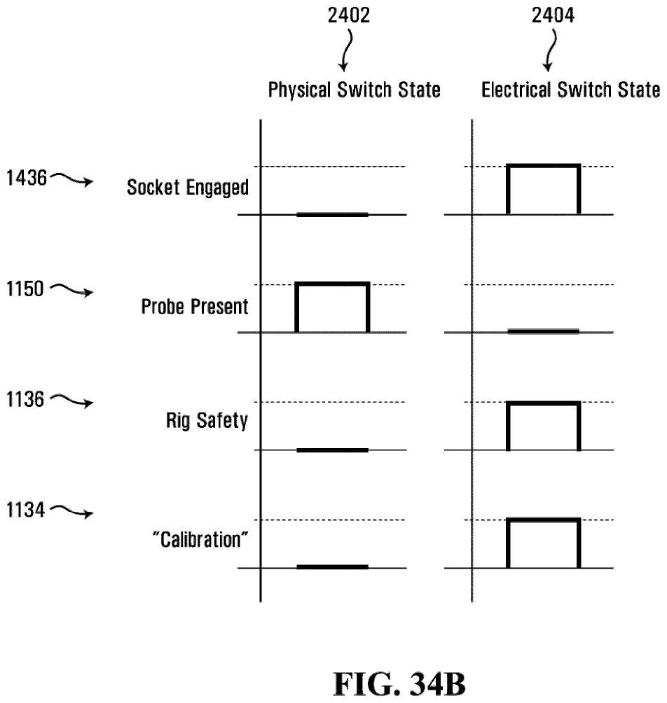

FIG. 34A shows the end effector 502 in a state 2324 in which the preload generated during rigidization (shown in FIG. 34A) is released. To release the preload, the grapple motor module 554 drives the gear pass 1102 to rotate the ball screw 1110, causing the ball nut 1120 to translate the screw sleeve 1122 in direction 1146 (opposite of retraction) along the capture axis relative to the split housing 1124, decompressing the Belleville spring stacks 1126.

FIG. 34B shows the switch states 2402, 2404 for the switches 1134, 1136, 115, 1436 in the released preload state 2324 have not changed from the rigidized state 2322 of FIGS. 33A,33B.

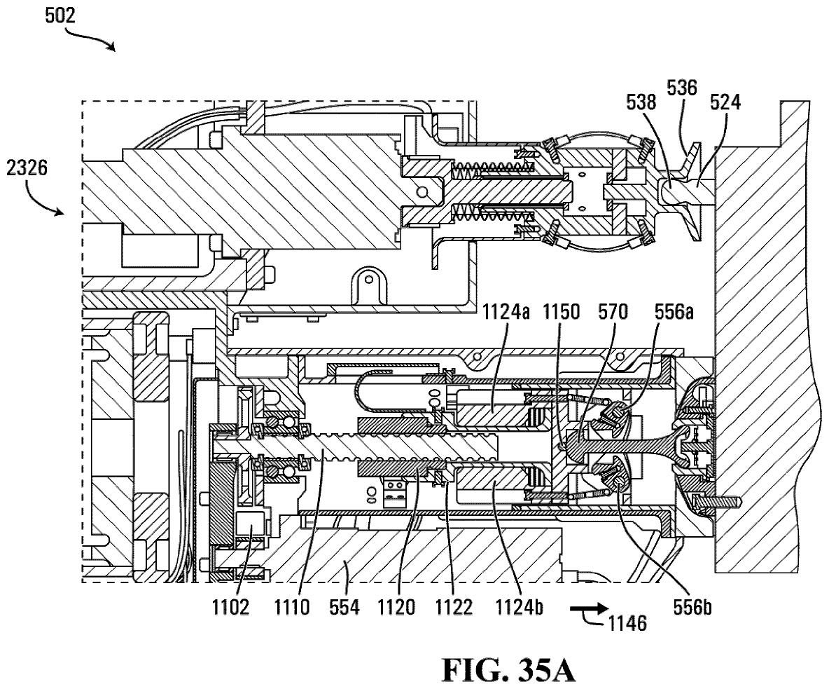

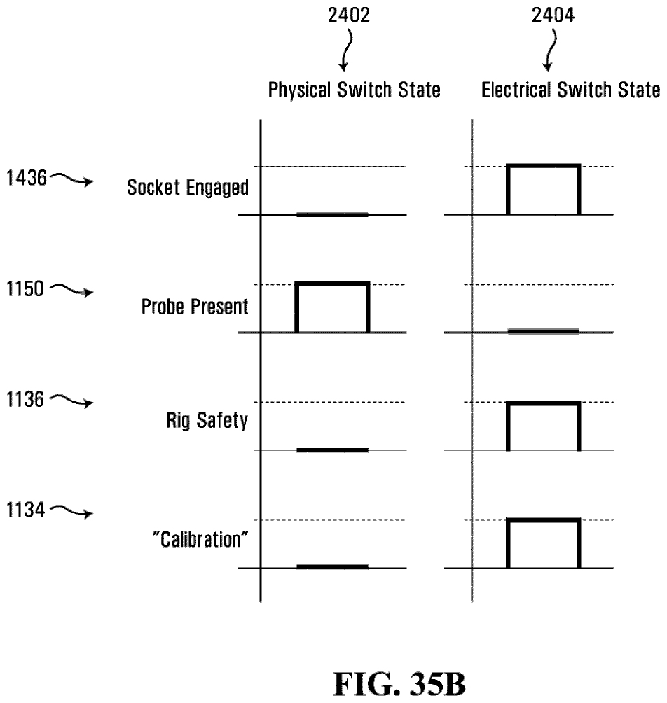

FIG. 35A shows the end effector 502 in a payload release state 2326 in which the grapple mechanism 510 starts to push on the grapple probe 512 in direction 1146. In particular, the ball screw 1110 is rotated to cause the ball nut 1120 to translate the jaw assembly 1156 in direction 1146 to a point at which the jaw housing 1128 contacts the rounded surface 572 of the probe tip 570 and pushes the probe 512 in direction 1146 as the jaw assembly 1156 is further translated in direction 1146.

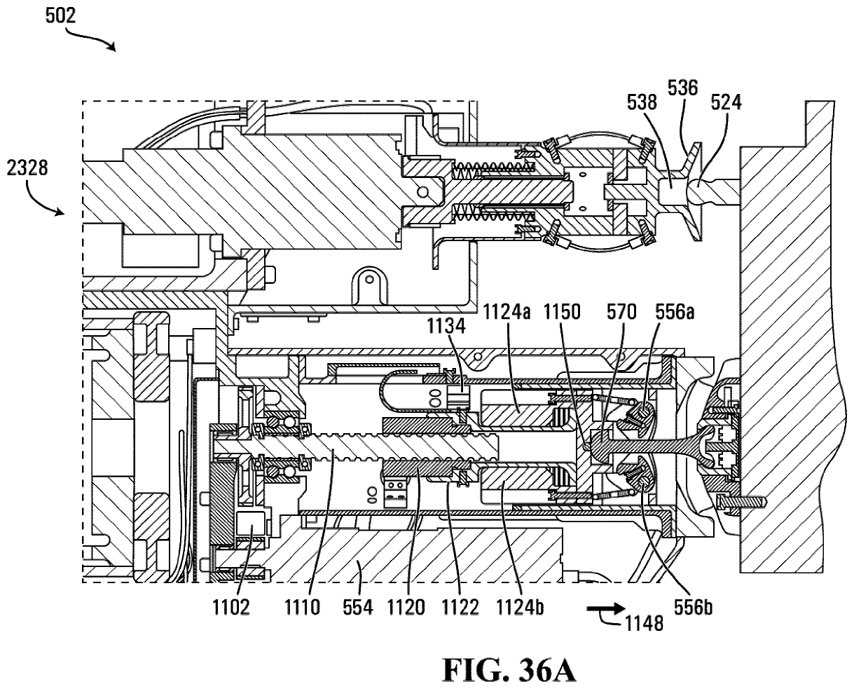

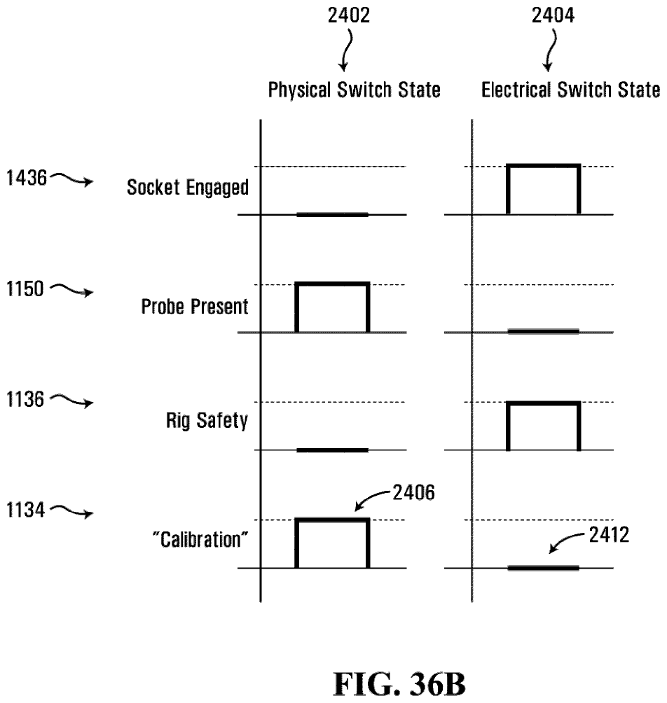

FIG. 35B shows the switch states 2402, 2404 for the switches 1134, 1136, 1150, 1436 in the payload release state 2326 have not changed from the released preload state 2324 of FIGS. 36A, 36B.

FIG. 36A shows the end effector 502 in a payload release state 2328 in which the grapple jaws 556 start to move from the closed configuration to the open configuration. The jaw assembly 1156 has been further translated via rotation of the ball screw 1110 and the jaw housing 1128 continues to push on the probe tip 570 in direction 1146. At this stage, the extension springs 1131 start to move from the extended state to the free state, to actuate the grapple jaws 556.

The jaw assembly 1156 has been translated back to or past the calibration (home position), engaging the calibration microswitch 1134.

Further, the grapple mechanism 510 pushing on the probe 512 has caused the coupling element 514 of the grapple fixture 508 to decouple from the coupling element 532 of the grapple mechanism 510 and the torque bolt 524 to release from the socket 538.

FIG. 36B shows the physical switch state 2402 and electrical switch state 2404 of the calibration switch 1436 have changed to a depressed physical state 2406 and a low electrical state 2412, respectively. This change in state is caused by the jaw assembly 1156 traveling past and engaging the calibration microswitch 1134.

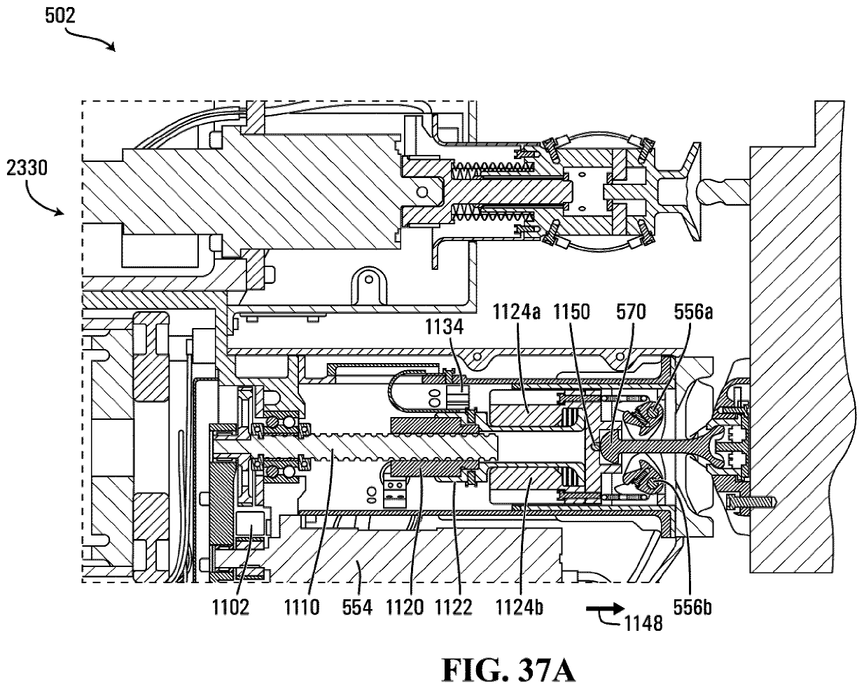

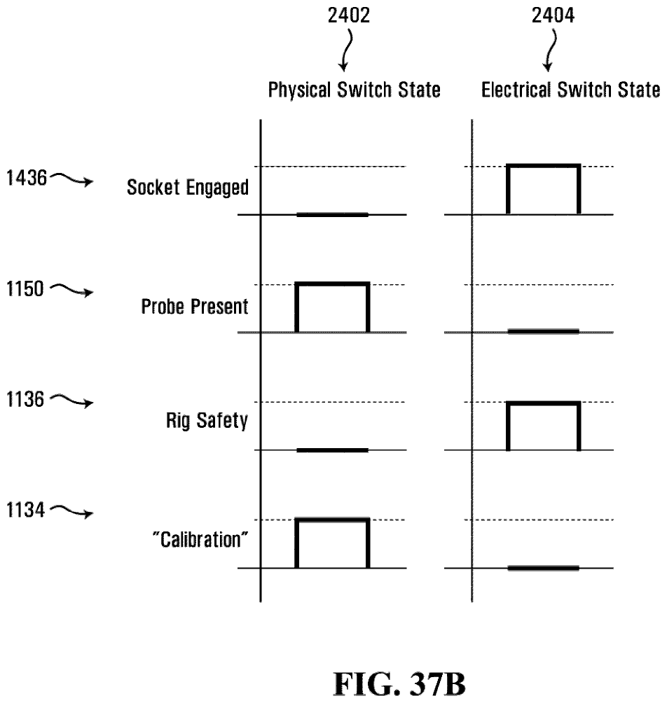

FIG. 37A shows the end effector 502 in a payload release state 2330 in which the grapple jaws 556 have partially opened.

Relative to the position shown in FIG. 36A, the jaw assembly 1156 is further translated along the ball screw 1110 in direction 1146. This movement further forces the extension springs 1131 of the jaw assembly 1156 towards the free state, actuating the grapple jaws 556 to open further.

FIG. 37B shows the switch states 2402, 2404 for the switches 1134, 1136, 1150, 1436 in the payload release state # have not changed from the payload release state 2328 of FIGS. 36A, 36B.

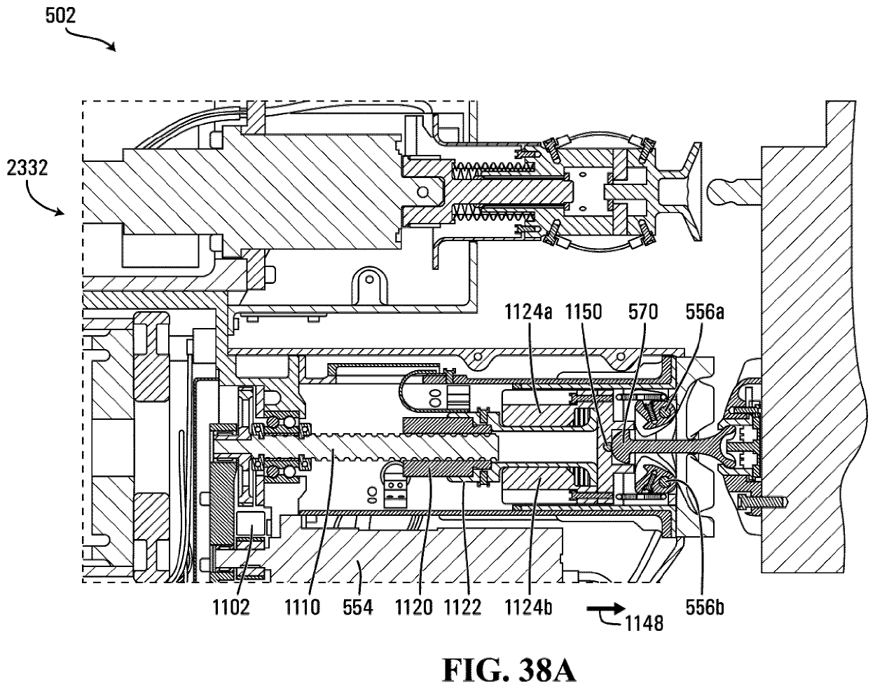

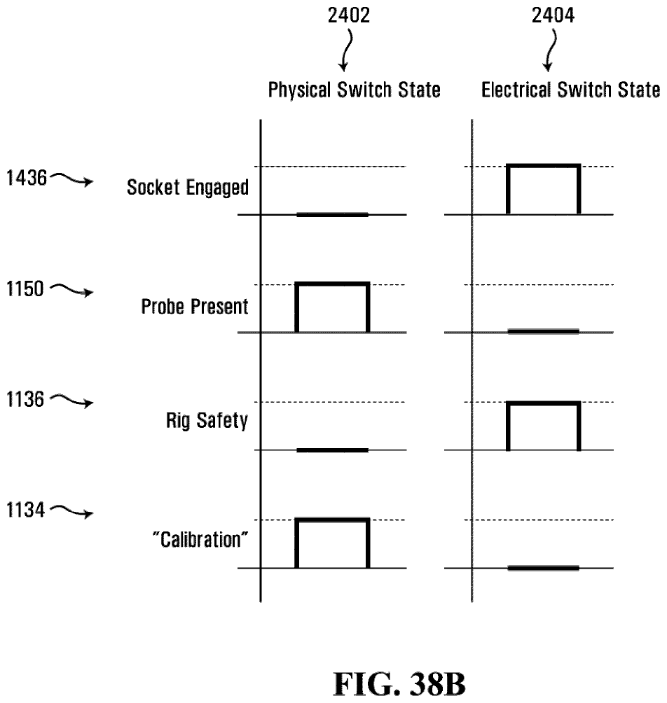

FIG. 38A shows the end effector 502 in a payload release state 2332 with the grapple jaws 556 open. The continued forward translation of the jaw assembly 1156 via the ball screw 1110 rotation pushes the jaw housing 1128 into contact with the back side of the coupling element 532. The continued forward translation of the jaw assembly 1156 also causes the extension springs 1131 to return to the free state, which actuates the grapple jaws 556 to fully open (open configuration). This fully open state of the grapple jaws 556 enables release of the grapple probe 512 from the grapple canister 528.

FIG. 38B shows the switch states 2402, 2404 for the switches 1134, 1136, 115, 1436 in the payload release state 2332 have not changed from the payload release state 2330 of FIGS. 37A, 37B.

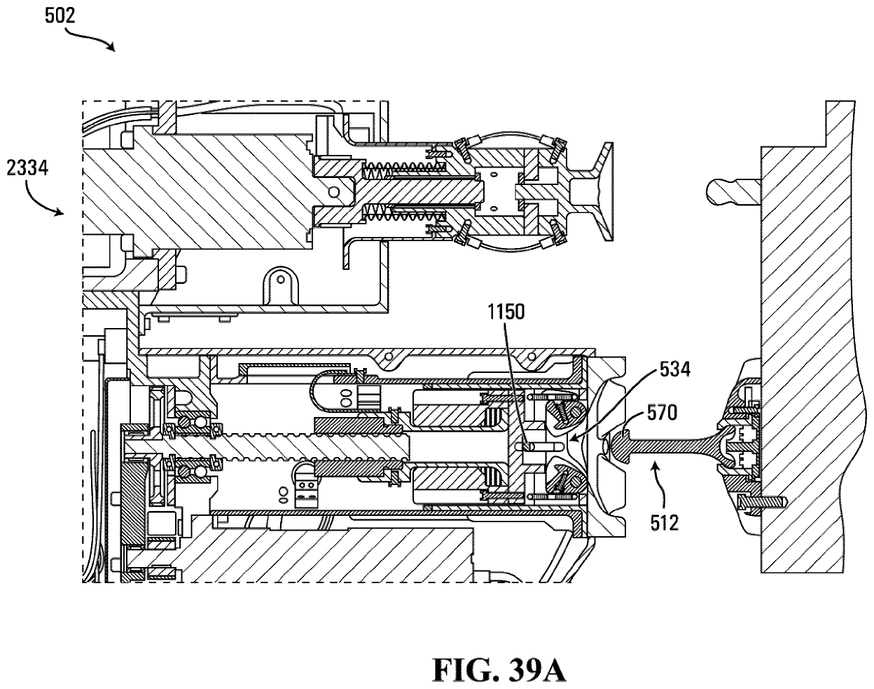

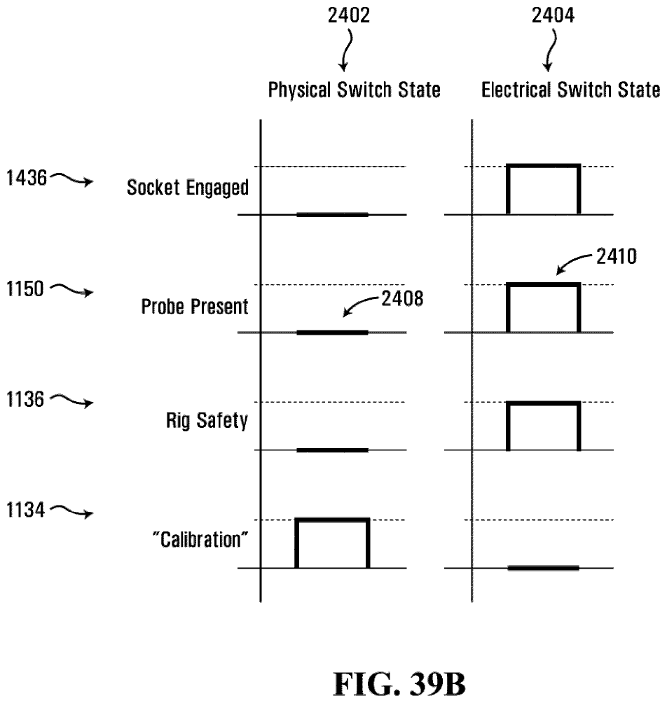

FIG. 39A shows the end effector 502 in a payload released state 2334. The grapple probe 512 has been released from the grapple canister 528 (enabled by the open grapple jaws 556), releasing the payload from the end effector 502.

The release of the grapple probe 512 causes the payload present microswitch 1150 to become disengaged (by virtue of the probe end 570 no longer depressing the payload present bar 557). Payload present may be activated or removed by motion of the end effector onto the grapple probe or off of the grapple probe.

FIG. 39B shows that the physical switch state 2402 and the electrical switch state 2404 of the payload present switch 1150 have changed to non-depressed 2408 and high electrical state 2410, respectively.

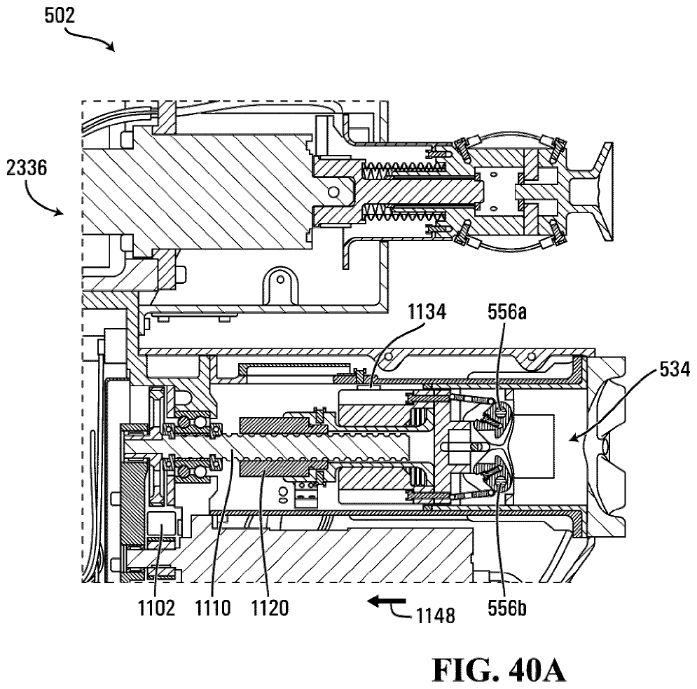

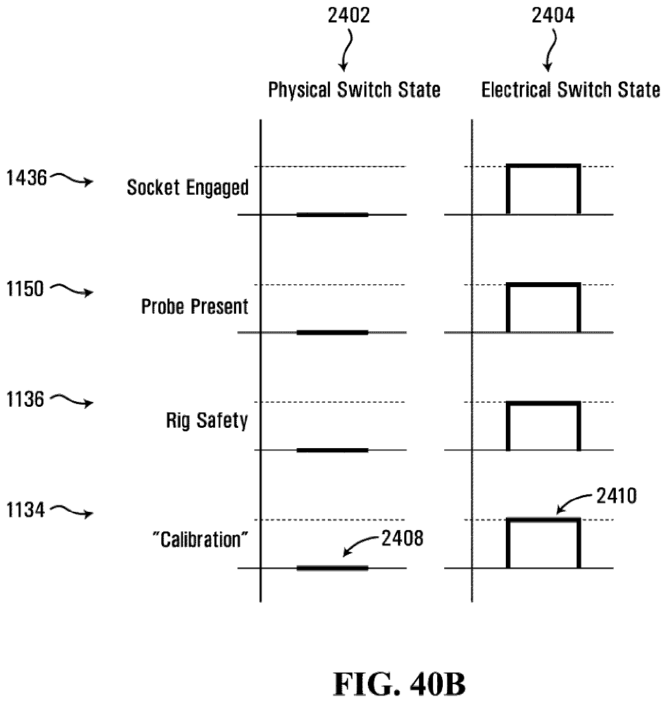

FIG. 40A shows the end effector 502 having returned to “rest state” 2326 shown previously in FIG. 35A. Movement to the rest state 2326 from the payload released state 2334 of FIG. 39A is effected by retraction of the jaw assembly 1156 along the capture axis via rotation of the ball screw 1110. As the jaw assembly 1156 retracts, the extension springs 1131 in the jaw assembly 1156 move from the free state (jaws open) to the extended state, closing the grapple jaws 556.

FIG. 40B shows that the physical switch state 2402 of the calibration switch 1134 has changed to a non-depressed state 2408 and the corresponding electrical switch state 2404 of the calibration switch 1134 has changed to a high state 2410 from the states 2402, 2404 in FIG. 39B.

While the above description provides examples of one or more apparatus, methods, or systems, it may be appreciated that other apparatus, methods, or systems may be within the scope of the claims as interpreted by one of skill in the art.

1. A robotic end effector device having an arm interfacing end including a robotic arm interface for connecting to a robotic arm and a payload interfacing end for interfacing with a payload, the payload having a grapple fixture which includes a first coupling element mounted to a surface of the payload and a grapple probe, the device comprising:
a housing for enclosing an interior compartment of the end effector device;
a second coupling element that is connected to the housing at the payload interfacing end for mating with the first coupling element during rigidization of the end effector to the payload, the second coupling element having an opening therethrough to enable the grapple probe of the grapple fixture to enter the interior compartment as the payload interfacing end is moved towards the grapple fixture by the robotic arm;
a grapple mechanism disposed in the interior compartment for capturing and rigidizing the payload to the end effector device through the grapple fixture, the grapple mechanism comprising:
a jaw assembly including jaws for grappling the grapple probe;
a payload present sensor for sensing that the grapple probe is in a position to be grappled by the jaws (“grappling position”);
a moving component for translating along a capture axis of the grapple mechanism in a direction opposite the payload interfacing end (“retraction”) to bring the first coupling element and the second coupling element into mating connection while the jaws are grappling the grapple probe to rigidize the end effector to the payload to a target preload, the moving component including the jaw assembly, and wherein the retraction of the moving component closes the jaws to grapple the grapple probe;
a translation mechanism for retracting the moving component along the capture axis;
a motor for driving the translation mechanism, the motor triggered to drive the translation mechanism in response to the payload present sensor sensing the grapple probe in the grappling position;
a calibration sensor for sensing that the moving component has retracted from a calibration position; and
a position monitoring device for monitoring a position of the moving component relative to the calibration position and generating an output to stop retraction of the moving component when the moving component has reached a target preload position along the capture axis that achieves the target preload.

2. The device of claim 1, wherein the first and second coupling elements each comprise a plurality of radially disposed teeth and notches, and wherein the teeth of the second coupling element are configured to mate with the notches of the first coupling element and the teeth of the first coupling element are configured to mate with the notches of the second coupling element when the first and second coupling elements are brought together during rigidization of the payload to the end effector.

3. The device of claim 1, wherein the first and second coupling elements are configured to each act as one half of a hirth coupling when the first and second coupling elements are brought into mating connection during rigidization of the payload to the end effector.

4. The device of claim 2, wherein the first and second coupling elements each comprise six teeth and six notches such that when mated the first and second coupling elements have twelve points of contact through the respective teeth and notches.

5. (canceled)

6. The device of claim 2, wherein the teeth of the second coupling element and the complementary notches on the first coupling element each comprise three curved side surfaces for promoting alignment of the teeth of the second coupling element with the notches of the first coupling element as the first and second coupling elements are engaged.

7. The device of claim 1, wherein the moving component comprises a compressible element biased between a first compressing surface of a sub-component of the moving component and a second compressing surface of the jaw assembly, the first compressing surface facing the arm interfacing end and the second compressing surface facing the payload interfacing end such that the first and second compressing surfaces face each other, and wherein, during retraction of the moving component, the jaw assembly stops retracting prior to the target preload position and the sub-component of the moving component continues retracting to the target preload position such that the compressible element is compressed between the first and second compressing surfaces to generate the target preload.

8-10. (canceled)

11. The device of claim 1, wherein the payload sensor includes a sensing element positioned such that the sensing element is triggered by the grapple probe when the grapple probe is inserted deep enough into the jaws to be grappled by the jaws when the jaws close.

12. (canceled)

13. The device of claim 11, wherein the sensing element is connected to the moving component such that the sensing element moves with the moving component during retraction to maintain a state indicating the payload is present throughout the rigidization.

14. (canceled)

15. The device of claim 1, wherein the grapple mechanism further comprises a brake for maintaining the target preload with no power draw required.

16-19. (canceled)

20. The device of claim 1, wherein the position monitoring device is configured to perform position monitoring of the moving component to a plurality of different target preload positions such that the grapple mechanism can rigidize the interface between the first and second coupling elements to a plurality of different target preloads.

21. The device of claim 20, wherein differences between respective ones of the plurality of target preload positions correspond to different amounts of compression applied to the compressible element by the relative movement of the first and second surfaces.

22. The device of claim 1, further comprising a force torque sensor mounted in a primary load path of the grapple mechanism, for limiting loads during grappling.

23-37. (canceled)

38. A method of robotic capture of a payload, the method comprising:
moving a payload interfacing end of an end effector via a robotic arm towards a grapple fixture on the payload such that the grapple fixture is within a capture envelope of the end effector, the payload interfacing end having a grapple mechanism;
sensing that a probe of the grapple fixture is within a grappling area of the grapple mechanism where grapple jaws of the grapple mechanism can grapple the probe;
in response to sensing the grapple probe is within the grappling area, retracting the grapple mechanism along a capture axis to close the grapple jaws and grapple the probe;
sensing that the grapple mechanism has retracted from a home position;
in response to sensing the grapple mechanism has retracted from the home position, tracking a position of the grapple mechanism along the capture axis as the grapple mechanism retracts via a position monitoring device;
further retracting the grapple mechanism along the capture axis to a target preload position as the grapple mechanism is grappling the probe to draw a first coupling element of the grapple fixture on the surface of the payload into mated connection with a second coupling element on the payload interfacing end of the end effector such that the first and second coupling elements transmit static loads between each other without separation of the interface up to a maximum rigidization load capability of the end effector, the target preload position corresponding to a discrete rigidization load;
generating an output at the position monitoring device when the grapple mechanism has retracted to the target preload position;
stopping retraction of the grapple mechanism at the target preload position based on the output of the position monitoring device.

39. (canceled)

40. The method of claim 38, further comprising, prior to the retraction by the grapple mechanism:
selecting the discrete rigidization load from a plurality of discrete rigidization loads achievable by the grapple mechanism; and
communicating the selected discrete rigidization load to the position monitoring device.

41. The method of claim 38, further comprising:
after stopping retraction of the grapple mechanism, engaging a brake to maintain preloaded configuration with no power draw required.

42. The method of claim 38, wherein further retracting the grapple mechanism along the capture axis to the target preload position includes:
compressing a compressible element in a load path of the grapple mechanism to generate the discrete rigidization load.

43. (canceled)

44. The method of claim 38, wherein the payload interfacing end of the end effector includes a socket drive mechanism, and the payload further includes a torque element on the surface of the payload for receiving torque and passing the received torque to a torque driven subsystem, and wherein the method further comprises:
bringing the torque element and a socket of the socket drive mechanism into contact as the grapple fixture is being rigidized to the end effector by the grapple mechanism;
seating the torque element in a socket of the socket drive mechanism as the grapple fixture is being grappled and rigidized; and
applying torque to the torque element when the torque element is seated in the socket and the grapple fixture is rigidized to the end effector by rotating the socket seated on the torque element.

45. The method of claim 38, wherein the first and second coupling elements each comprise a plurality of radially disposed teeth and notches, and wherein the teeth of the second coupling element are configured to mate with the notches of the first coupling element and the teeth of the first coupling element are configured to mate with the notches of the second coupling element when the first and second coupling elements are brought together during rigidization of the payload to the end effector.

46. The device of claim 38, wherein the first and second coupling elements are configured to each act as one half of a hirth coupling when the first and second coupling elements are brought into the mated connection during rigidization of the payload to the end effector.

47. The method of claim 38, further comprising limiting loads during grappling using a force torque sensor mounted in a primary load path of the grapple mechanism.

48-55. (canceled)
